(19) United States
(12) Patent Application Publication
(10) Pub. No.: US 2009/0233687 A1
(43) Pub. Date: Sep. 17, 2009

(54) Slot Machine

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/399,401

(22) Filed: Mar. 6, 2009

Related U.S. Application Data
(60) Provisional application No. 61/034,353, filed on Mar. 6, 2008.
(60) Provisional application No. 61/034,670, filed on Mar. 7, 2008.
(60) Provisional application No. 61/034,679, filed on Mar. 7, 2008.

(51) Int. Cl. A63F 9/24; A63F 13/00

(52) U.S. Cl. 463/20; 463/30

(57) ABSTRACT

A slot machine according to the present invention includes a display device for displaying a symbol display region having a first display region and a second display region; an input device for accepting input of a side-BET; a memory for storing image data concerning plural types of symbols; and a controller for controlling the display device and the input device. The controller reads from the image data concerning the symbols stored in the memory, image data concerning symbols to be combined under condition of the input of the side-BET; scales down the symbols of the image data so as to display the symbols in a region for displaying a single symbol; generate image data concerning a complex symbol based on the image data concerning the scaled-down symbols; rearrange the complex symbol in the first display region and the symbol in accordance with the image data concerning the plural types of symbols in the second display region; and selectively execute a plurality of bonus games in accordance with a type of a combination of the complex symbol and the single symbol in the case where the combination is a predetermined one.

### CROSS-REFERENCE TO RELATED APPLICATIONS

This application claims priorities of U.S. Provisional Application No. 61/034,670 filed on Mar. 7, 2008, U.S. Provisional Application No. 61/034,679 filed on Mar. 7, 2008 and U.S. Provisional Application No. 61/034,353 filed on Mar. 6, 2008. The contents of these applications are incorporated herein by reference in their entirety.

### BACKGROUND OF THE INVENTION

1. Field of the Invention

The present invention relates to a slot machine.

2. Description of the Related Art

Conventionally, slot machines known as a type of gaming machines are constituted so as to: start games by players inserting coins or the like into the gaming machine; variably display columns of symbols in predetermined regions of the gaming machine while they are displayed in a stopped state after a predetermined period has elapsed; and award payout based on a combination of symbols in a stopped state.

In addition, the above slot machines are generally constituted to judge whether or not a winning combination allowed to award payout is established, based on whether or not a predetermined number of symbols of the same type (for example, “CHERRY” or “7”) are arranged along a preset payline. In the conventional slot machine, in the case where a predetermined number or more of symbols of the same type are arranged, it has been a common routine to award payout based on the number of the aforementioned arranged symbols, regardless of the payout line.

Further, many of the conventional slot machines have been known which conduct two types of games, i.e., a basic game and a free game. The basic game is executed upon consumption of gaming values (such as coins or credits) corresponding to the bet amount. On the other hand, the free game is executed without consuming gaming values corresponding to the bet amount

The basic game is switched to the free game when a predetermined condition is satisfied. The condition includes a case in which, for example, a specific symbol is displayed in a stopped state during the basic game. The free game is switched to the basic game when a predetermined condition is satisfied. The condition includes a case in which, for example, the free games are executed a predetermined number of times.

In the conventional slot machines, it has been a common routine to raise players' expectations for the free game by changing arrangement of symbols during the free game differently from that during the basic game. For example, U.S. Pat. No. 6,394,902-B1 describes a slot machine in which a total of fifteen symbols are displayed in three rows and five columns with the use of video reels. This slot machine changes symbol columns arranged on reels during the free game differently from that during the basic game, in which eight types of symbols are decreased to five. In this manner, a probability of awarding payout can be apparently increased during the free game.

In the aforementioned conventional slot machines, however, irrespective of whichever of the basic game and the free game is in progress, the symbols of different types have been randomly arranged in combination and sequential order. These slot machines determine the contents of the prize to be awarded, based on a combination of multiple symbols that have been arranged in a display device. Therefore, players are allowed to have expectations only for random payout based on a combination of plural types of symbols that have been randomly arranged in the display device. Accordingly, a need exists for the advent of a slot machine which can offer new entertainability.

The present invention has been made in view of the above-described circumstance. It is an object of the present invention to provide a novel slot machine by enhancing entertainability in arrangement of the symbols.

### SUMMARY OF THE INVENTION

A first aspect of the present invention is a slot machine including: a display device for displaying a symbol matrix display region having a first display region and a second display region; and a controller for controlling the display device. The controller is programmed to: (a) execute a basic game; (b) rearrange a complex symbol composed of plural types of single symbols in the first display region of the symbol matrix display region and the plural types of single symbols in the second display region during the basic game; and (c) selectively execute a first bonus game or a second bonus game in accordance with a type of a combination of the complex symbol displayed in the first display region and the single symbol displayed in the second display region, in the case where the combination is a predetermined one.

According to the first aspect, a bonus game to be executed is different according to a combination of the complex symbol and the single symbol rearranged in the symbol matrix display region. Thus, the slot machine according to the first aspect achieves the bonus game that raises players' expectations depending on a combination of the complex symbol and the single symbol, thereby enhancing entertainability in symbol rearrangement

A second aspect of the present invention is a slot machine constituted as set fourth below. In the first aspect, the first bonus game or the second bonus game is set to a free game or a jackpot bonus game.

According to the second aspect, the bonus game or the free game is executed in accordance with a combination of the complex symbol and the single symbol rearranged in the symbol matrix display region. Thus, the slot machine according to the second aspect achieves the bonus game that raises players' expectations depending on a combination of the complex symbol and the single symbol, thereby enhancing entertainability in symbol rearrangement

A third aspect of the present invention is a slot machine constituted as set fourth below. In the second aspect, the slot machine further includes a memory for cumulatively storing a progressive value. The controller exercises control, over the itemized (b), to assign the complex symbol with a jackpot symbol accordingly when a jackpot reaches a predetermined progressive value on referring to the progressive value stored in the memory, in the case where the bonus game is set to the jackpot bonus game.

According to the third aspect, the complex symbol is assigned with the jackpot symbol when a jackpot reaches the predetermined progressive value, and the free game or the jackpot game is executed in accordance with a combination of the complex symbol and the single symbol rearranged in the symbol matrix display region. Thus, the slot machine according to the third aspect achieves the bonus game that raises players' expectations depending on a combination of the complex symbol and the single symbol, thereby enhancing entertainability in symbol rearrangement

A fourth aspect of the present invention is a slot machine including: a display device for displaying a symbol matrix display region having a first display region and a second display region; and a controller for controlling the display device. The controller is programmed to: (a) execute a basic game; (b) rearrange a complex symbol composed of plural types of single symbols in the first display region of the symbol matrix display region and the plural types of single symbols in the second display region during the basic game; and (c) selectively execute a bonus game or a free game in accordance with a type of a combination of the complex symbol displayed in the first display region and the single symbol displayed in the second display region, in the case where the combination is a predetermined one.

According to the fourth aspect, the bonus game or the free game to be executed is different according to a combination of the complex symbol and the single symbol rearranged in the symbol matrix display region. Thus, the slot machine according to the fourth aspect achieves the bonus game that raises players' expectations depending on a combination of the complex symbol and the single symbol, thereby enhancing entertainability in symbol rearrangement.

A fifth aspect of the present invention is a slot machine constituted as set fourth below. In the fourth aspect, the slot machine further includes a memory for cumulatively storing a progressive value. The controller exercises control, over the itemized (b), to assign the complex symbol with a jackpot symbol accordingly when a jackpot reaches a predetermined progressive value on referring to the progressive value stored in the memory, in the case where the bonus game is set to the jackpot bonus game.

According to the fifth aspect, the complex symbol is assigned with the jackpot when the jackpot reaches the predetermined progressive value, and the free game or the jackpot game to be executed is different according to a combination of the complex symbol and the single symbol rearranged in the symbol matrix display region. Thus, the slot machine according to the fifth aspect achieves the bonus game that raises players' expectations depending on a combination of the complex symbol and the single symbol, thereby enhancing entertainability in symbol rearrangement.

A sixth aspect of the present invention is a slot machine including: a display device for displaying a symbol matrix display region having a first display region and a second display region; a memory for cumulatively storing a progressive value in accordance with a jackpot; and a controller for controlling the display device and the memory. The controller is programmed to: (a) execute a basic game; (b) generate data of a complex symbol composed of plural types of single symbols so as to assign the complex symbol with a jackpot symbol accordingly when a jackpot reaches a predetermined progressive value on referring to the progressive value stored in the memory during the basic game; (c) rearrange the complex symbol in the first display region of the symbol matrix display region based on the data of the complex symbol, and the plural types of single symbols in the second display region; and (d) selectively execute a jackpot bonus game or a free game in accordance with a type of a combination of the complex symbol displayed in the first display region and the single symbol displayed in the second display region, in the case where the combination is a predetermined one.

According to a sixth aspect, data of the complex symbol is generated so that the complex data is assigned with the jackpot symbol when the jackpot reaches the predetermined value. The bonus game or the free game to be executed is different according to a combination of the complex symbol based on the above data and the single symbol rearranged in the symbol matrix display region. Thus, the slot machine according to the sixth aspect achieves the bonus game that raises players' expectations depending on a combination of the complex symbol and the single symbol, thereby enhancing entertainability in symbol rearrangement.

A seventh aspect of the present inventions a slot machine including: a display device for displaying a symbol matrix display region having a first display region and a second display region; a memory for storing plural types of symbol image data; and a controller for controlling the display device and the memory, the controller being programmed to: (a) execute a basic game; (b) read at least two symbol image data to be combined from among the symbol image data stored in the memory during the basic game, reduce a horizontal or vertical direction of the read symbol image data so that said at least two symbol images are displayed in a region for displaying a single symbol, and then, generate combined symbol image data for displaying a combined symbol to be displayed in the first display region by combined said at least two reduced symbol image data; (c) rearrange the combined symbol corresponding to the combined symbol image data in the first display region within the symbol display region and, rearrange symbols corresponding to the plural types of symbol image data in the second display region within the symbol display region, during the basic game; and (d) selectively execute a first bonus game or a second bonus game according to types of the combination, in a case where a combination of the combined symbol displayed in the first display region and single symbols displayed in the second display region matches a predetermined combination.

According to the seventh aspect of the present invention, the symbol image data is reduced to generate a combined symbol. Data capacity is thereby remarkably reduced in comparison with a case in which a plurality of combined symbols are stored. According to the combination of the generated combined symbol and single symbols, different bonus games are executed. Thus, a bonus game with a high level of expectation can be realized according to the combination of the combined symbol and the single symbols. This enhances the entertainability associated with rearrangement of the symbols.

A eighth aspect of the present invention is a slot machine constituted as set forth below. In the seventh aspect, the first bonus game or the second bonus game is a free game or a jackpot.

According to the eighth aspect of the present invention, based on the combination of the combined symbol and the single symbols rearranged in the symbol matrix display region, a free game or a jackpot bonus game is executed. Thus, a bonus game with a high level of expectation can be realized according to the combination of the combined symbol and the single symbols. This enhances the entertainability associated with rearrangement of the symbols.

A ninth aspect of the present invention is a slot machine constituted as set forth below. In the seventh aspect, a memory for cumulatively storing a progressive value is further included, in which the controller, in the itemized (b), reads the symbol image data from the memory with referring to the progressive value of the memory, in a case where the bonus game is the jackpot, so that a jackpot symbol is added to the combined symbol in response to the jackpot becoming a predetermined progressive value.

According to the ninth aspect of the present invention, upon becoming a predetermined progressive value, the jackpot symbol is added to the combined symbol, and according to the combination of the combined symbol and the single symbols rearranged in the symbol matrix display region, a free game or a jackpot game is executed. Thus, a bonus game with a high level of expectation can be realized according to the combination of the combined symbol and the single symbols. This enhances the entertainability associated with rearrangement of the symbols.

A tenth aspect of the present inventions is a slot machine including: a display device for displaying a symbol matrix display region having a first display region and a second display region; a memory for storing plural types of symbol image data; and a controller for controlling the display device and the memory, the controller being programmed to: (a) execute a basic game; (b) read at least two symbol image data to be combined from among the symbol image data stored in the memory during the basic game, and then, reduce a horizontal or vertical direction of the read items of symbol image data so that said at least two symbol images are displayed in a region for displaying a single symbol, and then, generate combined symbol image data for displaying a combined symbol to be displayed in the first display region by combined said at least two reduced symbol image data; (c) rearrange the combined symbol corresponding to the combined symbol image data in the first display region within the symbol display region and rearrange symbols corresponding to the plural types of symbol image data in the second display region within the symbol display region, during the basic game; and (d) selectively execute a bonus game or a free game according to types of the combination, in a case where a combination of the combined symbol displayed in the first display region and single symbols displayed in the second display region matches a predetermined combination.

According to the tenth aspect of the present invention, the symbol image data is reduced to generate a combined symbol. Data capacity is thereby remarkably reduced in comparison with a case in which a plurality of combined symbols are stored. According to the combination of the generated combined symbol and single symbols, the free game or the jackpot bonus game is executed. Thus, a bonus game with a high level of expectation can be realized according to the combination of the combined symbol and the single symbols. This enhances the entertainability associated with rearrangement of the symbols.

A eleventh aspect of the present invention is a slot machine constituted as set forth below. In the tenth aspect, a memory for cumulatively storing a progressive value is further included, in which the controller, in the itemized (b), reads the symbol image data from the memory with referring to the progressive value of the memory, in a case where the bonus game is the jackpot, so that a jackpot symbol is added to the combined symbol in response to the jackpot becoming a predetermined progressive value.

According to the eleventh aspect of the present invention, upon becoming a predetermined progressive value, the jackpot symbol is added to the combined symbol, and according to the combination of the combined symbol and the single symbols rearranged in the symbol matrix display region, a free game or a jackpot game is executed. Thus, a bonus game with a high level of expectation can be realized according to the combination of the combined symbol and the single symbols. This enhances the entertainability associated with rearrangement of the symbols.

A twelfth aspect of the present inventions is a slot machine including: a display device for displaying a symbol matrix display region having a first display region and a second display region; a memory for storing plural types of symbol image data and cumulatively storing a progressive value; a controller for controlling the display device and the memory, the controller being programmed to: (a) execute a basic game; (b) read at least two symbol image data to be combined from among the symbol image data stored in the memory, with referring to the progressive value of the memory so that the jackpot symbol is added to the combined symbol in which plural types of symbols are combined in response to the jackpot becoming a predetermined progressive value, during the basic game, reduce a horizontal or a vertical direction of the read symbol image data so that said at least two symbol images are displayed in a region for displaying a single symbol, and then, generate combined symbol image data for displaying a combined symbol to be displayed in the first display region by combined said at least two reduced symbol image data; (c) rearrange the combined symbol corresponding to the combined symbol image data in the first display region within the symbol display region and rearrange symbols corresponding to the plural types of symbol image data in the second display region within the symbol display region, during the basic game; and (d) selectively execute a bonus game or a free game according to types of the combination, in a case where a combination of the combined symbol displayed in the first display region and single symbols displayed in the second display region matches a predetermined combination.

According to the twelfth aspect of the present invention, upon becoming a predetermined progressive value, the symbol image data is reduced to generate the combined symbol to which the jackpot symbol is added. Data capacity is thereby remarkably reduced in comparison with a case in which a plurality of combined symbols are stored. According to the combination of the combined symbol and the single symbols rearranged in the symbol matrix display region, a free game or a jackpot game is executed. Thus, a bonus game with a high level of expectation can be realized according to the combination of the combined symbol and the single symbols. This enhances the entertainability associated with rearrangement of the symbols.

A thirteenth aspect of the present invention is a slot machine including: a display device for displaying a symbol matrix display region having a first display region and a second display region; an input device for accepting input of a normal-BET and a side-BET different from the normal-BET; a memory for storing image data concerning plural types of symbols; and a controller for controlling the display device and the input device. The controller is programmed to: (a) execute a basic game; (b) read from the image data concerning the symbols stored in the memory, image data concerning at least two symbols including symbols that are possibly combined under condition of the input of the side-BET; laterally or longitudinally scale down the at least two symbols of the read-out image data to display these two symbols in a region for displaying a single symbol; and generate image data concerning a complex symbol to display the complex symbol in the first display region, based on the image data concerning the scaled-down symbols; and (c) rearrange the complex symbol composed of the symbols combined in accordance with the image data concerning the complex symbol, in the first display region in the symbol matrix display region and a symbol in accordance with the image data concerning the plural types of symbols in the second display region during the basic game; and (d) selectively execute one bonus game from among a plurality of bonus games, in accordance with a type of a combination of the complex symbol displayed in the first display region and the single symbol displayed in the second display region, in the case where the combination is a predetermined one.

According to the thirteenth aspect, a bonus game is to be executed in accordance with a combination of a complex symbol composed of symbols that are combined under condition of input of the side-BET, and a single symbol. Thus, the slot machine according to the thirteenth aspect achieves a bonus game that raises player's expectations depending on a combination of the complex symbol and the single symbol, thereby enhancing entertainability in symbol rearrangement.

A fourteenth aspect of the present invention is a slot machine constituted as set fourth below. In the thirteenth aspect, the bonus game is set to a jackpot bonus game; and the image data concerning the symbols that are possibly combined under condition of the input of the side-BET includes image data concerning a plurality of jackpot symbols.

According to the fourteenth aspect, when a jackpot symbol is incorporated into a symbol composed of symbols that are combined under condition of input of the side-BET, a bonus game is selectively executed and a jackpot game is to be executed depending on a combination of the complex symbol and the single symbol. Thus, the slot machine according to the fourteenth aspect achieves a bonus game that raises player's expectations depending on a combination of the complex symbol and the single symbol, thereby enhancing entertainability in symbol rearrangement.

A fifteenth aspect of the present invention is a slot machine constituted as set fourth below. In the fourteenth aspect, the slot machine further includes a memory for cumulatively storing a progressive value. The controller, in the itemized (b), reads the image data concerning the symbols out of the memory to incorporate one jackpot symbol from among the plurality of jackpot symbols into the complex symbol accordingly, when a jackpot reaches a predetermined progressive value on referring to the progressive value stored in the memory.

According to the fifteenth aspect, a jackpot symbol is incorporated into the complex symbol when a jackpot reaches a predetermined progressive value, and a jackpot game is to be executed in accordance with a combination of the complex symbol and the single symbol rearranged in the symbol matrix display region. Thus, the slot machine according to the fifteenth aspect achieves a bonus game that raises player's expectations depending on a combination of the complex symbol and the single symbol, thereby enhancing entertainability in symbol rearrangement.

A sixteenth aspect of the present invention is a slot machine including: a display device for displaying a symbol matrix display region having a first display region and a second display region; an input device for accepting input of a normal-BET and a side-BET different from the normal-BET; a memory for storing image data concerning plural types of symbols; and a controller for controlling the display device and the input device. The controller is programmed to: (a) execute a basic game; (b) read from the image data concerning the symbols stored in the memory, image data concerning at least two symbols including a plurality of jackpot symbols that are possibly combined under condition of the input of the side-BET; laterally or longitudinally scale down the at least two symbols of the read-out image data to display these two symbols in a region for displaying a single symbol; and generate image data concerning a complex symbol to display the complex symbol in the first display region, based on the image data concerning the scaled-down symbols; and (c) rearrange the complex symbol composed of the symbols combined in accordance with the image data concerning the complex symbol, in the first display region in the symbol matrix display region and a symbol in accordance with the image data concerning the plural types of symbols in the second display region during the basic game; and (d) selectively execute one bonus game from among a plurality of bonus games, in accordance with a type of a combination of the complex symbol displayed in the first display region and the single symbol displayed in the second display region, in the case where the combination is a predetermined one.

According to the sixteenth aspect, when a jackpot symbol is incorporated into a symbol composed of symbols that are combined under condition of input of the side-BET, a bonus game is selectively executed and a jackpot game is to be executed depending on a combination of the complex symbol and the single symbol. Thus, the slot machine according to the sixteenth aspect achieves a bonus game that raises player's expectations depending on a combination of the complex symbol and the single symbol, thereby enhancing entertainability in symbol rearrangement.

A seventeenth aspect of the present invention is a slot machine constituted as set fourth below. In the sixteenth aspect, the slot machine further includes a memory for cumulatively storing a progressive value. The controller, in the itemized (b), reads the image data concerning the symbols out of the memory to incorporate one jackpot symbol from among a plurality of the jackpot symbols into the complex symbol accordingly, when a jackpot reaches a predetermined progressive value on referring to the progressive value stored in the memory.

According to the seventeenth aspect, a jackpot symbol is incorporated into the complex symbol when a jackpot reaches a predetermined progressive value, and a jackpot game is to be executed in accordance with a combination of the complex symbol and the single symbol rearranged in the symbol matrix display region. Thus, the slot machine according to the fifteenth aspect achieves a bonus game that raises player's expectations depending on a combination of the complex symbol and the single symbol, thereby enhancing entertainability in symbol rearrangement.

A eighteenth aspect of the present invention is a slot machine including: a display device for displaying a symbol matrix display region having a first display region and a second display region; an input device for accepting input of a normal-BET and a side-BET different from the normal-BET; a memory for storing image data concerning plural types of symbols; and a controller for controlling the display device and the input device. The controller is programmed to: (a) execute a basic game; (b) read the image data concerning the symbols out of the memory to incorporate one jackpot symbol from among a plurality of jackpot symbols that are possibly combined under condition of the input of the side-BET, into a complex symbol accordingly, when a jackpot reaches a predetermined progressive value on referring to the progressive value stored in the memory; laterally or longitudinally scale down at least two symbols of the read-out image data to display these two symbols in a region for displaying a single symbol; and generate image data concerning a complex symbol to display the complex symbol in the first display region, based on the image data concerning the scaled-down symbols; and (c) rearrange the complex symbol composed of the symbols combined in accordance with the image data concerning the complex symbol, in the first display region in the symbol matrix display region and a symbol in accordance with the image data concerning the plural types of symbols in the second display region during the basic game; and (d) selectively execute one bonus game from among a plurality of bonus games, in accordance with a type of a combination of the complex symbol displayed in the first display region and the single symbol displayed in the second display region, in the case where the combination is a predetermined one.

According to the eighteenth aspect of the present invention, a jackpot symbol is incorporated into the complex symbol when a jackpot reaches a predetermined progressive value, and a jackpot game is to be executed in accordance with a combination of the complex symbol and the single symbol rearranged in the symbol matrix display region. Thus, the slot machine according to the fifteenth aspect achieves a bonus game that raises player's expectations depending on a combination of the complex symbol and the single symbol, thereby enhancing entertainability in symbol rearrangement.

### BRIEF DESCRIPTION OF THE DRAWINGS

FIG. 1A is a view showing an exemplary symbol matrix during a basic game according to a first embodiment;

FIG. 1B is a view showing an exemplary symbol matrix during the basic game according to the first embodiment;

FIG. 2 is a perspective view schematically showing an appearance of a slot machine according to the first embodiment;

FIG. 3 is a view showing an internal construction of the slot machine shown in FIG. 2;

FIG. 4A is a view showing an exemplary symbol matrix displayed during the basic game in the slot machine shown in FIG. 2 according to the first embodiment;

FIG. 4B is a view showing an exemplary symbol matrix displayed during the basic game in the slot machine shown in FIG. 2 according to the first embodiment;

FIG. 5A is a view showing one example of an image displayed during a free game in the slot machine shown in FIG. 2 according to the first embodiment;

FIG. 5B is a view showing an exemplary symbol matrix displayed during the free game in the slot machine shown in FIG. 2 according to the first embodiment;

FIG. 6A is a view showing one example of an image displayed during a jackpot bonus game in the slot machine shown in FIG. 2 according to the first embodiment;

FIG. 6B is a view showing an exemplary symbol matrix displayed during the jackpot bonus game in the slot machine shown in FIG. 2 according to the first embodiment;

FIG. 7A is a view showing one example of an image displayed during the jackpot bonus game in the slot machine shown in FIG. 2 according to the first embodiment;

FIG. 7B is a view showing one example of an image displayed during the jackpot bonus game in the slot machine shown in FIG. 2 according to the first embodiment;

FIG. 8A is a view showing one example of an image displayed during the jackpot bonus game in the slot machine shown in FIG. 2 according to the first embodiment;

FIG. 8B is a view showing one example of an image displayed during the jackpot bonus game in the slot machine shown in FIG. 2 according to the first embodiment;

FIG. 9 is a flowchart showing a subroutine of a main process according to the first embodiment;

FIG. 10 is a flowchart showing a subroutine of a game execution process according to the first embodiment;

FIG. 11 is a flowchart showing a subroutine of a basic game symbol rearrangement process according to the first embodiment;

FIG. 12 is a flowchart showing a subroutine of a free game execution process according to the first embodiment;

FIG. 13 is a flowchart showing a subroutine of a jackpot bonus game execution process according to the first embodiment;

FIG. 14 is a view for schematically showing an appearance of the slot machine according to a second embodiment of the present invention;

FIG. 15 is a view showing an exemplary symbol matrix during the basic game according to the second embodiment of the present invention;

FIG. 16 is a flowchart showing a subroutine of a basic game symbol rearrangement process according to the second embodiment of the present invention.

FIG. 17A is a view showing an exemplary symbol matrix during a basic game according to the third embodiment;

FIG. 17B is a view showing an exemplary symbol matrix during the basic game according to the third embodiment;

FIG. 18 is a perspective view schematically showing a frame format of a slot machine according to the third embodiment;

FIG. 19 is a block diagram depicting an internal construction of the slot machine shown in FIG. 18;

FIG. 20A is a view showing an exemplary symbol matrix displayed in the slot machine shown in FIG. 18 during the basic game according to the third embodiment;

FIG. 20B is a view showing an exemplary symbol matrix displayed in the slot machine shown in FIG. 18 during the basic game according to the third embodiment;

FIG. 21A is a view showing an exemplary image displayed in the slot machine shown in FIG. 18 during a free game according to the third embodiment;

FIG. 21B is a view showing an exemplary symbol matrix displayed in the slot machine shown in FIG. 18 during the free game according to the third embodiment;

FIG. 22A is a view showing an exemplary image displayed in the slot machine shown in FIG. 18 during a jackpot bonus game according to the third embodiment;

FIG. 22B is a view showing an exemplary symbol matrix displayed in the slot machine shown in FIG. 18 during the jackpot bonus game according to the third embodiment;

FIG. 23A is a view showing an exemplary image displayed in the slot machine shown in FIG. 18 during the jackpot bonus game according to the third embodiment;

FIG. 23B is a view showing an exemplary image displayed in the slot machine shown in FIG. 18 during the jackpot bonus game according to the third embodiment;

FIG. 24A is a view showing an exemplary image displayed in the slot machine shown in FIG. 18 during the jackpot bonus game according to the third embodiment;

FIG. 24B is a view showing an exemplary image displayed in the slot machine shown in FIG. 18 during the jackpot bonus game according to the third embodiment;

FIG. 25 is a flowchart showing a subroutine of a main process according to the third embodiment;

FIG. 26 is a flowchart showing a subroutine of a game execution process according to the third embodiment;

FIG. 27 is a flowchart showing a subroutine of a basic game symbol rearrangement process according to the third embodiment;

FIG. 28 is a flowchart showing a subroutine of a symbol scaling process according to the third embodiment;

FIG. 29 is a flowchart showing a subroutine of a free game execution process according to the third embodiment;

FIG. 30 is a flowchart showing a subroutine of a jackpot bonus game execution process according to the third embodiment;

FIG. 31 is a view schematically depicting a frame format of an appearance of a slot machine according to a fourth embodiment;

FIG. 32A is a view showing an exemplary symbol matrix during a basic game according to the fourth embodiment;

FIG. 32B is a view showing an exemplary symbol matrix during the basic game according to the fourth embodiment;

FIG. 33 is a flowchart showing a subroutine of a basic game symbol rearrangement process according to the fourth embodiment.

FIG. 34A is a view showing an exemplary symbol matrix during a basic game according to a fifth embodiment;

FIG. 34B is a view showing an exemplary symbol matrix during the basic game according to the fifth embodiment;

FIG. 35 is a perspective view schematically showing an appearance of a slot machine according to the fifth embodiment;

FIG. 36 is a view showing an internal construction of the slot machine shown in FIG. 35;

FIG. 37A is a view showing an exemplary image displayed during the basic game in the slot machine shown in FIG. 35;

FIG. 37B is a view showing an exemplary image displayed during the basic game in the slot machine shown in FIG. 35;

FIG. 38A is a view showing an exemplary image displayed during the basic game in the slot machine shown in FIG. 35;

FIG. 38B is a view showing an exemplary image displayed during the basic game in the slot machine shown in FIG. 35;

FIG. 39A is a view showing an exemplary image displayed during a free game in the slot machine shown in FIG. 35;

FIG. 39B is a view showing an exemplary image displayed during the free game in the slot machine shown in FIG. 35;

FIG. 39C is a view showing an exemplary image displayed during the free game in the slot machine shown in FIG. 35;

FIG. 40A is a view showing an exemplary image displayed during the bonus game in the slot machine shown in FIG. 35;

FIG. 40B is a view showing an exemplary image displayed during the bonus game in the slot machine shown in FIG. 35;

FIG. 41A is a view showing an exemplary image displayed during the bonus game in the slot machine shown in FIG. 35;

FIG. 41B is a view showing an exemplary image displayed during the bonus game in the slot machine shown in FIG. 35;

FIG. 42A is a view showing an exemplary image displayed during the bonus game in the slot machine shown in FIG. 35;

FIG. 42B is a view showing an exemplary image displayed during the bonus game in the slot machine shown in FIG. 35;

FIG. 43 is a flowchart showing a subroutine of a main process;

FIG. 44 is a flowchart showing a subroutine of a game execution process according to the fifth embodiment;

FIG. 45 is a flowchart showing a subroutine of a basic game symbol rearrangement process according to the fifth embodiment;

FIG. 46 is a flowchart showing a subroutine of a symbol combining process according to the fifth embodiment;

FIG. 47 is a flowchart showing a subroutine of a free game execution process according to the fifth embodiment;

FIG. 48 is a flowchart showing a subroutine of a jackpot bonus game execution process according to the fifth embodiment of the present invention;

FIG. 49 is a view for schematically showing an appearance of the slot machine according to a sixth embodiment of the present invention;

FIG. 50A is a view showing an exemplary symbol matrix during a basic game according to the sixth embodiment; and

FIG. 50B is a view showing an exemplary symbol matrix during the basic game according to the sixth embodiment.

### DESCRIPTION OF THE PREFERRED EMBODIMENTS

### 1. First Embodiment

First, a slot machine 10 according to a first embodiment will be described in detail with reference to the drawings. The slot machine according to the first embodiment is a so-called video slot machine, which has an image display panel such as a liquid crystal display and executes a game by displaying images of various symbols on the image display panel.

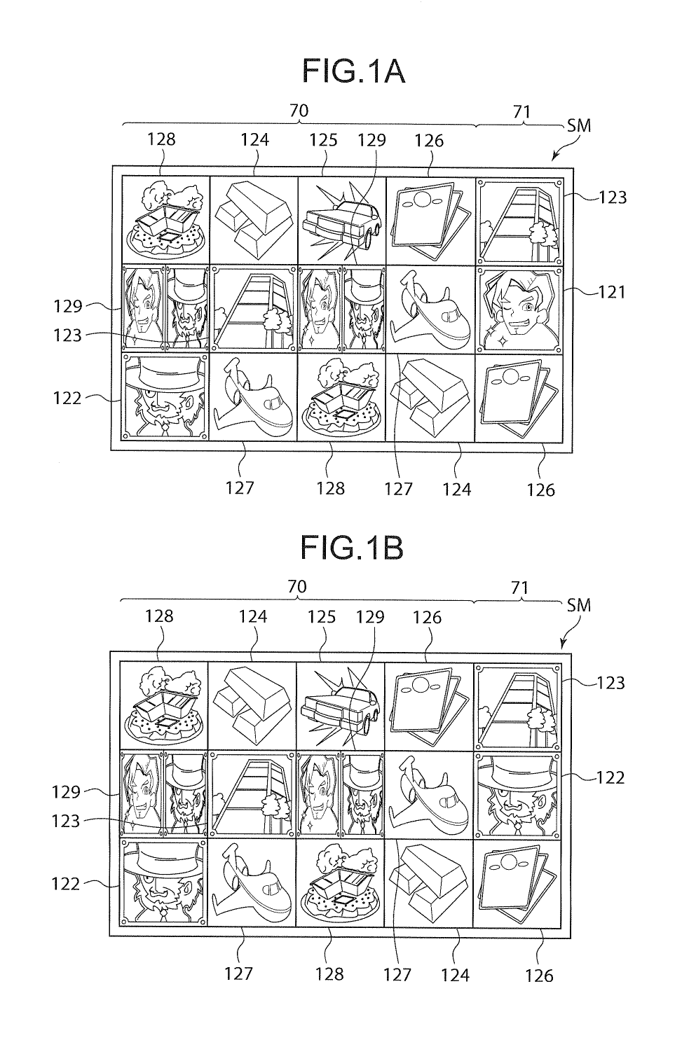

FIGS. 1A and 1B are views each showing an exemplary symbol matrix during a basic game according to the first embodiment. The slot machine 10 according to the present invention executes any one of three types of gaming modes including a basic game, a free game, and a progressive bonus game. The basic game is executed upon consuming a gaming value corresponding to the amount bet by a player. The free game is executed without consuming a gaming value. The progressive bonus game is executed when a jackpot reaches a predetermined progressive value. The slot machine 10 is of a stand-alone type, which is not connected to a network, but the present invention is applicable to a networked slot machine.

As shown in FIGS. 1A and 1B, a symbol matrix SM is displayed on a lower image display panel 16 included in a slot machine 10 to be described later. A total of fifteen symbols in three rows and five columns are rearranged in the symbol matrix SM.

In the first embodiment of the present invention, any of symbols “main character” 121, “sub character” 122, “office building” 123, “gold bullion” 124, “car” 125, “stock certificate” 126, “jet” 127, and “villa” 128, is rearranged in the symbol matrix SM, and a payout is determined based on the number of respective symbols rearranged in the symbol matrix SM. Further, when a jackpot reaches a predetermined progressive value, a complex symbol 129 is assigned with a jackpot symbol accordingly, thereby being rearranged.

As shown in FIG. 1A, when a jackpot reaches a predetermined progressive value during the basic game, any of the symbols “main character” 121, “sub character” 122, “office building” 123, “gold bullion” 124, “car” 125, “stock certificate” 126, “jet” 127, and “villa” 128, and a complex symbol 129 is rearranged in a first display region 70 of the symbol matrix SM. Further any of the symbols “main character” 121, “sub character” 122, “office building” 123, “gold bullion” 124, “car” 125, “stock certificate” 126, “jet” 127, and “villa” 128, is rearranged in a second display region 71 of the symbol matrix SM. In this case, a combination of the two complex symbols 129 each composed of the symbols “main character” 121 and “sub character” 122, and the single symbol “main character” 121 is rearranged, thereby executing the free game.

As shown in FIG. 1B, when a jackpot reaches a predetermined progressive value during the basic game, any of the symbols “main character” 121, “sub character” 122, “office building” 123, “gold bullion” 124, “car” 125, “stock certificate” 126, “jet” 127, and “villa” 128, and a complex symbol 129 is rearranged in the first display region 70 of the symbol matrix SM. Further, any of the symbols “main character” 121, “sub character” 122, “office building” 123, “gold bullion” 124, “car” 125, “stock certificate” 126, “jet” 127, and “villa” 128, is rearranged in the second display region 71 of the symbol matrix SM. In this case, a combination of the two complex symbols 129 each composed of the symbols “main character” 121 and “sub character” 122, and the single symbol “sub character” 122 is rearranged, thereby executing the jackpot bonus game.

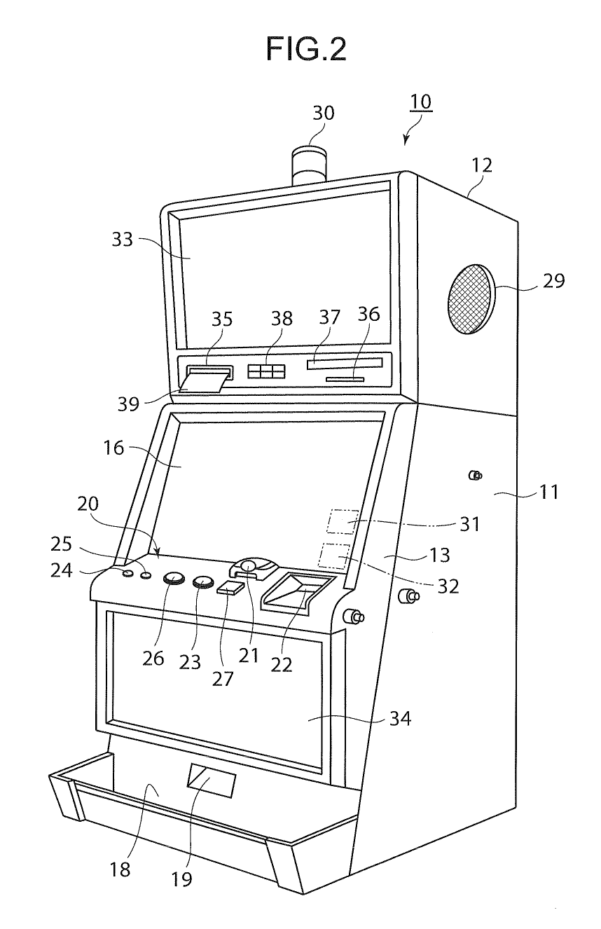

FIG. 2 is a view schematically depicting an appearance of the slot machine according to the first embodiment. The gaming media used in the slot machine 10 include coins, bills, or electronic value information equivalent thereto. In the present invention, however, the gaming media are not limitative thereto in particular, and can include medals, tokens, electric money, and tickets, for example. The above tickets are not limitative in particular, and can include barcode-attached tickets or the like, as described later, for example.

The slot machine 10 is provided with a cabinet 11, a top box 12 installed on an upper side of the cabinet 11, and a main door 13 provided on a front surface of the cabinet 11.

A lower image display panel 16 serving as a display device is provided in front of the main door 13. The lower image display panel 16 is provided with a liquid crystal panel, which displays the symbol matrix SM in three rows and five columns. In each symbol matrix SM, one symbol is arranged.

A credit amount display unit 31 of the lower image display panel 16 displays the number of coins credited by way of an image. A payout display unit 32 displays an image indicative of the number of coins or the like to be paid out in the case where the predetermined number or more of respective symbols are rearranged in the symbol matrix SM.

Provided on a lower side of the lower image display panel 16 are a control panel 20 having a plurality of buttons 23 to 27 through which command regarding the process of the game will be input by a player, a coin receiving slot 21 for receiving coins into the cabinet 11, and a bill validator 22.

On the control panel 20, a start button 23, a change button 24, a cashout button 25, a 1-BET button 26, and a max-BET button 27 are provided. The start button 23 is intended for entering a command for starting the game. The change button 24 is intended for use in asking an attendant of the gaming facility for change. The cashout button 25 is intended for entering a command for paying the credited coins to a coin tray 18 through a coin payout exit 19.

The 1-BET button 26 is intended for entering a command for betting one coin among the credited coins on the game. The max-BET button 27 is intended for entering a command for betting the upper number (50 in this embodiment) of coins that can be bet per game among the credited coins on the game.

The bill validator 22 validates whether or not a bill is legitimate and accepts a legitimate bill into the cabinet 11. The bill validator 22 may be configured so that a barcode-attached ticket 39 described later is readable thereby. Provided on a lower front surface of the main door 13, that is, at a lower part of the control panel 20, is a berry glass 34 on which characters of the slot machine 10 and the like are depicted.

On a front surface of the top box 12, an upper image display panel 33 is provided. The upper image display panel 33 has a liquid crystal panel, which displays images for introducing the game contents or explaining game rules, for example.

Also, on the top box 12, a speaker 29 and a lamp 30 are provided. On a lower side of the upper image display panel 33, a ticket printer 35, a card reader 36, a data display unit 37, and a key pad 38 are provided. The ticket printer 35 prints on the ticket, a barcode having encoded thereon data such as the credit amount, the date and time, and the identification number of the slot machine 10, and outputs the printed ticket as the barcode-attached ticket 39. The player can play the game on another slot machine with the barcode attached ticket 39 by causing this slot machine to read the barcode attached ticket 39. Alternatively, the player can exchange the barcode-attached ticket 39 with the bills or the like at a predetermined place (at a cashier inside a casino, for example) of the gaming facility.

The card reader 36 reads data from and writes data into a smart card. The smart card is to be owned by the player, which stores data for identifying the player or data regarding the log of games executed by the player, for example. The smart card may store data corresponding to coins, bills, or credit. As an alternative of a smart card, a magnetic stripe card may be employed. The data display 37 is made up of a fluorescent display and the like, and displays the data read by the card reader 36 or the data input by the player through the key pad 38, for example. The key pad 38 inputs data and commands regarding the ticket issuance or the like.

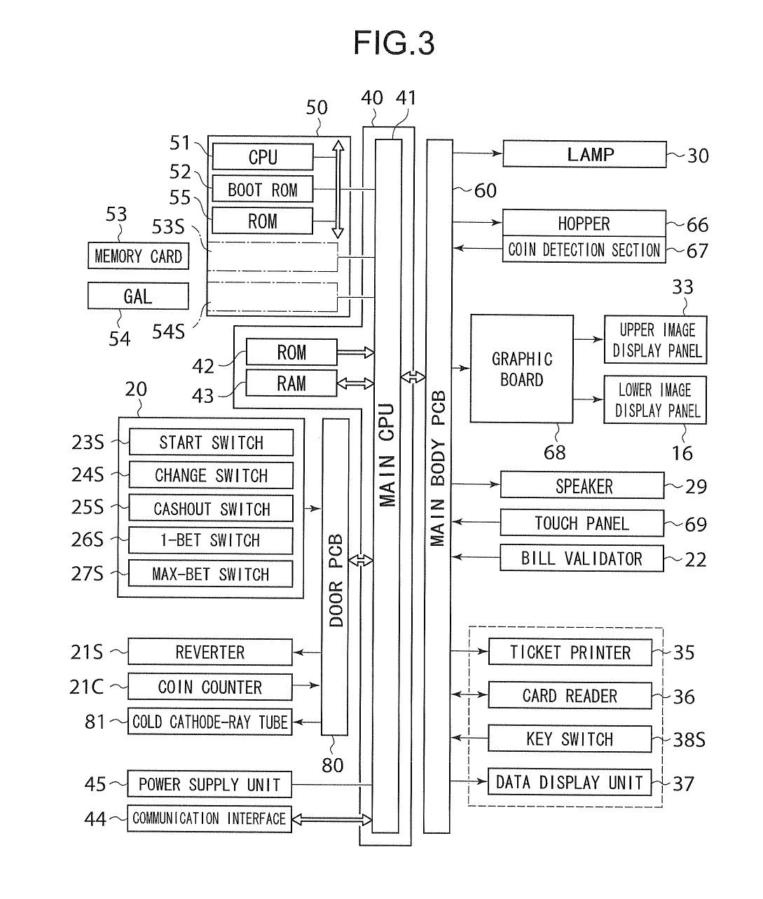

FIG. 3 is a block diagram depicting the internal construction of the slot machine shown in FIG. 2. A gaming board 50 includes: a CPU (Central Processing Unit) 51, a ROM (Read Only Memory) 55 and a boot ROM 52 interconnected by an internal bus; a card slot 53S corresponding to a memory card 53; and an IC socket 54S corresponding to a GAL (Generic Array Logic) 54.

A memory card 53 is composed of a non-volatile memory, such as CompactFlash (registered trademark), and stores a game program. The game programs include a symbol selection program. The symbol selection program is intended for determining symbols to be rearranged on a symbol matrix SM. The symbol selection program includes symbol weighing data corresponding to each of a plurality of kinds of payout ratios (for example, 80%, 84%, and 88%). The symbol weighting data is indicative of the correspondence relationship between the respective symbols and one or more random numeric values which come under a predetermined numerical range (0 to 255). The payout ratio is determined according to the payout-ratio setting data output from the GAL 54. The symbols to be rearranged in the symbol matrix SM are determined depending upon the symbol weighing data corresponding to this payout ratio. Further, the game programs include table data indicating the correspondence relationship between each of the symbols and a payout.

Also, the card slot 53S is configured to allow the memory card 53 to be inserted thereinto or ejected therefrom, and is connected to a motherboard 40 via an IDE bus. Accordingly, the memory card 53 can be ejected from the card slot 53S, other game programs and other game system programs can then be written into the memory card 53, and further, the memory card 53 can be inserted into the card slot 53S, thereby allowing the player to change the types and contents of games executed in the slot machine 10. The game programs include a program related to gaming progress. Furthermore, the game program includes image data or sound data to be output during the game. The image data include, for example, image data indicative of the symbol matrix.

The GAL 54 is a type of a PLD having a fixed OR array structure. The GAL 54 includes plural input ports and plural output ports. Where predetermined data is input to the input port, the GAL 54 outputs data corresponding to the aforementioned data from the output port. The data output from this output port is equivalent to the aforementioned payout-ratio setting data. Further, the IC socket 54S is configured to allow the GAL 54 to be attached thereto and detached therefrom, and is connected to the motherboard 40 by a PCI bus. Accordingly, the GAL can be replaced with the replacement GAL 54 to change the payout-ratio setting data.

The CPU 51, the ROM 55, and the boot ROM 52 interconnected by the internal bus are connected to the motherboard 40 by the PCI bus. The PCI bus serves to transmit signals between the motherboard 40 and the gaming board 50 and supply power from the motherboard 40 to the gaming board 50.

The motherboard 40 is constructed using a general-purpose motherboard commercially available (a printed circuit board on which essential parts of a personal computer are mounted) and includes: a main CPU (Central Processing Unit) 41, a ROM (Read Only Memory) 42; a RAM (Random Access Memory) 43; and a communication interface 44. The main CPU 41 functions as a processor for controlling a display device and memory according to the embodiment of the present invention.

The ROM 42 is made up of a memory device such as a flash memory and stores thereon a program such as BIOS (Basic Input/Output System) executed by the main CPU 41, and permanent data. When the BIOS is executed by the main CPU 41, processing of initializing predetermined peripheral devices is carried out and processing of capturing game programs and game system programs stored in the memory card 53 through the gaming board 50 is started. In the present invention, the contents of the ROM 42 may be rewritable or not.

The RAM 43 stores data and a program used when the main CPU 41 is activated. The RAM 43 can also store game programs. The RAM 43 further stores data concerning the credit amount, the number of coin-in or coin-out for one game, and the like.

Both a main body PCB (Printed Circuit Board) 60 and a door PCB 80, which will be described later, are connected to the motherboard 40 by USB. A power supply unit 45 is also connected to the motherboard 40.

Connected to the main body PCB 60 and the door PCB 80 are: equipment and devices which generate input signals to be input to the main CPU 41; and equipment and devices of which operations are controlled by a control signal output from the main CPU 41. The main CPU 41 executes a game program stored in the RAM 43 based on an input signal having been input to the main CPU 41 and performs a predetermined computational process, thereby storing results thereof in the RAM 43 or transmitting a control signal to each of equipment and devices as a control process therefor.

Connected to the main body PCB 60 are a lamp 30, a hopper 66, a coin detecting section 67, a graphic board 68, a speaker 29, a touch panel 69, a bill validator 22, a ticket printer 35, a card reader 36, a key switch 38S, and a data display 37. The lamp 30 illuminates in a predetermined pattern, based on a control signal output from a main CPU 41.

The hopper 66 is installed in the cabinet 11 and pays out a predetermined number of coins from the coin payout exit 19 to the coin tray 18 based on a control signal output from the main CPU 41. The coin detecting section 67 is installed inside the coin payout exit 19 and outputs an input signal to the main CPU 41 upon detecting that a predetermined number of coins have been paid out from the coin payout exit 19.

The graphic board 68 controls, based on a control signal output from the main CPU 41, images to be displayed on the upper image display panel 33 and the lower image display panel 16. The credit amount stored in the RAM 43 is displayed on a credit amount display section 31 (see FIG. 2) of the lower image display panel 16. The number of coins to be paid out is displayed at a payout amount display section 31 (see FIG. 2) of the lower image display panel 16. The graphic board 68 is equipped with a DVP (Video Display Processor) which generates image data based on a control signal output from the main CPU 41 and a video RAM which temporarily stores image data generated by the VDP, and the like. The image data used in generating image data with VDP is contained in the game program read from the memory card 53 and stored in the RAM 43.

The bill validator 22 validates whether or not a bill is legitimate and accepts a legitimate bill into the cabinet 11. Upon accepting a legitimate bill, the bill validator 22 outputs an input signal to the main CPU 41 based on the amount of the bill. The main CPU 41 stores in the RAM 43 the credit amount corresponding to the amount of bills transmitted by the input signal.

Based on a control signal output from the main CPU 41, the ticket printer 35 prints on a ticket a barcode having encoded thereon data such as the credit amount, data and time, and the identification number of the slot machine 10 stored in the RAM 43. Further, this printer outputs the printed ticket as a barcode-attached ticket 39. The card reader 36 transmits to the main CPU 41 the data read from the smart card and writes the read data onto the smart card, based on a control signal from the main CPU 41. The key pad switch 38S is provided on the key pad 38, and outputs a predetermined input signal to the main CPU 41 when the player operates the key pad 38. The data display 37, based on a control signal output from the main CPU 41, displays the data read by the card reader 36 and the data input by the player through the key pad 38.

The control panel 20, a reverter 21S, a coin counter 21C, and a cold cathode tube 81 are connected to the door PCB 80. The control panel 20 is provided with: a start switch 23S corresponding to the start button 23; a change switch 24S corresponding to the change button 24; a cashout switch 25S corresponding to a cashout button 25; a 1-BET switch 26S corresponding to a 1-BET button 26; and a max-BET switch 27S corresponding to the max BET button 27. When the player operates the buttons 23 to 27, the corresponding switches 23S to 27S output input-signals to the main CPU 41, respectively.

The coin counter 21C is provided inside the coin receiving slot 21, and validates whether or not a legitimate coin is inserted into the coin receiving slot 21. Those other than the legitimate coins are discharged from the coin payout exit 19. The coin counter 21C outputs an input signal to the main CPU 41 when a legitimate coin is detected.

The reverter 21S operates based on a control signal output from the main CPU 41 and distributes coins recognized as being legitimate by the coin counter 21C into a cash box (not shown in the drawings) or the hopper 66 which is arranged in the slot machine 10. In other words, when the hopper 66 is filled with coins, legitimate coins are distributed by the reverter 21S into the cash box. On the other hand, when the hopper 66 is not filled with coins, legitimate coins are distributed into the hopper 66. A cold cathode tube 81 functions as a backlight installed on rear face side of each of the lower image display panel 16 and the upper image display panel 33, and is lit up based on a control signal output from the main CPU 41.

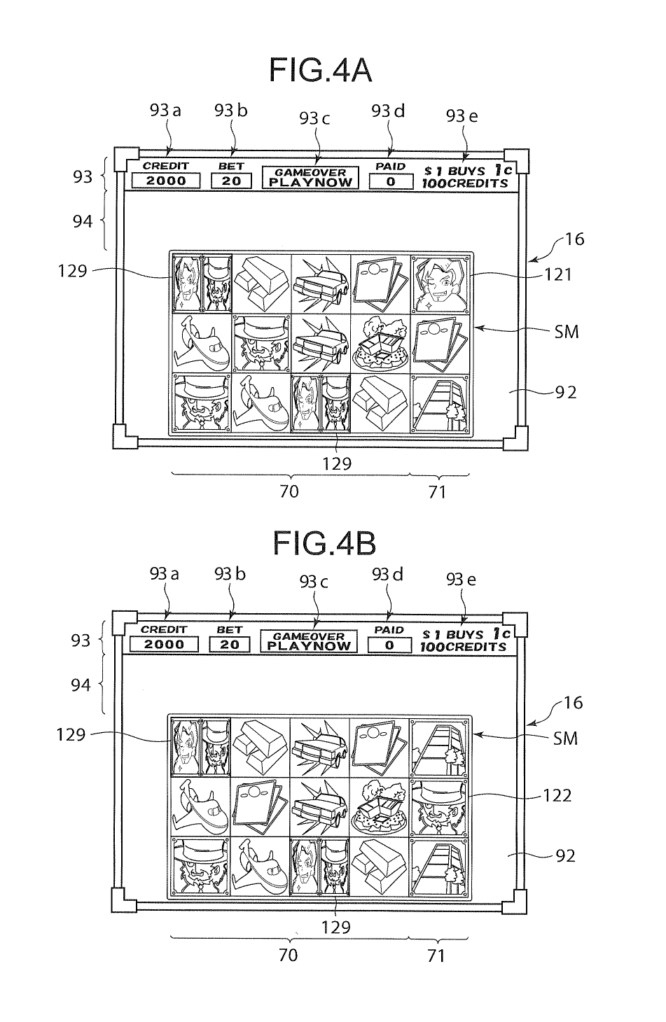

FIG. 4A to 8B are views each showing one example of an image displayed in the slot machine shown in FIG. 2 according to the first embodiment. FIGS. 4A and 4B are views each showing an exemplary symbol matrix displayed during the basic game in the slot machine shown in FIG. 2.

As shown in FIG. 4A, the lower image display panel 16 is made up of a display region 92, an information display section 93, the effect image display section 94, and the like. The display area section 92 is for displaying a symbol matrix SM. In addition, the information display section 93 is arranged above the display area section 92. This display section is made up of a credit amount display section 93a, a BET amount display section 93b, a character information display portion 93c, a PAID amount display section 93d, and a charge display section 93e.

The number of coins currently credited is displayed at the credit amount display section 93a while the number of coins bet in one game is displayed at the BET amount display section 93b. The character information indicative of a current status of the game is displayed at the character information display section 93c. The characters of “PLAYNOW” are displayed during the play of the game, whereas the characters of “GAMEOVER” are displayed during the intervals between the plays of the game. The number of coins that has been successfully obtained in one game is displayed at the PAID amount display section 93d, whereas a conversion value of the credit amount based on a predetermined charge is displayed at the charge display section.

At the effect image display section 94, effect images in accordance with a type of the present slot game are displayed. In other words, the effect image display section 94 displays different effect images between the basic and free games.

Any of the symbols, “main character” 121, “sub character” 122, “office building” 123, “gold bullion” 124, “car” 125, “stock certificate” 126, “jet” 127, and “villa” 128, and the complex symbol 129 is rearranged in the symbol matrix SM displayed on the lower image display panel 16. A payout is determined based on the number of these symbols rearranged in the symbol matrix SM. Data of complex symbol is generated so that a complex symbol composed of plural types of symbols is assigned with a jackpot symbol and then rearranged accordingly when a jackpot reaches a predetermined progressive value.

In this case, when a jackpot reaches a predetermined progressive value during the basic game, any of the symbols “main character” 121, “sub character” 122, “office building” 123, “gold bullion” 124, “car” 125, “stock certificate” 126, “jet” 127, and “villa” 128, and the complex symbol 129 is rearranged in the first display region 70 of the symbol matrix SM. Further any of the symbols “main character” 121, “sub character” 122, “office building” 123, “gold bullion” 124, “car” 125, “stock certificate” 126, “jet” 127, and “villa” 128, is rearranged in the second display region 71 of the symbol matrix SM. In this case, a combination of the two complex symbols 129 each composed of the symbols “main character” 121 and “sub character” 122, and the single symbol “main character” 121 is rearranged, thereby executing the free game.

As shown in FIG. 4B, when a jackpot reaches a predetermined progressive value during the basic game, any of the symbols “main character” 121, “sub character” 122, “office building” 123, “gold bullion” 124, “car” 125, “stock certificate” 126, “jet” 127, and “villa” 128, and a complex symbol 129 is rearranged in the first display region 70 of the symbol matrix SM. Further, any of the symbols “main character” 121, “sub character” 122, “office building” 123, “gold bullion” 124, “car” 125, “stock certificate” 126, “jet” 127, and “villa” 128, is rearranged in the second display region 71 of the symbol matrix SM. In this case, a combination of the two complex symbols 129 each composed of the symbols “main character” 121 and “sub character” 122, and the single symbol “sub character” 122 is rearranged, thereby executing the jackpot bonus game.

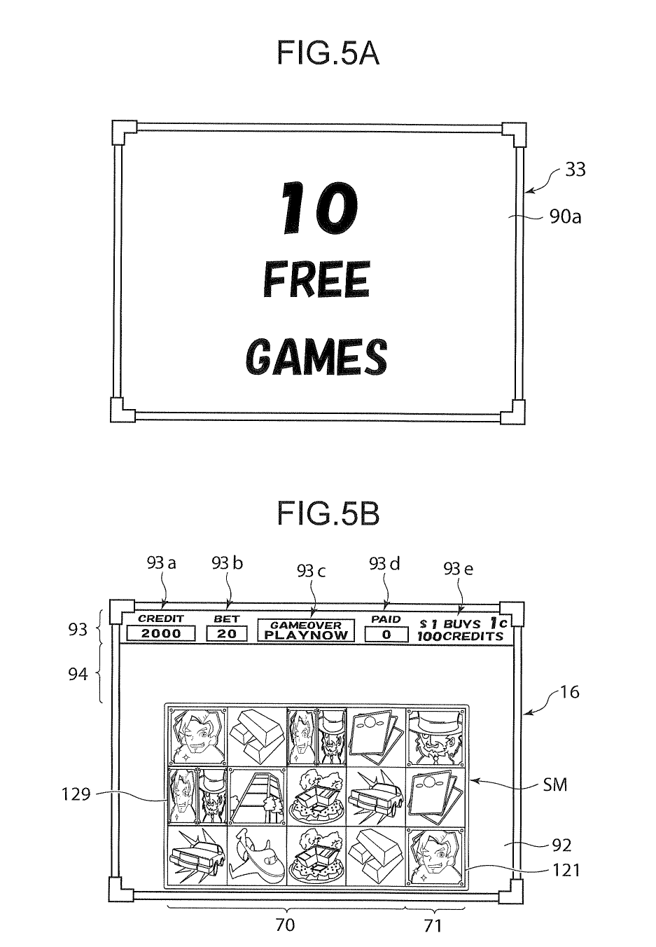

FIGS. 5A and 5B are views respectively showing one example of an image and an exemplary symbol matrix displayed during the free game in the slot machine 10 shown in FIG. 2 according to the first embodiment. As shown in FIG. 5A, the free game is started in the case where the symbols rearranged in the symbol matrix SM in FIG. 4A contain a combination of the two complex symbols 129 and the one symbol “main character” 121, the combination being set as a trigger for execution of the free game. Upon start of the free game, the upper image display panel 33 displays a free-game-number display image 90a indicative of the number of times in executing the free game. In this case, the free-game-number display image 90a of “10 FREE GAME” is displayed indicating that the number of times in executing the free game has been set to 10.

As shown in FIG. 5B, when a jackpot reaches a predetermined progressive value during the bonus game, any of the symbols “main character” 121, “sub character” 122, “office building” 123, “gold bullion” 124, “car” 125, “stock certificate” 126, “jet” 127, and “villa” 128, and the complex symbol 129 is rearranged in the first display region 70 of the symbol matrix SM. Any of the symbols “main character” 121, “sub character” 122, “office building” 123, “gold bullion” 124, “car” 125, “stock certificate” 126, “jet” 127, and “villa” 128, is rearranged in the second display region 71 of the symbol matrix SM. In this case, a combination of the two complex symbols 129 each composed of the symbols “main character” 121 and “sub character” 122, and the single symbol “sub character” 122 is rearranged, thereby executing the jackpot bonus game.

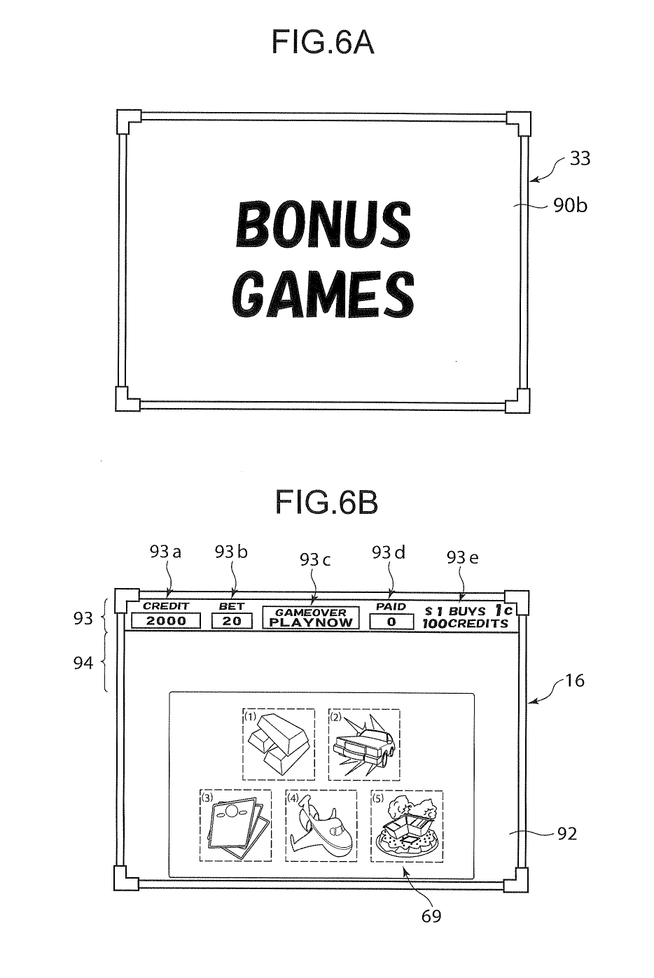

FIGS. 6A and 6B are views each showing one example of an image displayed in the slot machine 10 shown in FIG. 2 according to the first embodiment. As shown in FIG. 6A, the jackpot bonus game is started in the case where the symbols rearranged in the symbol matrix SM in FIG. 4B contain a combination of the two complex symbols 129 and the single symbol “sub character” 122, the combination being set as a trigger for execution of the jackpot bonus game. When start of the jackpot bonus game is determined, the upper image display panel 33 displays a jackpot-bonus-game display image 90b indicative of start of the jackpot bonus game is started. In this case, the jackpot-bonus-game display image 90b of “BONUS GAME” is displayed indicating that the jackpot bonus game is started.

As shown in FIG. 6B, when the jackpot bonus game is started, the display region 92 displays a selection screen through which a type of the jackpot game is determined. In this case, the symbols (1) to (5) including “gold bullion” 124, “car” 125, “stock certificate” 126, “jet” 127, and “villa” 128 are displayed so that a type of the jackpot bonus game can be selected by selecting one from among these symbols though a touch panel 69.

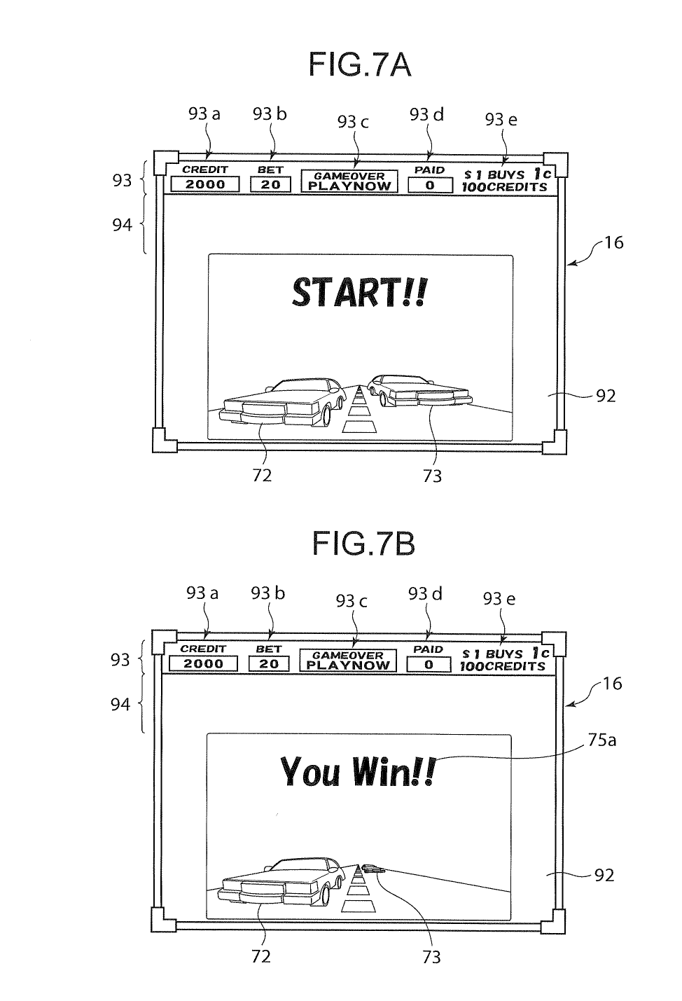

FIGS. 7A and 7B are views each showing one example of an image displayed during the jackpot bonus game in the slot machine 10 shown in FIG. 2 according to the first embodiment. As shown in FIG. 7A, the jackpot bonus game that corresponds to the symbol selected in FIG. 6B is displayed. In the case of selecting the symbol (2) in FIG. 6B, the jackpot bonus game of a car-race type is started, and a car-race starting screen is displayed, which displays a main-character effect image 72 and a sub-character effect image 73.

As shown in FIG. 7B, displayed is a win-loss screen of the jackpot bonus game that corresponds to the symbol selected in FIG. 6B. In this case, a win-loss information display 75a of “You Win” is displayed in the case where the symbol (2) in FIG. 6B has been selected and the main-character effect image 72 won in the jackpot bonus game of the car-race type.

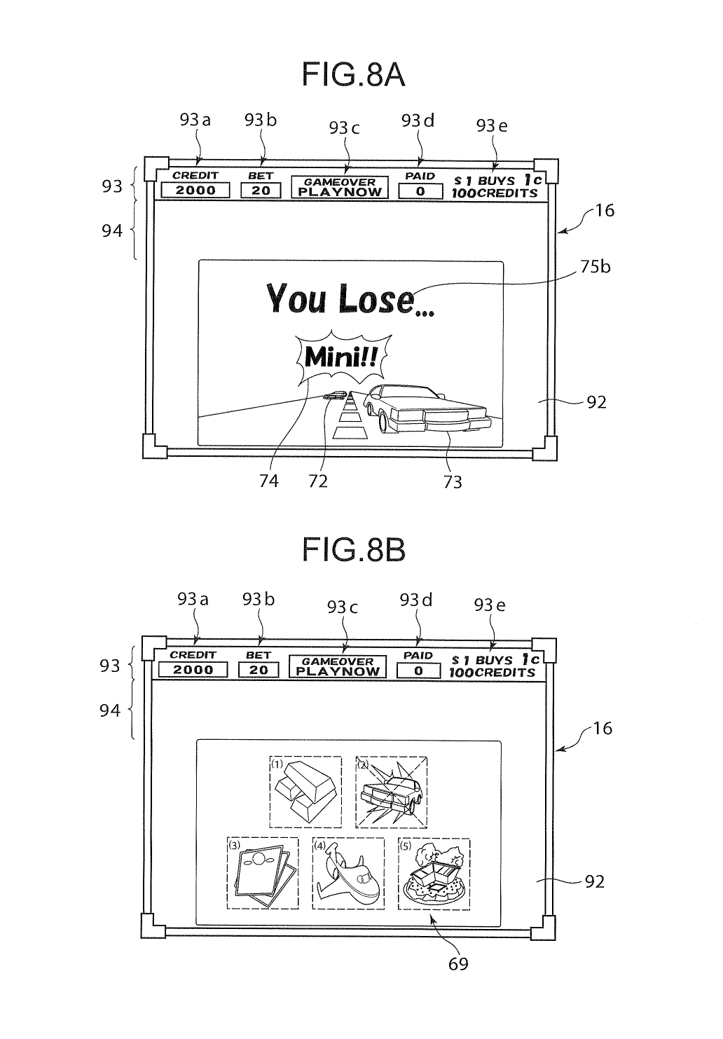

FIGS. 8A and 8B are views each showing one example of an image displayed during the jackpot bonus game in the slot machine 10 shown in FIG. 2 according to the first embodiment. As shown in FIG. 8A, displayed is a win-loss screen of the jackpot bonus game that corresponds to the symbol selected in FIG. 6B. In this case, a win-loss information display 78b of “You Lose” is displayed in the case where the symbol (2) in FIG. 6B has been selected and the sub-character effect image 73 won in the jackpot bonus game of the car-race type. Further, a payout display image 74 of “Mini” as one type of payout for the jackpot is displayed, thereby awarding a payout corresponding to “Mini”.

As shown in FIG. 8B, the display region 92 displays a selection screen of the jackpot bonus game that corresponds to the symbol selected in FIG. 6B. In the case where the symbol (2) has been selected in FIG. 6B and then the symbol “main character” 121 won in the jackpot bonus game of the car-race type (see FIG. 7B), the display region 92 displays the selection screen through which a type of the next jackpot bonus game is selected, in a manner to identify that the symbol (2) has been selected last time. Further, the next jackpot bonus game is to be executed by selecting one from among the symbols other than the symbol (2) through the touch panel 69.

Next, a process executed in the slot machine 10 according to the first embodiment, will be described in detail with reference to the drawings. The main CPU 41 reads out and executes a game program, thereby conducting the game.

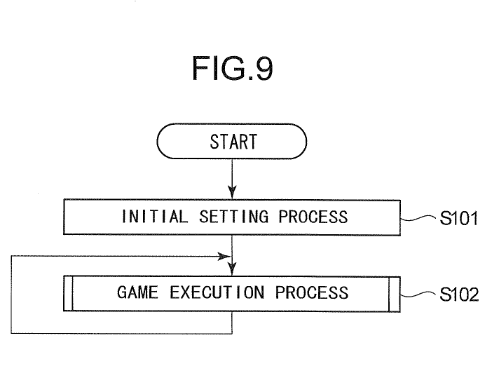

FIG. 9 is a flowchart showing a subroutine of a main process according to the first embodiment. In the main process, first, when a power switch is turned on (that is, when power is supplied), a motherboard 40 and a gaming board 50 are activated respectively, so that the CPU 51 executes an initial setting process (step S101). In this initial setting process, the main CPU 41 executes the BIOS stored in the ROM 42, decompresses, in the RAM 43, compressed data included in the BIOS, executes the BIOS decompressed in the RAM 43, and performs diagnosis and initialization of each of the peripheral devices. Further, the main CPU 41 writes game programs or the like from the ROM 42 into the RAM 43, and acquires payout-ratio setting data and country-identification information. The main CPU 41 also performs an authentication process for each program during execution of the initial setting process.

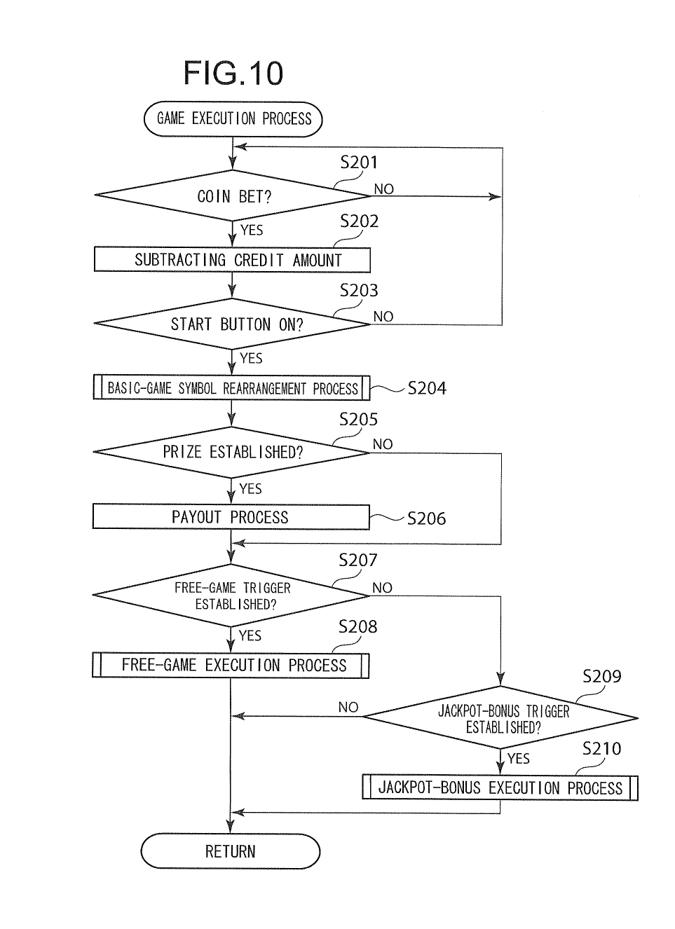

Next, the main CPU 41 performs a game execution process described later with reference to FIG. 10 (step S102). In the game execution process, the main CPU 41 sequentially reads and executes game programs or the like from the ROM 42. By performing the game execution process, the slot machine 10 executes the game according to the first embodiment. The game execution process is repeatedly performed while power is supplied to the slot machine 10.

FIG. 10 is a flowchart showing a subroutine of the game execution process invoked and executed at step S102 of the subroutine shown in FIG. 9 according to the first embodiment. Specifically, the main CPU 41 judges whether or a coin has been bet (step S201). Specifically, the main CPU 41 judges whether or not an input signal has been received, the signal being output from the 1-BET switch 26S when the 1-BET button 26 is pressed, or alternatively, being output from the MAX-BET switch 27S when the MAX-BET button 27 is pressed. The main CPU 41 controls the process to return to step S201 upon judging that no coin has been bet (step S201: NO).

On the other hand, the main CPU 41 subtracts the number of bet coins from the credit amount stored in the RAM 43 (step S202) upon judging that a coin has been bet (step S201: YES). Where the number of bet coins is larger than the credit amount stored in the RAM 43, the main CPU 41 controls the process to return to step S101 without performing the process for subtracting the number of bet coins from the credit number stored in the RAM 43. Where the number of bet coins exceeds the upper limit (fifty coins in this embodiment) of coins that can be bet in one game, the main CPU 41 controls the process to shift to step 203 without performing the process for subtracting the number of bet coins from the credit number stored in the RAM 43.

The main CPU 41 judges whether or not the start button 23 has been set to ON (step S203). Specifically, the main CPU 41 judges whether or not an input signal output from the start switch 23S at the time of pushing of the start button 23 has been received. The main CPU 41 controls the process to return to step 201 upon judging that the start button 23 has not been set to ON (step S203: NO). Where the start button 23 has not been set to ON (for example, where an instruction has been input to terminate the game without setting the start button 23 to ON), the main CPU 41 cancels acceptance of a subtraction result at step S202.

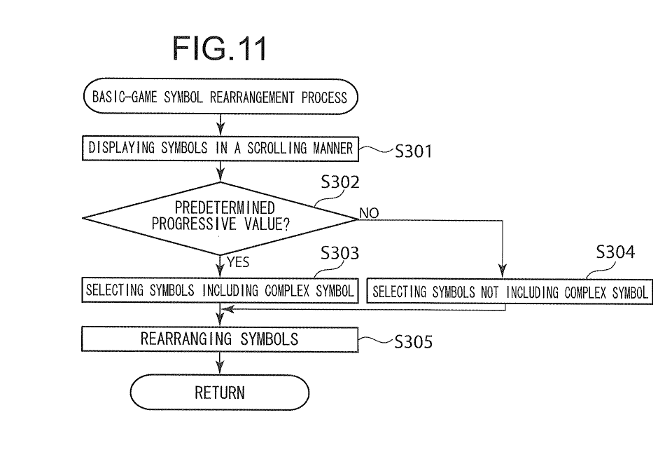

On the other hand, when the main CPU 41 judges that the start button 23 has been set to ON (step S203: YES), the main CPU 41 carries out symbol rearrangement process which will be described later with reference to FIG. 11 (step S204). Specifically, the CPU 41 executes the program stored in the RAM 43 and determines the symbols to be rearranged in the symbol matrix SM displayed on the lower image display panel 16. The symbols are determined from among the symbols, “main character” 121, “sub character” 122, “office building” 123, “gold bullion” 124, “car” 125, “stock certificate” 126, “jet” 127, and “villa” 128, and the complex symbol 129. This determination is based on the symbol weighting data and random numeric values sampled by sampling the random numeric values in a numerical range which comes under a predetermined range of random numeric values. The CPU 41 then rearranges the symbols in the symbol matrix SM.

Next, the main CPU 41 judges whether a prize has been established or not (step S205). Specifically, the main CPU 41 judges whether or not the number of symbols of respective types rearranged in the symbol matrix SM is a winning number allowed to award any of payouts. Herein, the prize is established on condition that a predetermined number of symbols of the same type are rearranged in the symbol matrix SM.

Upon judging that the prize is established (step S205: YES), the main CPU 41 then performs a coin-payout process in accordance with the amount of bet and the number of coins set for the winning number (step S206). Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66.

On the other hand, the main CPU 41 judges whether a free game trigger has been established or not (step S207) when judging that the prize has not been established (step S205: NO) or executing the process at step S206. Specifically, the main CPU 41 executes the program stored in the RAM 43 to sample the random numeric values in a numerical range which comes under a predetermined range of random numeric values, thereby judging whether or not the free game trigger has been established based on the sampled random numeric values. Upon judging that the free game trigger is established (step S207: YES), the main CPU 41 performs a free game execution process described later with reference to FIG. 11 (step S208). In this free game execution process, the main CPU 41 sequentially reads and executes the game programs or the like from the ROM 42 and performs the free game execution process.

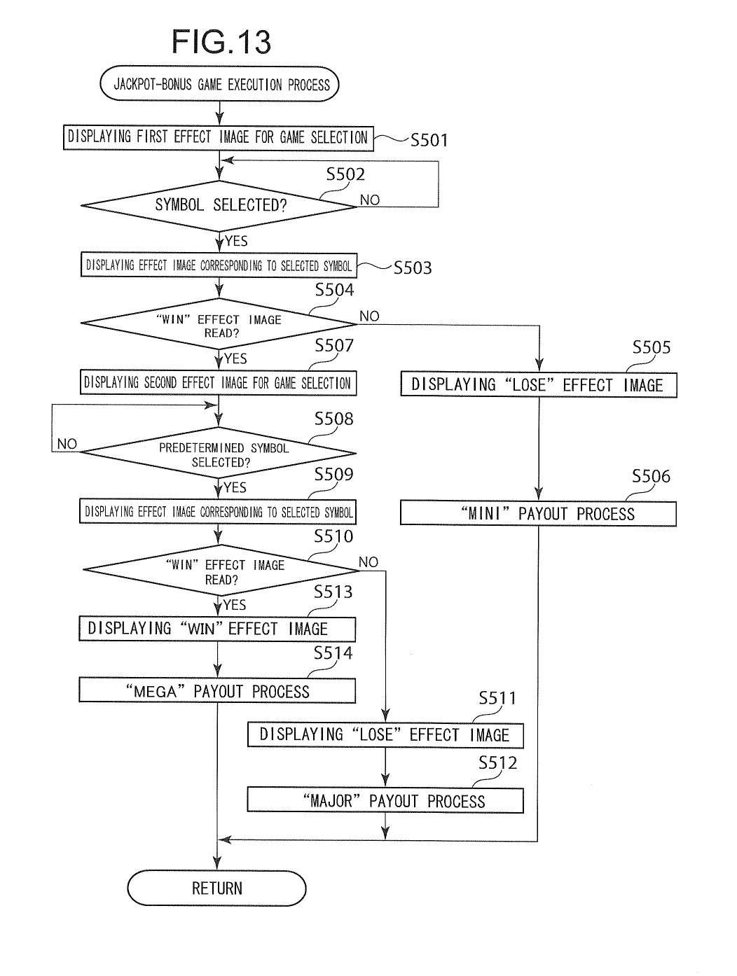

On the other hand, upon judging that the free game trigger has not been established (step S207: NO), the main CPU 41 judges whether or not a jackpot bonus game trigger has been established (step S209). Specifically, the main CPU 41 executes the program stored in the RAM 43 to sample the random numeric values in a numerical range which comes under a predetermined range of random numeric values, thereby judging whether or not the jackpot bonus game trigger has been established based on the sampled random numeric values. Upon judging that the jackpot bonus game trigger has been established (step S209: YES), the main CPU 41 performs a jackpot bonus game execution process described later with reference to FIG. 13 (step S210). In this jackpot bonus game execution process, the main CPU 41 sequentially reads and executes game programs or the like from the ROM 42, thereby executing the jackpot bonus game execution process.

The CPU 41 terminates the game execution process when judging that the jackpot bonus game trigger has not been established (step S209: NO) or when executing the process at step S208.

FIG. 11 is a flowchart showing a subroutine of the basic game symbol rearrangement process invoked and executed at step S204 of the subroutine shown in FIG. 10 according to the first embodiment. Next, the main CPU 41 displays the symbols in a scrolling manner (step S301). Specifically, the main CPU 41 successively displays in a scrolling manner the symbols that are rearranged in the symbol matrix SM displayed on the lower image display panel 16.

Next, the main CPU 41 judges whether or not a jackpot is a predetermined progressive value (step S302). Specifically, the main CPU 41 judges whether or not a value of credit for the progressive jackpot is equal to a predetermined value. Upon judging that the value is a predetermined progressive value (step S302: YES), the main CPU 41 selects the symbols including the complex symbol (step S303). Specifically, the main CPU 41 selects a storage area set in the RAM 43, for storing data of the symbols including the complex symbol. Herein, data of the complex symbol is generated so that the complex symbol composed of plural types of symbols is assigned with a jackpot symbol and then rearranged.

On the other hand, upon judging that the value is not equal to a predetermined value (step S302: NO), the main CPU 41 performs a process for selecting the symbols not including the complex symbol (step S304). Specifically, the main CPU 41 selects a storage area set in the RAM 43, for storing data of the symbols not including the complex symbol. When terminating this process, the main CPU 41 controls the process to shift to step 305.

The main CPU 41 then rearranges the symbols (step S305). Specifically, the main CPU 41 executes the program stored in the RAM 43 and determines the symbols selected at the step S303 or S304, the symbols to be rearranged in the symbol matrix SM displayed on the lower image display panel (see FIGS. 4A and 4B). The symbols are determined from among the symbols, “main character” 121, “sub character” 122, “office building” 123, “gold bullion” 124, “car” 125, “stock certificate” 126, “jet” 127, and “villa” 128, and the complex symbol 128 in the case where the symbols including the complex symbol have been selected at the step S303. This determination is based on the symbol weighting data and random numeric values sampled by sampling the random numeric values in a numerical range which comes under a predetermined range of random numeric values. The CPU 41 then rearranges the symbols in the symbol matrix SM. The main CPU 41 terminates the basic game symbol rearrangement process when executing this process.

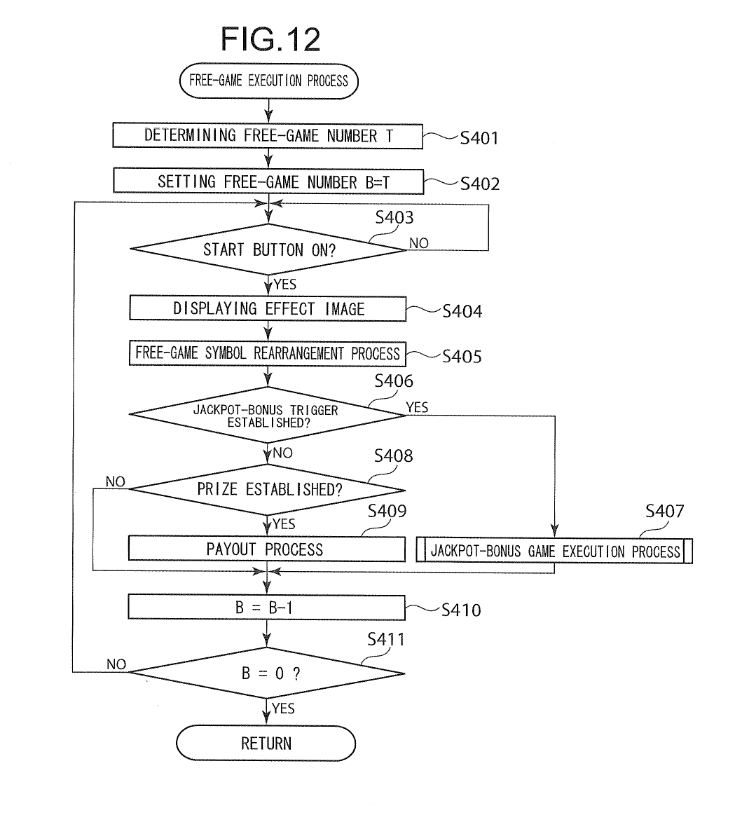

FIG. 12 is a flowchart showing a subroutine of the free game execution process invoked and executed at step S208 of the subroutine shown in FIG. 10 according to the first embodiment. First, the main CPU 41 determines a free-game number T as a number of times in executing the free game (step S401). Specifically, the main CPU 41 determines the free-game number T in accordance with a program stored in the RAM 43.

Next, the main CPU 41 performs a process for setting the free-game number B=T (step S402). Specifically, the main CPU 41 sets a remaining free-game number B=T in the storage area provided in the RAM 43, the area storing the data indicative of the remaining free-game number B as the remaining number of times in executing the free game. A value of T is equal to the free-game number T determined at step S401.

The main CPU 41 judges whether or not the start button 23 has been set to ON (step S403). Specifically, the main CPU 41 judges whether or not an input signal output from the start switch 23S at the time of pushing of the start button 23 has been received. The main CPU 41 controls the process to return to step S403 upon judging that the start button 23 has not been set to ON (step S403: NO).

Upon judging that the start button 23 has been set to ON (step S403: YES), on the other hand, the main CPU 41 performs a process for displaying an effect image (step S404). Specifically, the main CPU 41 displays the free-game number display image 90a corresponding to the number of times in executing the free game on the upper image display panel 33 (see FIG. 5).

Next, the main CPU 41 performs a free game symbol rearrangement process (step S405). Specifically, the CPU 41 executes the program stored in the RAM 43 and determines the symbols to be rearranged in the symbol matrix SM displayed on the lower image display panel 16. The symbols are determined from among the symbols, “main character” 121, “sub character” 122, “office building” 123, “gold bullion” 124, “car” 125, “stock certificate” 126, “jet” 127, and “villa” 128, and the complex symbol 129. This determination is based on the symbol weighting data and random numeric values sampled by sampling the random numeric values in a numerical range which comes under a predetermined range of random numeric values. The CPU 41 then rearranges the symbols in the symbol matrix SM.

Thereafter, the main CPU 41 judges whether the jackpot bonus trigger has been established or not (step S406). Specifically, the main CPU 41 executes the program stored in the RAM 43 to sample the random numeric values in a numerical range which comes under a predetermined range of random numeric values, thereby judging whether or not the jackpot bonus game trigger has been established based on the sampled random numeric values. Upon judging that the jackpot bonus game trigger has been established (step S406: NO), the main CPU 41 controls the process to shift to step S408.

Upon judging that the jackpot bonus game trigger has been established (step S406: YES), the main CPU 41 performs the jackpot bonus game execution process described later with reference to FIG. 13 (step S407). In this jackpot bonus game, the main CPU 41 sequentially reads and executes the game programs or the like from the ROM 42 to execute the jackpot bonus game execution process. The main CPU 41 controls the process to shift to step S410.

Next, the main CPU 41 judges whether or not a prize has been established (step S408). Specifically, the main CPU 41 judges whether or not the number of symbols of respective types rearranged in the symbol matrix SM is a winning number allowed to award any of payouts. Herein, the prize is established on condition that a predetermined number of symbols of the same type are rearranged in the symbol matrix SM.

Thereafter, upon judging that the prize has not been established (step S408: YES), the main CPU 41 performs a coin-payout process for paying out the coins of the number set for the winning number (step S409). Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66.

On the other hand, upon judging that the prize has not been established (step S408: NO) or upon executing the process at step S409 or S410, the main CPU 41 sets the remaining free-game number B=B−1 (step S410). Specifically, the main CPU 41 sets B=B−1 at a value of the free-game number B stored in the RAM 43.

The main CPU 41 then judges whether or not a value of the remaining free-game number B is equal to zero (step S411). Specifically, the main CPU 41 judges whether or not the remaining game number B stored in the RAM 43 is equal to zero. Upon judging that the value of the remaining free-game number B is not zero (step S411: NO), the main CPU 41 controls the process to return to step S403.

On the other hand, upon judging that the value of B is equal to zero (step S411: YES), the main CPU 41 terminates the free game execution process.

FIG. 13 is a flowchart showing a subroutine of a jackpot bonus game execution process invoked and executed at step S210 of the subroutine shown FIG. 10 and step S407 of the subroutine shown in FIG. 12 according to the first embodiment. First, the main CPU 41 displays the first effect image (step S501). Specifically, the main CPU 41 displays the jackpot bonus game display image 90b indicative of start of the jackpot bonus game on the upper image display panel 33 and the selection screen through which a type of the jackpot is determined (see FIG. 6) in the display region 92.

Next, the main CPU 41 judges whether or not the symbol has been selected (step S502). Specifically, the main CPU 41 judges whether or not one has been selected through the touch panel 69 (see FIG. 6B) from among the symbols displayed on the selection screen for determining a type of the jackpot game. Upon judging that the symbol has not been selected (step S502: NO), the main CPU 41 returns the process to step S502.

On the other hand, upon judging that one symbol has been selected (step S502: YES), the main CPU 41 displays an effect image corresponding to the selected symbol (step S503). Specifically, the main CPU 41 sequentially reads the effect image corresponding to the selected symbol from the ROM 42, and displays the read effect image in the display region 92 (see FIG. 7A).

Next, the main CPU 41 judges whether or not the read effect image is a “Win” effect image (step S504). Specifically, the main CPU 41 judges whether or not the effect image read at step S503 is the “Win” effect image (see FIG. 7B). Upon judging that the read image is not the “Win” effect image (step S504: NO), the main CPU 41 then displays a “Lose” effect image (step S505). Specifically, the main CPU 41 reads an effect image corresponding to the “Lose” effect image from ROM 42, and displays the effect image in the display region 92 (see FIG. 8A). Next, the main CPU 41 executes a “Mini” payout process (step S506). Specifically, the main CPU 41 performs a payout process corresponding to a “Mini” payout. Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66. The main CPU 41 terminates the jackpot bonus execution process when executing the process at step S506.

On the other hand, upon judging that the “Win” effect image has been read (step S504: YES), the main CPU 41 displays the second effect image for game selection (step S507). Specifically, the main CPU 41 displays in the display region 92 a selection screen through which a type of the jackpot game is determined, in a manner to make the symbol identifiable, the symbol selected at step S502 (see FIG. 8B).

Next, the main CPU 41 judges whether or not a predetermined symbol has been selected (step S508). Specifically, the main CPU 41 judges whether or not a symbol other than the symbol selected at step S502 has been selected through the touch panel 69. Upon judging that the predetermined symbol has not been selected (step S508: NO), the main CPU 41 controls the process to return to step S508.

On the other hand, upon judging that the predetermined symbol has been selected (step S508: YES), the main CPU 41 displays the effect image corresponding to the selected symbol (step S509). Specifically, the main CPU 41 sequentially reads the effect image corresponding to the selected symbol from the ROM 42, and displays the read effect image in the display region 92.

Next, the main CPU 41 judges whether or not the read effect image is the “Win” effect image (step S510). Specifically, the main CPU 41 judges whether or not the effect image read at step S509 is the “Win” effect image. Upon judging that the read image is not the “Win” effect image (step S510: NO), the main CPU 41 then displays a “Lose” effect image (step S511). Specifically, the main CPU 41 reads the effect image corresponding to the “Lose” effect image form ROM 42, and displays this image in the display region 92. Next, the main CPU 41 executes a “Major” payout process (step S512). Specifically, the main CPU 41 performs a payout process corresponding to a “Major” payout. Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66. The main CPU 41 terminates the jackpot bonus execution process when executing the process at step S512.

On the other hand, upon judging that the read effect image is the “Win” effect image (step S510: YES), the main CPU 41 displays the “Win” effect image (step S513). Specifically, the main CPU 41 reads an effect image corresponding to the “Win” effect image from the ROM 42, and displays the effect image in the display region 92. Next, the main CPU 41 executes a “Mega” payout process (step S514). Specifically, the main CPU 41 performs a payout process corresponding to a “Mega” payout. Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66. The main CPU 41 terminates the jackpot bonus execution process when executing the process at step S514.

### 2. Second Embodiment

Next, a slot machine 100 according to a second embodiment will be described in detail with reference to the drawings. Here, the slot machine according to the second embodiment described below is a so-called hybrid type slot machine, which has a transparent liquid crystal panel allocated in front of a plurality of mechanical reels supported in a rotatable manner, and executes a game by displaying images of various types of symbols drawn on an outer peripheral surface of the mechanical reels through the transparent liquid crystal panel. The slot machine according to the second embodiment has an appearance, circuitry, and the like that are substantially the same as those of the slot machine 10 according to the first embodiment. Thus, a duplicated explanation is omitted here. In addition, the constituent elements corresponding to those of the slot machine 10 are designated by the same reference numerals and are explained.

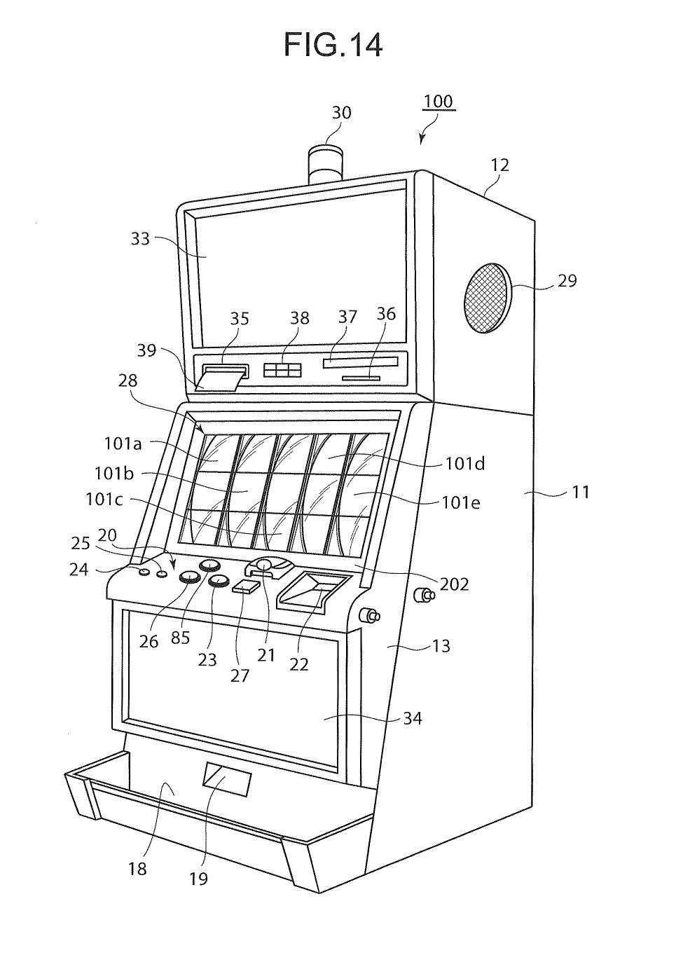

FIG. 14 is a view for schematically showing an appearance of the slot machine according to the second embodiment. As shown in FIG. 14, the slot machine 100 is rotatably provided with five reels 101a to 101e. A symbol column made up of the symbols “main character” 121, “sub character” 122, “office building” 123, “gold bullion” 124, “car” 125, “stock certificate” 126, “jet” 127, and “villa” 128 is drawn on the respective one of the outer circumferential surfaces of the reels 101a to 101e.

A main liquid crystal panel 202 formed of a transparent liquid crystal panel, which is disposed at the main door, is provided in front of the respective reels 101a to 101e. The main liquid crystal panel 202 displays the symbol display region 28 with visually recognizable rear surface so as to surround symbols displayed in the reels 101a to 101e in a stopped state, respectively. The symbols drawn on the reels 101a to 101e are visualized by rendering the symbol display region 28 transparent.

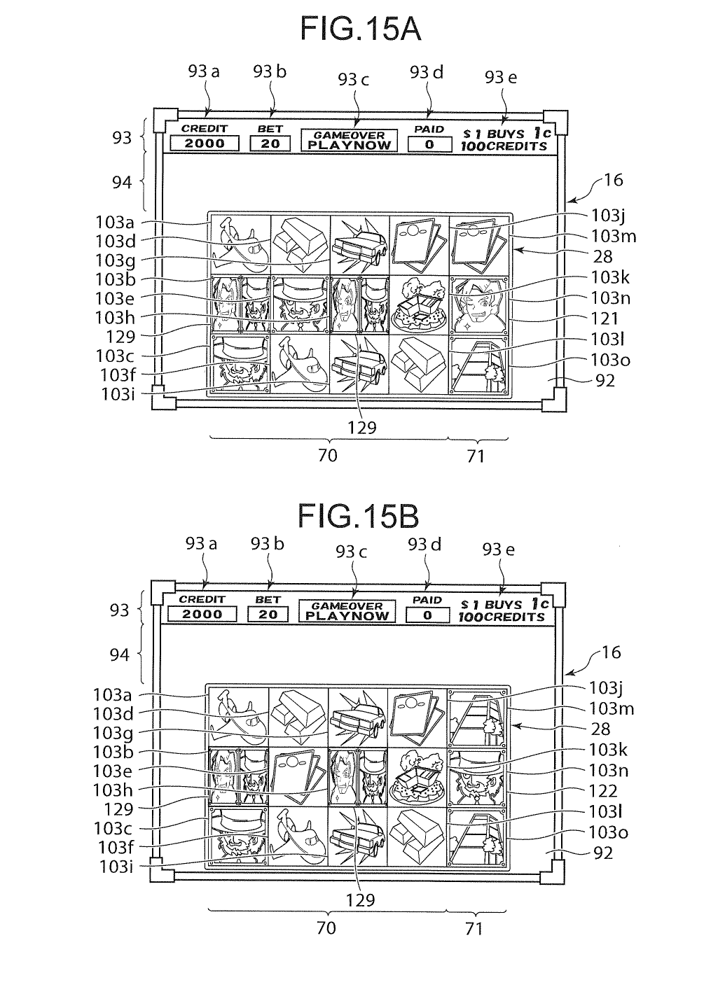

FIGS. 15A and 15B are views each showing an exemplary symbol matrix during the basic game. As shown in FIGS. 15A and 15B, the symbol display region 28 is displayed on the main liquid crystal panel 202 included in the slot machine 100 of the present invention. Further, the total of five reels 101a to 101e in five columns are rotatably provided behind the liquid crystal panel 202.

As shown in FIG. 15A, when rotation of the reels 101a to 101e is stopped, the display windows 103 within the symbol display region 28 of the lower image display panel 16 display the total of fifteen symbols in three rows and five columns in a stopped state from among the symbols “main character” 121, “sub character” 122, “office building” 123, “gold bullion” 124, “car” 125, “stock certificate” 126, “jet” 127, and “villa” 128. Further, in the case where a jackpot is a predetermined progressive value, the complex symbol 129 is rearranged in a superimposed manner on the reels 101a to 101e by means of the liquid crystal panel 202. In this case, by means of the liquid crystal panel 202, the two complex symbols 129 and the symbol “main character” 121 are rearranged in a superimposed manner on the display windows 103b, 103h, 103n, respectively, so that the free game is to be executed.

As shown in FIG. 15B, when rotation of the reels 101a to 101e is stopped, the display windows 103 within the symbol display region 28 of the lower image display panel 16 display the total of fifteen symbols in three rows and five columns in a stopped state from among the symbols “main character” 121, “sub character” 122, “office building” 123, “gold bullion” 124, “car” 125, “stock certificate” 126, “jet” 127, and “villa” 128. Further, in the case where a jackpot is a predetermined progressive value, the complex symbol 129 is rearranged in a superimposed manner on the reels 101a to 101e by means of the liquid crystal panel 202. In this case, by means of the liquid crystal panel 202, the two complex symbols 129 and the symbol “sub character” 122 are rearranged in a superimposed manner on the display windows 103b, 103h, 103n, respectively, so that the jackpot bonus game is to be executed.

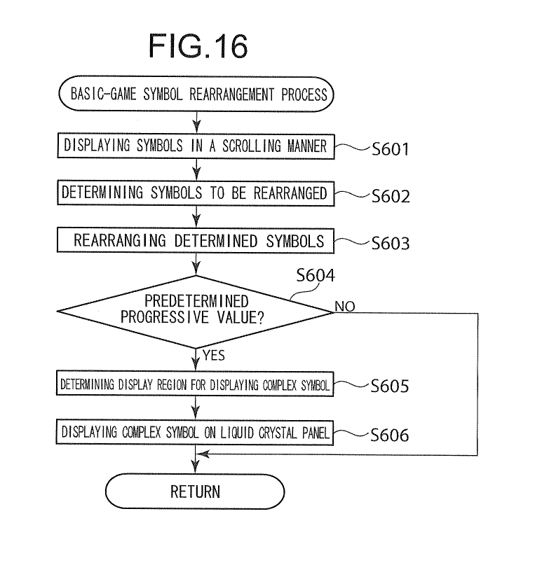

FIG. 16 is a flowchart showing a subroutine of a basic game rearrangement process invoked and executed at step S204 of the subroutine shown in FIG. 10 according to the second embodiment. First, the main CPU 41 displays the symbols in a scrolling manner (step S601). Specifically, the main CPU 41 successively displays in a scrolling manner the symbols to be rearranged in the symbol display region 28 displayed on the lower image display panel.

The main CPU 41 then determines the symbols to be rearranged (step S602). Specifically, the CPU 41 executes the program stored in the RAM 43 and determines the symbols to be rearranged in the symbol display region 28 of the lower image display panel 16. The symbols are determined from among the symbols, “main character” 121, “sub character” 122, “office building” 123, “gold bullion” 124, “car” 125, “stock certificate” 126, “jet” 127, and “villa” 128 drawn on the reels 101a to 101e. This determination is based on random numeric values sampled by sampling the random numeric values in a numerical range which comes under a predetermined range of random numeric values.

Next, the main CPU 41 rearranged the determined symbols (step S603). Specifically, the main CPU 41 rearranges the symbols in the display windows 103 by displaying the reels 101a to 101e in a stopped state based on the symbols determined at step S602.

The main CPU 41 then judges whether or not a jackpot is a predetermined progressive value (step S604). Specifically, the main CPU 41 judges whether or not a value of credit for the progressive jackpot is equal to a predetermined value. Upon judging that the value is not a progressive value (step S605: NO), the main CPU 41 terminates the basic game symbol rearrangement process.

On the other hand, upon judging that the value is a progressive value (step S605: YES), the main CPU 41 determines a display region for displaying the complex symbol (step S605). Specifically, the main CPU 41 determines which of the display windows 103a to 103o of the symbol display region 28 displays the complex symbol.

The main CPU 41 then displays the complex symbol on the liquid crystal panel (step S606). Specifically, the main CPU 41 generates data of the complex symbol so that the complex symbol composed of plural types of symbols is assigned with a jackpot symbol, the data being stored in the RAM 43. The main CPU 41 then displays the complex symbol in the display window 103 which is determined at the step S605 (see FIG. 13). The main CPU 41 terminates the basic game symbol rearrangement process when executing this process.

### 3. Third Embodiment

First, a slot machine 10 according to a third embodiment will be described in detail with referring to the drawings. The slot machine according to the below third embodiment is a so-called video slot machine, which has an image display panel such as a liquid crystal display and executes a game by displaying images of various symbols on the image display panel.

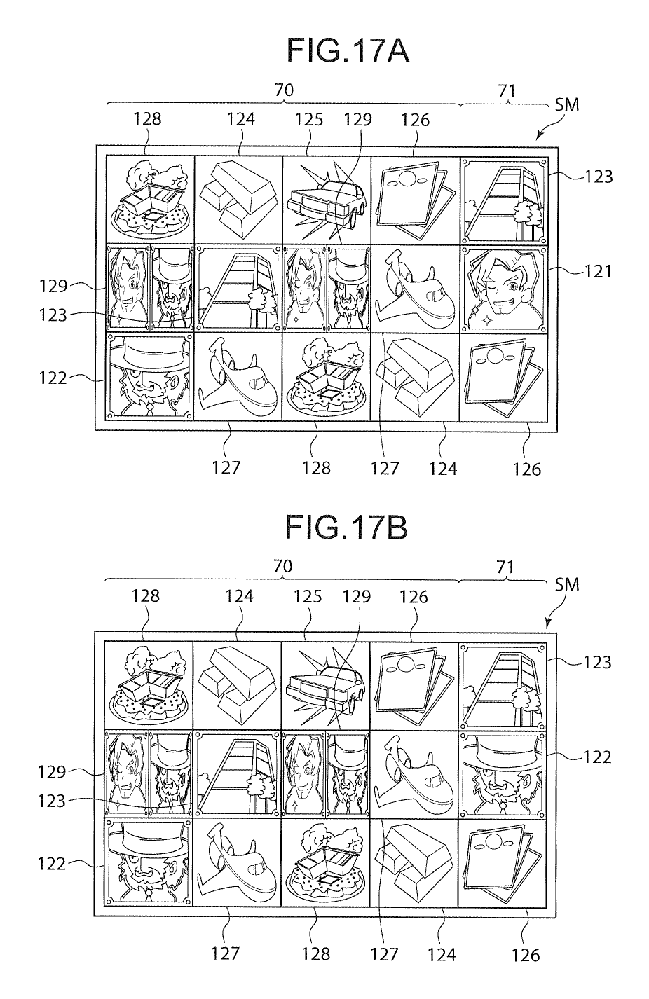

FIGS. 17A and 17B are views each showing an exemplary symbol matrix during a basic game according to the third embodiment. The slot machine 10 according to the present invention executes any one of three modes of games, i.e., a basic game, a free game, and a progressive bonus game. The basic game is executed upon consuming a gaming value corresponding to the amount bet by a player. The free game is executed without consuming a gaming value. The progressive bonus game is executed when a predetermined progressive value is obtained. While the slot machine 10 is of a stand-alone type, which is not connected to a network, the present invention is also applicable to a networked slot machine.

As shown in FIGS. 17A and 17B, elements of the symbol matrix SM are displayed on the lower image display panel 16 described later, included in the slot machine 10. The elements of the symbol matrix SM are made up of a total of fifteen symbols in three rows and five columns.

In the third embodiment of the present invention, any of single symbols, “main character 121”, “sub character 122”, “office building 123”, “gold bullion 124”, “car 125”, “stock certificate 126”, “jet 127”, and “villa 128” are rearranged in the elements of the symbol matrix SM. A payout is determined based on the number of symbols of respective types rearranged in the elements of the symbol matrix SM. Further, the symbols are rearranged while a horizontal or vertical direction of two symbol image data is reduced so that a jackpot symbol can be added to the combined symbol 129 in response to the jackpot symbol rendering a predetermined progressive value.

As shown in FIG. 17A, when the predetermined progressive value is obtained during the basic game, in a first display region 70 of the symbol matrix SM, the symbols, “main character 121”, “sub character 122”, “office building 123”, “gold bullion 124”, “car 125”, “stock certificate 126”, “jet 127”, “villa 128”, and “combined symbol 129” are rearranged in any of the elements of the symbol matrix SM. In a second display region 71, the symbols, “main character 121”, “sub character 122”, “office building 123”, “gold bullion 124”, “car 125”, “stock certificate 126”, “jet 127”, and “villa 128” are rearranged in any of the elements of the symbol matrix SM. In this case, a combination of two “combined symbols 129” and one “main character 121” is rearranged. The free game is executed, since each of the “combined symbols 129” is formed by combining the symbols of the main character 121 and the sub character 122 with each other. Thus, the free game is to be executed.

As shown in FIG. 17B, when the predetermined progressive value is obtained during the basic game, in the first display region 70 of the symbol matrix SM, the symbols, “main character 121”, “sub character 122”, “office building 123”, “gold bullion 124”, “car 125”, “stock certificate 126”, “jet 127”, “villa 128”, and “combined symbol 129” are rearranged in any of the elements of the symbol matrix SM. In the second display region 71, the symbols, “main character 121”, “sub character 122”, “office building 123”, “gold bullion 124”, “car 125”, “stock certificate 126”, “jet 127”, and “villa 128” are rearranged in any of the elements of the symbol matrix SM. In this case, a combination of two “combined symbols 129” and one “sub character 122” is rearranged. The jackpot bonus game is executed, since each of the “combined symbols 129” is formed by combining the symbols of the main character 121 and the sub character 122 with each other.

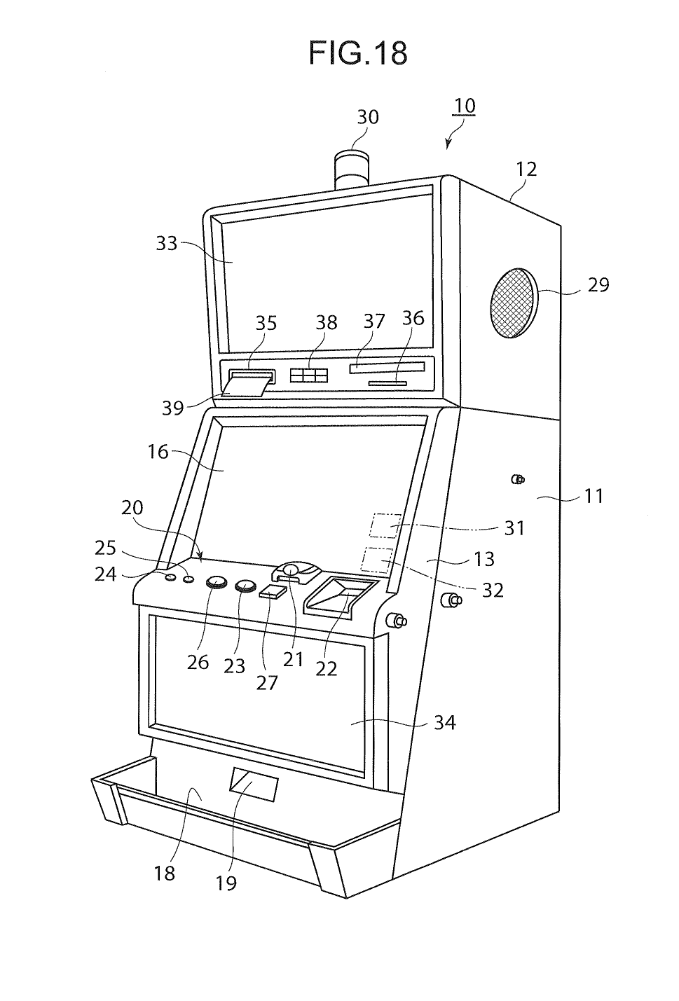

FIG. 18 is a view schematically depicting a frame format of an appearance of the slot machine according to the third embodiment of the present invention. The gaming media used in the slot machine 10 include coins, bills, or electronic value information equivalent thereto. In the present invention, however, the gaming media are not limitative thereto in particular, and can include medals, tokens, electric money, and tickets, for example. The above tickets are not limitative in particular, and can include barcode-attached tickets or the like, as described later, for example.

The slot machine 10 is provided with a cabinet 11, a top box 12 installed on an upper side of the cabinet 11, and a main door 13 provided on a front surface of the cabinet 11.

The lower image display panel 16 serving as a display device is provided in front of the main door 13. The lower image display panel 16 is provided with a liquid crystal panel, which displays the fifteen elements of the symbol matrix SM in three rows and five columns. A single symbol is arranged in each of the elements of the symbol matrix SM.

A credit amount display section 31 of the lower image display panel 16 displays the number of coins credited by way of an image. A payout amount display unit 32 displays by way of image the number of, for example, coins to be paid if a predetermined number of symbols or more of respective types are rearranged in the elements of the symbol matrix SM 28.

Provided on a lower side of the lower image display panel 16 are a control panel 20 having a plurality of buttons 23 to 27 through which command regarding the process of the game will be input by a player, a coin receiving slot 21 for receiving coins into the cabinet 11, and a bill validator 22.

On the control panel 20, a start button 23, a change button 24, a cashout button 25, a 1-BET button 26, and a MAX-BET button 27 are provided. The start button 23 is intended for entering a command for starting the game. The change button 24 is intended for use in asking an attendant of the gaming facility for change. The cashout button 25 is intended for entering a command for paying out the credited coins to a coin tray 18 through a coin payout exit 19.

[The 1-BET button 26 is intended for entering a command for betting one coin among the credited coins on the game. The MAX-BET button 27 is intended for entering a command for betting the upper number (fifty coins in this embodiment) of coins that can be bet per game among the credited coins on the game.

The bill validator 22 validates whether or not a bill is legitimate and accepts a legitimate bill into the cabinet 11. The bill validator 22 may be configured so that a barcode-attached ticket 39 described later is readable thereby. Provided on a lower front surface of the main door 13, that is, at a lower part of the control panel 20, is a berry glass 34 on which characters of the slot machine 10 and the like are depicted.

On a front surface of the top box 12, an upper image display panel 33 is provided. The upper image display panel 33 has a liquid crystal panel, which displays images for introducing the game contents or explaining game rules, for example.

Also, on the top box 12, a speaker 29 and a lamp 30 are provided. On a lower side of the upper image display panel 33, a ticket printer 35, a card reader 36, a data display unit 37, and a key pad 38 are provided. The ticket printer 35 prints on the ticket, a barcode having encoded thereon data such as the credit amount, the date and time, and the identification number of the slot machine 10, and outputs the printed ticket as the barcode-attached ticket 39. The player can play the game on another slot machine with the barcode attached ticket 39 by causing this slot machine to read the barcode attached ticket 39. Alternatively, the player can exchange the barcode-attached ticket 39 with the bills or the like at a predetermined place (at a cashier inside a casino, for example) of the gaming facility.

The card reader 36 reads data from and write data into a smart card. The smart card is to be owned by the player, which stores data for identifying the player or data regarding the log of games executed by the player, for example. The smart card may store data corresponding to coins, bills, or a credit. As an alternative of a smart card, a magnetic stripe card may be employed. The data display 37 is made up of a fluorescent display and the like, and displays the data read by the card reader 36 or the data input by the player through the key pad 38, for example. The key pad 38 inputs data and commands regarding the ticket issuance or the like.

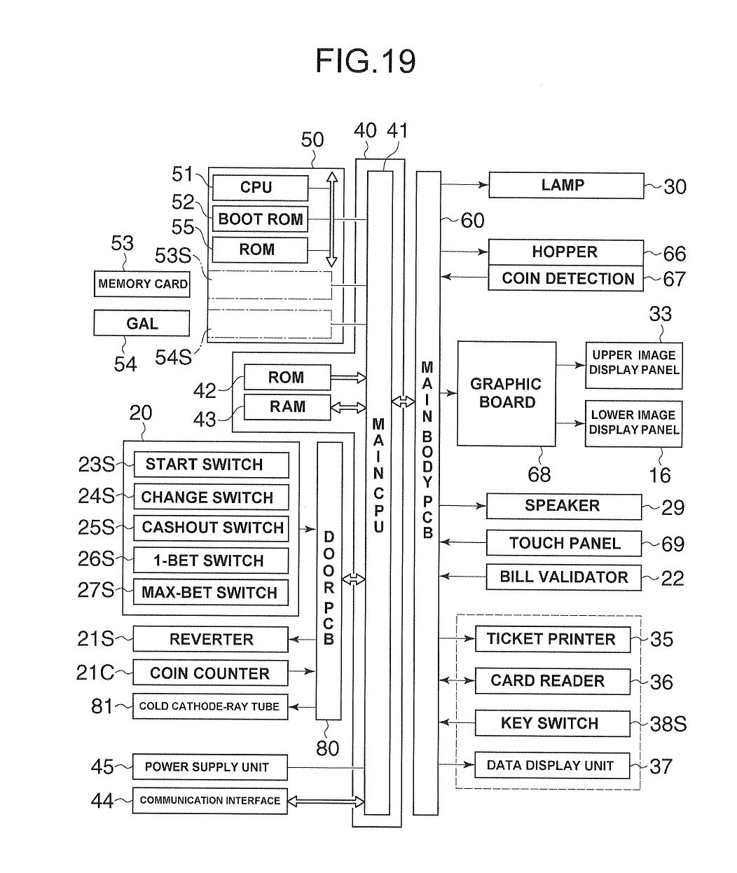

FIG. 19 is a block diagram depicting an internal construction of the slot machine shown in FIG. 18. A gaming board 50 includes: a CPU (Central Processing Unit) 51, a ROM (Read Only Memory) 55 and a boot ROM 52 interconnected by an internal bus; a card slot 53S corresponding to a memory card 53; and an IC socket 54S corresponding to a GAL (Generic Array Logic) 54.

The memory card 53 is formed of a nonvolatile memory such as Compact Flash (registered trademark) and stores game programs. The game programs include a symbol selection program. The aforementioned symbol selection program is intended for determining the symbols to be rearranged in the elements of the symbol matrix SM 28. The aforementioned symbol selection program includes symbol weighing data, respectively, corresponding to plural types of payout ratios (80%, 84%, and 88%, for example). The symbol weighing data is indicative of the correspondence relationship between the respective symbols and one or more random numeric values which come under a predetermined numerical range (0 to 255). The payout ratio is determined according to the payout-ratio setting data output from the GAL 54. The symbols to be rearranged in the elements of the symbol matrix SM 28 are determined depending upon the symbol weighing data corresponding to the payout ratio. Further, the game programs include table data indicating the correspondence relationship between each of the symbols and a payout.

Also, the card slot 53S is configured to allow the memory card 53 to be inserted thereinto or ejected therefrom, and is connected to a motherboard 40 through an IDE pass. Accordingly, the memory card 53 can be ejected from the card slot 53S, other game programs and other game system programs can then be written into the memory card 53, and further, the memory card 53 can be inserted into the card slot 53S, thereby allowing the player to change the types and contents of games executed in the slot machine 10. The game program includes programs concerning a game progress. Furthermore, the game program includes image data or sound data to be output during the game. The image data include, for example, image data indicative of the symbol matrix.

The GAL 54 is a type of a PLD having a fixed OR array structure. The GAL 54 includes plural input ports and plural output ports. Where predetermined data is input to the input port, the GAL 54 outputs data corresponding to the aforementioned data from the output port. The data output from this output port is equivalent to the aforementioned payout-ratio setting data. Further, the IC socket 54S is configured to allow the GAL 54 to be attached thereto and detached therefrom, and is connected to the motherboard 40 by a PCI bus. Accordingly, the GAL can be replaced with the replacement GAL 54 to change the payout-ratio setting data.

The CPU 51, the ROM 55, and the boot ROM 52 interconnected by the internal bus are connected to the motherboard 40 by the PCI bus. The PCI bus serves to transmit signals between the motherboard 40 and the gaming board 50 and supply power from the motherboard 40 to the gaming board 50.

The motherboard 40 is constructed using a general-purpose motherboard commercially available (a printed circuit board on which essential parts of a personal computer are mounted) and includes: a main CPU (Central Processing Unit) 41, a ROM (Read Only Memory) 42; a RAM (Random Access Memory) 43; and a communication interface 44. The main CPU 41 functions as a processor for controlling a display device and a memory according to the embodiment of the present invention.

The ROM 42 is made up of a memory device such as a flash memory and stores thereon a program such as BIOS (Basic Input/Output System) executed by the main CPU 41, and permanent data. When the BIOS is executed by the main CPU 41, processing of initializing predetermined peripheral devices is carried out and processing of capturing game programs and game system programs stored in the memory card 53 through the gaming board 50 is started. In the present invention, the contents of the ROM 42 may be rewritable or not.

The RAM 43 stores data and a program used when the main CPU 41 is activated. The RAM 43 can also store game programs. The RAM 43 further stores data concerning the credit amount, the number of coin-in or coin-out for one game, and the like.

Both a main body PCB (Printed Circuit Board) 60 and a door PCB 80, which will be described later, are connected to the motherboard 40 by USB. A power supply unit 45 is also connected to the motherboard 40.

Connected to the main body PCB 60 and the door PCB 80 are: equipment and devices which generate input signals to be input to the main CPU 41; and equipment and devices of which operations are controlled by a control signal output from the main CPU 41. The main CPU 41 executes a game program stored in the RAM 43 based on an input signal having been input to the main CPU 41 and performs a predetermined computational process, thereby storing results thereof in the RAM 43 or transmitting a control signal to each of equipment and devices as a control process therefor.

A lamp 30, a hopper 66, a coin detecting section 67, a graphic board 68, a speaker 29, a touch panel 69, the bill validator 22, the ticket printer 35, the card reader 36, a key switch 38S, and the data display unit 37 are connected to the main body PCB 60. The lamp 30 is lit up in a predetermined pattern based on a control signal output from the main CPU 41.

The hopper 66 is installed in the cabinet 11 and pays out a predetermined number of coins from the coin payout exit 19 to the coin tray 18 based on a control signal output from the main CPU 41. The coin detecting section 67 is installed inside the coin payout exit 19 and outputs an input signal to the main CPU 41 upon detecting that a predetermined number of coins have been paid out from the coin payout exit 19.

The graphic board 68 controls, based on a control signal output from the main CPU 41, images to be displayed on the upper image display panel 33 and the lower image display panel 16. The credit amount stored in the RAM 43 is displayed on the credit amount display section 31 (see FIG. 18) of the lower image display panel 16. The number of coins to be paid out is displayed at the payout amount display section 32 (see FIG. 18) of the lower image display panel 16. The graphic board 68 is equipped with a VDP (Video Display Processor) which generates image data based on a control signal output from the main CPU 41 and a video RAM which temporarily stores image data generated by the VDP, and the like. The image data used in generating image data with VDP is contained in the game program read from the memory card 53 and stored in the RAM 43.

The bill validator 22 validates whether or not a bill is legitimate and accepts a legitimate bill into the cabinet 11. Upon accepting a legitimate bill, the bill validator 22 outputs an input signal to the main CPU 41 based on the amount of the bill. The main CPU 41 stores in the RAM 43 the credit amount corresponding to the amount of bills transmitted by the input signal.

Based on a control signal output from the main CPU 41, the ticket printer 35 prints on a ticket a barcode having encoded thereon data such as the credit amount, data and time, and the identification number of the slot machine 10 stored in the RAM 43. Further, this printer outputs the printed ticket as the barcode-attached ticket 39. The card reader 36 transmits to the main CPU 41 the data read from the smart card and writes the read data onto the smart card, based on a control signal from the main CPU 41. The key switch 38S is provided on the key pad 38, and outputs a predetermined input signal to the main CPU 41 when the player operates the key pad 38. The data display 37, based on a control signal output from the main CPU 41, displays the data read by the card reader 36 and the data input by the player through the key pad 38.

The control panel 20, a reverter 21S, a coin counter 21C, and a cold-cathode tube 81 are connected to the door PCB 80. On the control panel 20, there are provided: a start switch 23S corresponding to the start button 23; a change switch 24S corresponding to the change button 24; a cashout switch 25S corresponding to a cashout button 25; and a 1-BET switch 26S corresponding to a 1-BET button 26; and a MAX-BET switch 27S corresponding to the MAX-BET button 27. When the player operates the buttons 23 to 27, the corresponding switches 23S to 27S output input-signals to the main CPU 41, respectively.

The coin counter 21C is provided inside the coin receiving slot 21, and validates whether or not a legitimate coin is inserted by the player into the coin receiving slot 21. Those other than the legitimate coins are discharged from the coin payout exit 19. The coin counter 21C outputs an input signal to the main CPU 41 when a legitimate coin is detected.

The reverter 21S operates based on a control signal output from the main CPU 41 and distributes coins recognized as being legitimate by the coin counter 21C into a cash box (not shown in the drawings) or the hopper 66 which is arranged in the slot machine 10. In other words, when the hopper 66 is filled with coins, legitimate coins are distributed by the reverter 21S into the cash box. On the other hand, when the hopper 66 is not filled with coins, legitimate coins are distributed into the hopper 66. The cold-cathode tube 81 functions as a backlight installed on a rear face side of each of the lower image display panel 16 and the upper image display panel 33, and is lit up based on a control signal output from the main CPU 41.

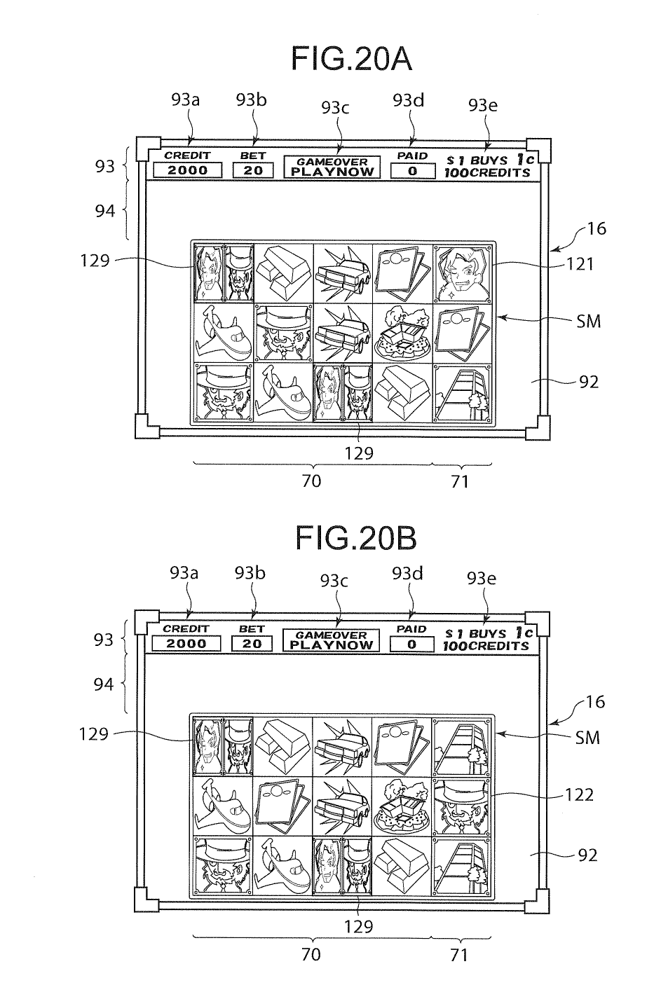

FIGS. 20A to 24B are diagrams each illustrating an exemplary image displayed on the slot machine illustrated in FIG. 18 according to the third embodiment. FIGS. 20A and 20B are diagrams each illustrating an exemplary symbol matrix displayed on the slot machine illustrated in FIG. 18 during the basic game.

As shown in FIG. 20A, the lower image display panel 16 is made up of a display region 92, an information display section 93, an effect image display section 94, and the like. The elements of the symbol matrix SM are displayed in the display region 92. The information display section 93 is arranged upwardly of the display region 92 and is made up of a credit amount display section 93a, a BET amount display section 93b, a character information display section 93c, a PAID amount display section 93d, and a charge display section 93e.

The number of coins currently credited is displayed at the credit amount display section 93a while the number of coins bet on one game is displayed at the BET amount display section 93b. The character information indicative of a current status of the game is displayed at the character information display section 93c. The characters of “PLAYNOW” are displayed during the play of the game, whereas the characters of “GAMEOVER” are displayed during the intervals between the plays of the game. The number of coins that have been successfully obtained in one game is displayed at the PAID amount display section 93d, whereas a conversion value of the credit amount based on a predetermined charge is displayed at the charge display section 93e.

The effect image display section 94 displays effect images according to a type of the present slot game. In other words, the effect image display section 94 displays different effect images between the basic and free games.

Any of symbols, “main character 121”, “sub character 122”, “office building 123”, “gold bullion 124”, “car 125”, “stock certificate 126”, “jet 127”, “villa 128”, and “combined symbol 129” are rearranged in the elements of the symbol matrix SM on the lower image display panel 16. A payout is determined based on the number of these symbols rearranged in the elements of the symbol matrix SM. The combined symbols are rearranged while a horizontal or vertical direction of two symbol image data is reduced so that the jackpot symbol can be added to the combined symbol 129 when a predetermined progressive value is obtained.

In this case, when the predetermined progressive value is obtained during the basic game, in the first display region 70 of the symbol matrix SM, the symbols, “main character 121”, “sub character 122”, “office building 123”, “gold bullion 124”, “car 125”, “stock certificate 126”, “jet 127”, “villa 128”, and “combined symbol 129” are rearranged in any of the elements of the symbol matrix SM. In the second display region 71, the symbols, “main character 121”, “sub character 122”, “office building 123”, “gold bullion 124”, “car 125”, “stock certificate 126”, “jet 127”, and “villa 128” are rearranged in any of the elements of the symbol matrix SM. In this case, a combination of two “combined symbols 129” and one “main character 121” is rearranged. The free game is executed, since each of the “combined symbols 129” is formed by combining the symbols of the main character 121 and the sub character 122 with each other.

As shown in FIG. 20B, when the predetermined progressive value is obtained during the basic game, in the first display region 70 of the symbol matrix SM, the symbols, “main character 121”, “sub character 122”, “office building 123”, “gold bullion 124”, “car 125”, “stock certificate 126”, “jet 127”, “villa 128”, and “combined symbol 129” are rearranged in any of the elements of the symbol matrix SM. In the second display region 71, the symbols, “main character 121”, “sub character 122”, “office building 123”, “gold bullion 124”, “car 125”, “stock certificate 126”, “jet 127”, and “villa 128” are rearranged in any of the elements of the symbol matrix SM. A combination of two “combined symbols 129” and one “sub character 122” is rearranged. The jackpot bonus game is executed, since each of the “combined symbols 129” is formed by combining the symbols of the main character 121 and the sub character 122.

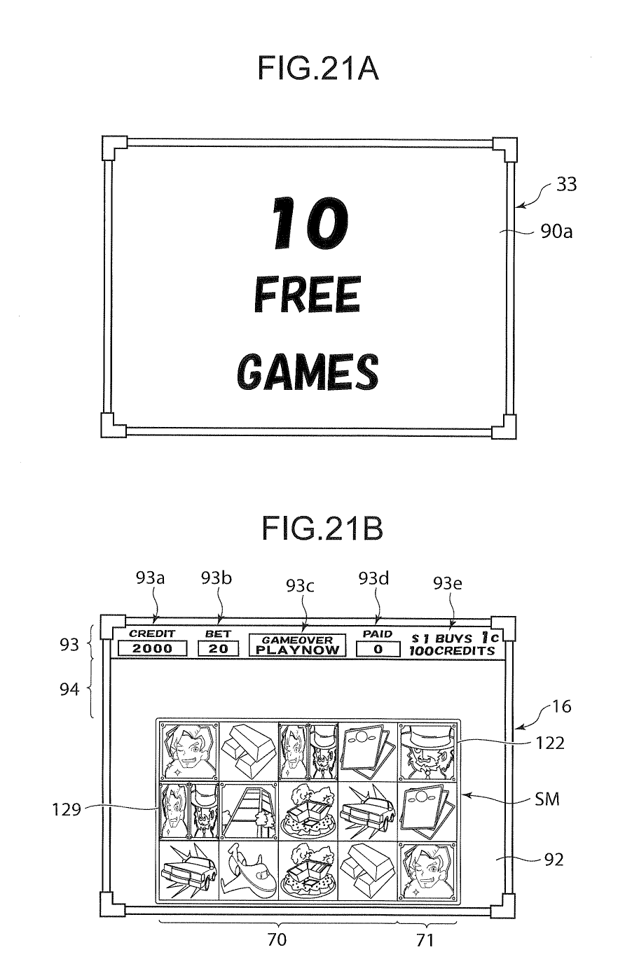

FIG. 21A is a diagram illustrating an exemplary image displayed in the slot machine 10 shown in FIG. 18. FIG. 21B is a diagram illustrating an exemplary symbol matrix, during the free game according to the third embodiment. As shown in FIG. 21A, when the symbols rearranged in the elements of the symbol matrix SM in FIG. 20A are rearranged to match a combination for executing the free game, i.e., the combination of the two “combined symbols 129” and one “main character 121”, the free game is started. Upon starting the free game, the upper image display panel 33 displays a free-game-number display image 90a indicative of the number of times in executing the free games. In this case, the free-game-number display image 90a of “10 FREE GAMES” is displayed indicating that the number of times in executing the free games is determined to be 10 times.

As shown in FIG. 21B, when a predetermined progressive value is obtained during the bonus game, in the first display region 70 of the symbol matrix SM, the symbols, “main character 121”, “sub character 122”, “office building 123”, “gold bullion 124”, “car 125”, “stock certificate 126”, “jet 127”, “villa 128”, and “combined symbol 129” are rearranged in any of the elements of the symbol matrix SM. In the second display region 71, the symbols, “main character 121”, “sub character 122”, “office building 123”, “gold bullion 124”, “car 125”, “stock certificate 126”, “jet 127”, and “villa 128” are rearranged in any of the elements of the symbol matrix SM. In this case, a combination of two “combined symbols 129” and one “sub character 122” is rearranged. The jackpot bonus game is executed, since each of the “combined symbols 129” is formed by combining the symbols of the main character 121 and the sub character 122 with each other.

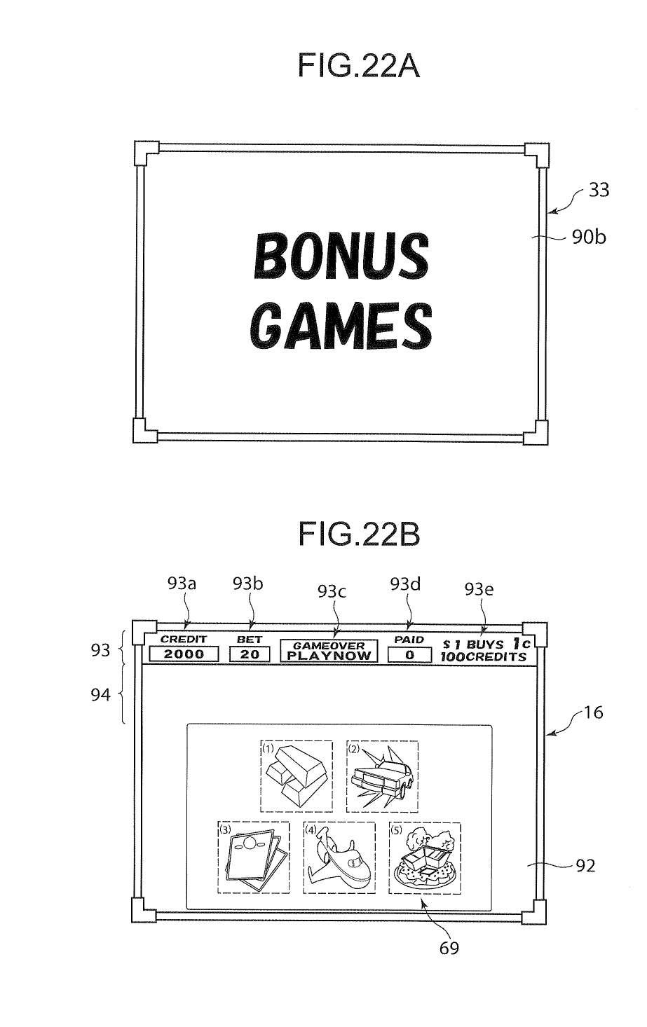

FIGS. 22A and 22B are diagrams each illustrating an exemplary image displayed in the slot machine 10 according to the third embodiment, shown in FIG. 18, during the jackpot bonus game. As shown in FIG. 22A, when the symbols rearranged in the elements of the symbol matrix SM in FIG. 20A are rearranged to match a combination for executing the free game in FIG. 20B, i.e., the combination of the two “combined symbols 129” and one “sub character 122”, the jackpot bonus game is started. Upon judging the start of the jackpot bonus game, the upper image display panel 33 displays a jackpot bonus game display image 90b indicative of the start of the jackpot bonus game. The jackpot bonus game display image 90b of “BONUS GAME” is displayed indicating that the jackpot bonus game has been started.

As shown in FIG. 22B, upon starting the jackpot bonus game, the display region 92 displays a selection screen for determining types of jackpot bonus games. In this case, the display region 92 displays symbols of (1) to (5) made up of “gold bullion 124”, “car 125”, “stock certificate 126”, “jet 127”, and “villa 128”, and displays in such a manner that the symbols are selected via the touch panel 69 to select the types of the jackpot bonus games.

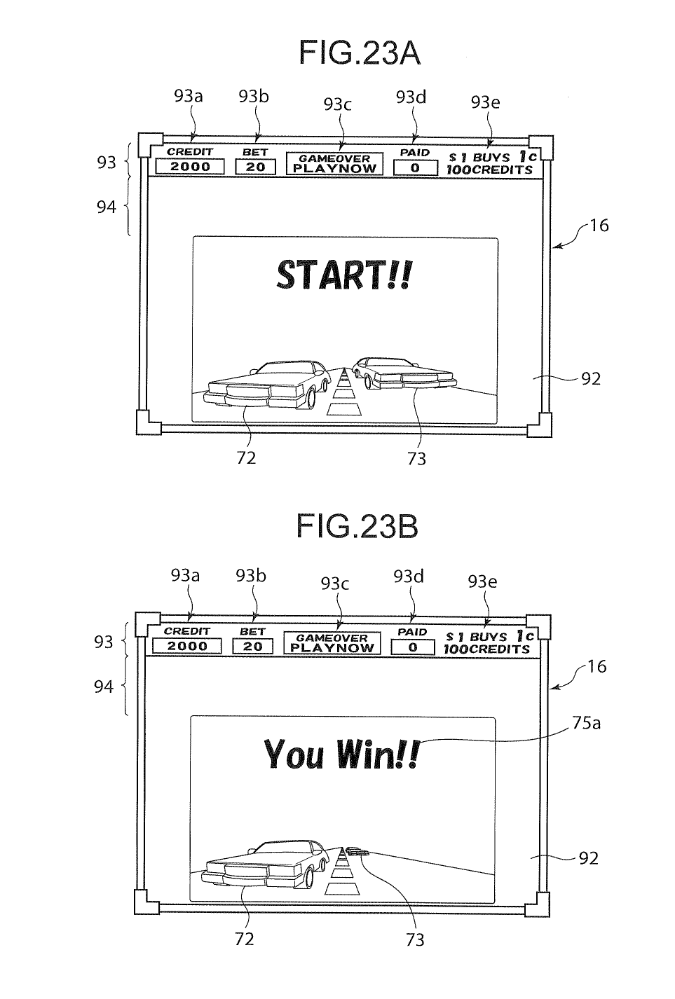

FIGS. 23A and 23B are diagrams each illustrating an exemplary image displayed in the slot machine 10 according to the third embodiment, shown in FIG. 18, during the jackpot bonus game. As shown in FIG. 23A, the jackpot bonus game is displayed which corresponds to the symbol selected in FIG. 22B. When the symbol (2) is selected in FIG. 22B, the jackpot bonus game of a car race is started. After that, a car-race start screen is displayed which constitutes the main character effect image 72 and the sub character effect image 73.

As shown in FIG. 23B, a win-or-lose screen of the jackpot bonus game corresponding to the symbol selected in FIG. 22B is displayed. In this case, when the symbol (2) is selected in FIG. 22B and the main character effect image 72 wins in the jackpot bonus game of the car race, a win-or-lose information display 75a of “You Win” is displayed.

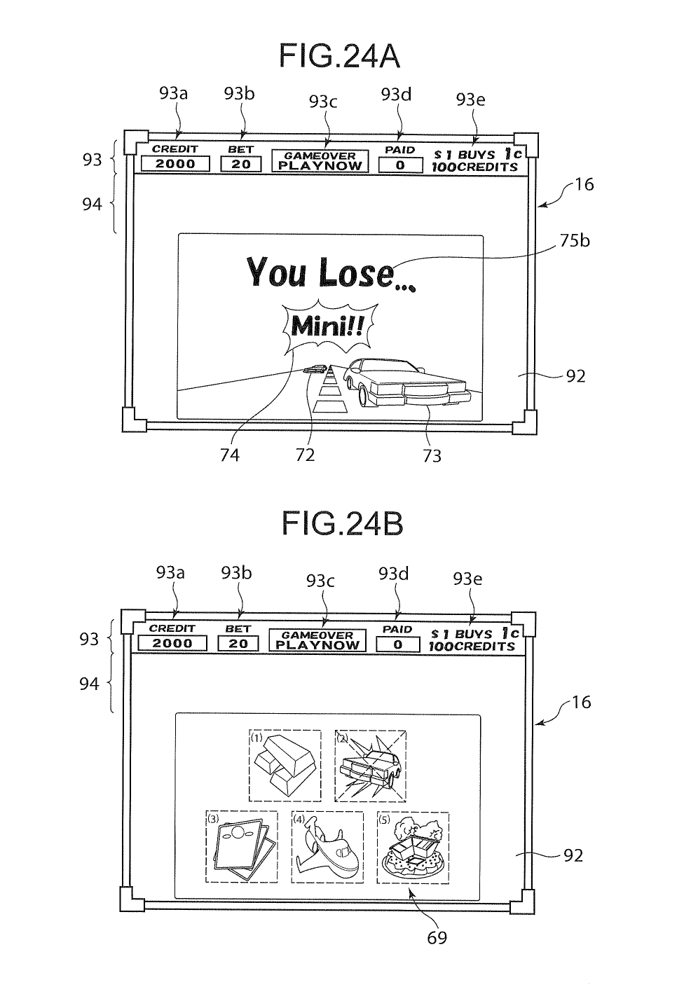

FIGS. 24A and 24B are diagrams each illustrating an exemplary image displayed in the slot machine 10 according to the third embodiment, shown in FIG. 18, during the jackpot bonus game. As shown in FIG. 24A, a win-or-lose screen of the jackpot bonus game is displayed which corresponds to the symbol selected in FIG. 22B. When the symbol (2) is selected in FIG. 22B and the sub character effect image 73 wins in the jackpot bonus game of a car race, a win-or-lose information display 78b of “You Lose” is displayed. A payout display image 74 of “Mini” is displayed which is indicative of types of payouts of the jackpot, and then, the payout corresponding to “Mini” is awarded.

As shown in FIG. 24B, the display region 92 displays a selection screen of the jackpot bonus game corresponding to the symbol selected in FIG. 22B. When the symbol (2) is selected in FIG. 22B and the “main character 121” wins in the jackpot bonus game of a car race (see FIG. 23B), the display region 92 displays a selection screen for determining the types of a subsequent jackpot bonus game and displays in such an identifiable manner the fact that the symbol (2) is selected last time in FIG. 22B. Selecting any other symbol from the touch panel 69 executes a subsequent jackpot bonus game.

Next, a process executed in the slot machine 10 according to the third embodiment will be described in detail with reference to the drawings. The main CPU 41 controls the progress of a game by reading out and executing the game program.

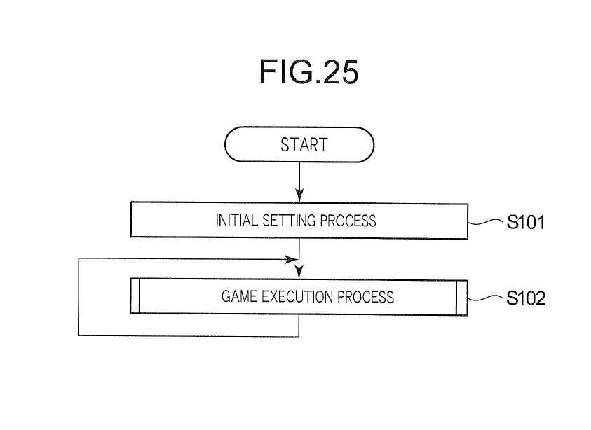

FIG. 25 is a flowchart showing a subroutine of a main process. In the main process, first, when a power switch is turned on (that is, when power is supplied), a motherboard 40 and a gaming board 50 are activated respectively, so that the CPU 51 executes an initial setting process (step S101). In this initial setting process, the main CPU 41 executes the BIOS stored in the ROM 42, and decompresses, in the RAM 43, compressed data included in the BIOS. Further, this CPU executes the BIOS decompressed in the RAM 43, and performs diagnosis and initialization of each of the peripheral devices. After that, the main CPU 41 writes game programs or the like from the ROM 42 into the RAM 43, and retrieves data for setting a payout ratio and country-identification information. The main CPU 41 also performs an authentication process for each program during execution of the initial setting process.

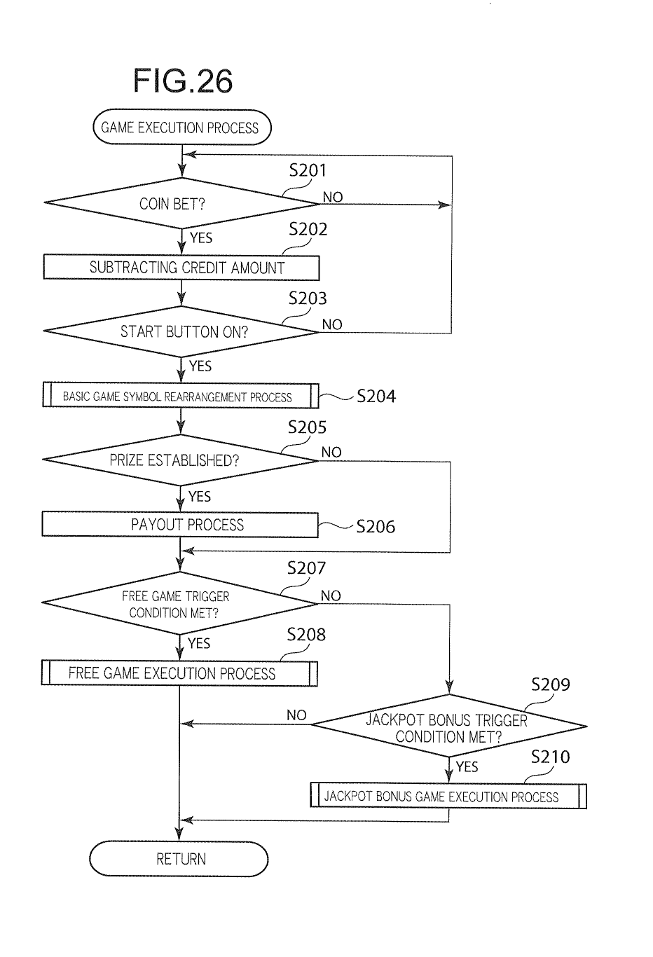

Next, the main CPU 41 performs a game execution process described later with reference to FIG. 26 (step S102). In this game execution process, the main CPU 41 sequentially reads and executes the game programs or the like from the ROM 42. By performing this game execution process, the slot machine 10 according to the third embodiment 10 executes the game. The game execution process is repeatedly performed while power is supplied to the slot machine 10.

FIG. 26 is a flowchart showing a subroutine of the game execution process invoked and performed at step S102 of the subroutine shown in FIG. 25 according to the third embodiment. First, the main CPU 41 judges whether a coin has been bet or not (step S201). Specifically, the main CPU 41 judges whether or not an input signal has been received. The input signal is output from the 1-BET switch 26S at the time of operation of the 1-BET button 26 or is output from the MAX-BET switch 27S at the time of operation of the MAX-BET button 27. The main CPU 41 controls the current step to return to the process at step S201 upon judging that no coin has been bet (step S201: NO).

On the other hand, the main CPU 41 subtracts the number of bet coins from the credit amount stored in the RAM 43 (step S202) upon judging that a coin has been bet (step S201: YES). Where the number of bet coins is larger than the credit amount stored in the RAM 43, the main CPU 41 controls the current step to return to step S101 without performing the process for subtracting the number of bet coins from the credit number stored in the RAM 43. Where the number of bet coins exceeds the upper limit (fifty coins in this embodiment) of coins that can be bet in one game, the main CPU 41 controls the step to return to step 203 without performing the process for subtracting the number of bet coins from the credit number stored in the RAM 43.

Next, the main CPU 41 judges whether or not the start button 23 has been set to ON (step S203). Specifically, the main CPU 41 judges whether or not an input signal output from the start switch 23S when the start button 23 is pressed has been received. The main CPU 41 controls the step to return to step S201 upon judging that the start button 23 has not been set to ON (step S203: NO). Where the start button 23 has not been set to ON (for example, where an instruction has been input to terminate the game without setting the start button 23 to ON), the main CPU 41 cancels acceptance of a subtraction result at step S202.

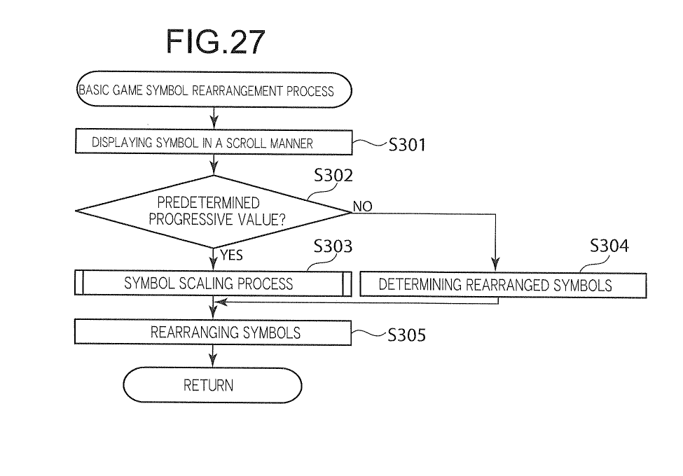

On the other hand, the main CPU 41 performs a symbol rearrangement process (step S204) described later with reference to FIG. 27 upon judging that the start button 23 has been set to ON (step S203: YES). Specifically, the main CPU 41 executes the program stored in the RAM 43 and determines the symbols to be rearranged in elements of the symbol matrix SM displayed on the lower image display panel 16. The symbols are selected from among the symbols, “main character 121”, “sub character 122”, “office building 123”, “gold bullion 124”, “car 125”, “stock certificate 126”, “jet 127”, “villa 128”, and “combined symbol 129”. This determination is based on the symbol weighing data and random numeric values sampled by sampling the random numeric values in a numerical range which comes under a predetermined range of random numeric values. The main CPU 41 then rearranges the symbols in the elements of the symbol matrix SM.

Next, the main CPU 41 judges whether a prize has been established or not (step S205). Specifically, the main CPU 41 judges whether or not the number of symbols of respective types rearranged in the elements of the symbol matrix SM is a winning number allowed to award any of payouts. Herein, the prize is established on condition that a predetermined number of symbols of the same type are rearranged in the elements of the symbol matrix SM.

Upon judging that the prize is established (step S205: YES), the main CPU 41 then performs a coin-payout process in accordance with the amount of bet and the number of coins set for the winning number (step S206). Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66.

Meanwhile, the main CPU 41 judges whether a free game trigger condition has been met or not (step S207) upon judging that the prize is not established (step S205: NO) or executing the process at step S206. Specifically, the main CPU 41 executes the program stored in the RAM 43 to sample the random numeric values in a numerical range which comes under a predetermined range of random numeric values, thereby judging whether or not the free game trigger condition has been met based on the sampled random numeric values. Upon judging that the free game trigger condition is met (step S207: YES), the main CPU 41 performs a free game execution process described later with reference to FIG. 27 (step S208). In this free game execution process, the main CPU 41 sequentially reads and executes the game programs or the like from the ROM 42 and performs the free game execution process.

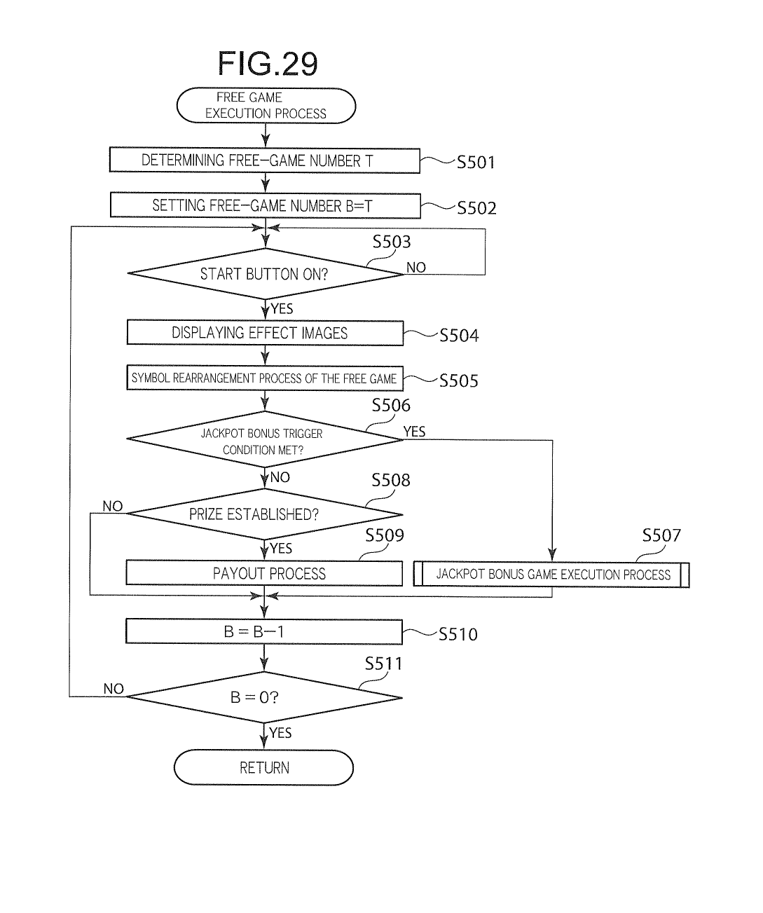

Meanwhile, the main CPU 41 judges whether a jackpot bonus game trigger condition has been met or not (step S209) when judging that the free game trigger condition is not met (step S207: NO). Specifically, the main CPU 41 executes the program stored in the RAM 43 to sample the random numeric values in a numeric-value range which comes under a predetermined range of random numeric values, thereby judging whether or not the jackpot bonus game trigger condition has been met based on the sampled random numeric values. Upon judging that the jackpot bonus game trigger condition is met (step S209), the main CPU 41 performs a jackpot bonus game execution process described later with reference to FIG. 29 (step S210). In this jackpot bonus game, the main CPU 41 sequentially reads and executes the game programs or the like from the ROM 42 and performs the jackpot bonus game execution process.

On the other hand, the main CPU 41 terminates the game execution process when judging that the jackpot bonus game trigger condition is not met (step S209: NO) or when executing the process at step S208.

FIG. 27 is a flowchart showing a subroutine of a basic symbol rearrangement process invoked and performed at step S204 of the subroutine shown in FIG. 26 according to the third embodiment. First, the main CPU 41 displays the symbols in a scrolling manner (step S301). Specifically, the main CPU 41 successively displays in a scrolling manner the symbols that are rearranged in the elements of the symbol matrix SM displayed on the lower image display panel.

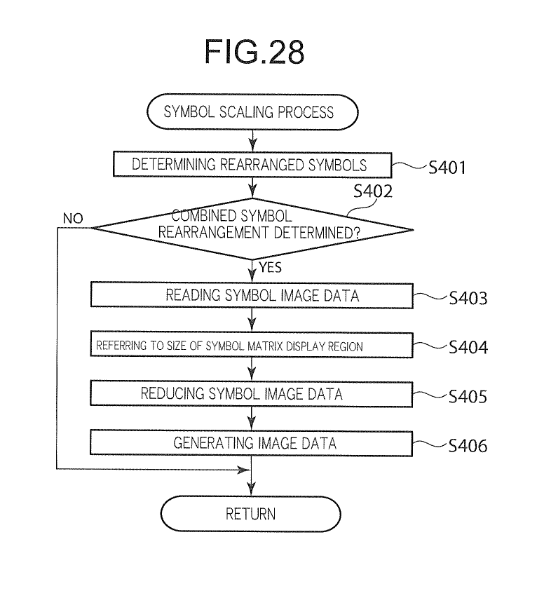

Next, the main CPU 41 judges whether or not the jackpot becomes the predetermined progressive value (step S302). Specifically, the main CPU 41 judges whether or not the value regarding the credit of the progressive jackpot is a predetermined value. Upon judging that the jackpot becomes predetermined progressive value (step S302: YES), the main CPU 41 performs a scaling process described later with reference to FIG. 28 (step S303). Specifically, the main CPU 41 reads the image data of the combined symbols from among the symbols, and reduces a horizontal or vertical direction of the read symbol image data.

On the other hand, when the main CPU 41 judge that the jackpot is not the predetermined progressive value (step S302: NO), the main CPU 41 judges the rearranged symbols (step S304). Specifically, the main CPU 41 selects a predetermined storage area, provided in the RAM 43, of symbol data. Upon terminating this process, the main CPU 41 controls the step to moves to step S305.

Next, the main CPU 41 rearranges the symbols (step S305). Specifically, the main CPU 41 executes the program stored in the RAM 43 and determines the respective symbols to be arranged, which were judged at step S303 or S304, in the elements of the symbol matrix SM displayed on the lower image display panel. The symbols are selected from among the symbols “main character 121”, “sub character 122”, “office building 123”, “gold bullion 124”, “car 125”, “stock certificate 126”, “jet 127”, “villa 128”, and “combined symbol 129”, of which the last symbol is selected only when the combined symbol scaled at step S303 is judged. This determination is based on the symbol weighing data and random numeric values sampled by sampling the random numeric values in a numeric-value range which comes under a predetermined range of random numeric values. Upon execution of this process, the main CPU 41 terminates the basic game symbol rearrangement process.

FIG. 28 is a flowchart showing a subroutine of the symbol scaling process invoked and performed at step S303 of the subroutine shown in FIG. 27. First, the main CPU 41 judges the rearranged symbols (step S401). Specifically, the main CPU 41 selects the predetermined storage area, provided in the RAM 43, of the symbol data.

Next, the main CPU 41 judges whether or not the combined symbol is determined to be rearranged (step S402). Specifically, the main CPU 41 judges whether or not the symbols determined to be rearranged at step S401 include the combined symbol. Upon judging that the combined symbol is not determined to be rearranged (step S402: NO), the main CPU 41 terminates the symbol scaling process.

On the other hand, upon judging that the combined symbol is determined to be rearranged (step S402: YES), the main CPU 41 reads the symbol image data (step S403). Specifically, the main CPU 41 reads, from among the symbol image data stored in the RAM 43, two symbol image data that are combined with each other.

Next, the main CPU 41 refers to a size of a symbol matrix display region (step S404). Specifically, the main CPU 41 refers to the size of the display region of the symbol matrix SM in which the combined symbol is rearranged so that the two symbol images read at step S403 are displayed in a region for displaying a single symbol.

Next, the main CPU 41 reduces the symbol image data (step S405). Specifically, the main CPU 41 reduces a horizontal or vertical direction of the symbol image data read to match the size referred to at step S404 so that the two symbol images read at step S403 are displayed in the region for displaying a single symbol.

Next, the main CPU 41 generates the image data (step S406). Specifically, the main CPU 41 generates the image data so combined that the two symbol image data reduced at step S405 are displayed in the region for displaying a single symbol is displayed. Upon execution of this process, the main CPU 41 terminates the symbol scaling process.

FIG. 29 is a flowchart showing a subroutine of the free game execution process invoked and executed at step S208 of the subroutine shown in FIG. 26 according to the third embodiment. First, the main CPU 41 determines the free-game number T (step S501). Specifically, the main CPU 41 determines the free-game number T in accordance with the program stored in the RAM 43.

Next, the main CPU 41 performs a process for setting the free-game number B=T (step S502). Specifically, the main CPU 41 sets a remaining free-game number B=T in a storage area provided in the RAM 43, the area storing the data indicative of the remaining free-game number B. T is the free-game number determined at step S401.

Next, the main CPU 41 judges whether or not the start button 23 has been set to ON (step S503). Specifically, the main CPU 41 judges whether or not an input signal output from the start switch 23S when the start button 23 is pushed has been received. The main CPU 41 controls the step to return to step S403 upon judging that the start button 23 has not been set to ON (step S503: NO).

Upon judging that the start button 23 has been set to ON (step S503: YES), on the other hand, the main CPU 41 performs a process for displaying effect images (step S504). Specifically, the main CPU 41 displays the free-game-number display image 90a corresponding to the number of times in executing the free game on the upper image display panel 33 (see FIG. 21A).

Next, the main CPU 41 performs a process for rearranging symbols in the free game (step S505). Specifically, the main CPU 41 executes the program stored in the RAM 43 and determines the symbols to be rearranged in the elements of the symbol matrix SM displayed on the lower image display panel. These symbols are selected from among the symbols, “main character 121”, “sub character 122”, “office building 123”, “gold bullion 124”, “car 125”, “stock certificate 126”, “jet 127”, “villa 128”, and “combined symbol 129”. This determination is based on the symbol weighing data and random numeric values sampled by sampling the random numeric values in a numeric-value range which comes under a predetermined range of random numeric values. The main CPU 41 then rearranges the symbols to be rearranged in the elements of symbol matrix SM.

Next, the main CPU 41 judges whether a jackpot bonus trigger condition has been met or not (step S506). Specifically, the main CPU 41 executes the program stored in the RAM 43 to sample the random numeric values in the numeric-value range which comes under a predetermined range of random numeric values, thereby judging whether or not the jackpot bonus game trigger condition has been met based on the sampled random numeric values. The main CPU 41 controls the step to return to step S510 upon judging that the jackpot bonus game trigger condition has been met (step S506: NO).

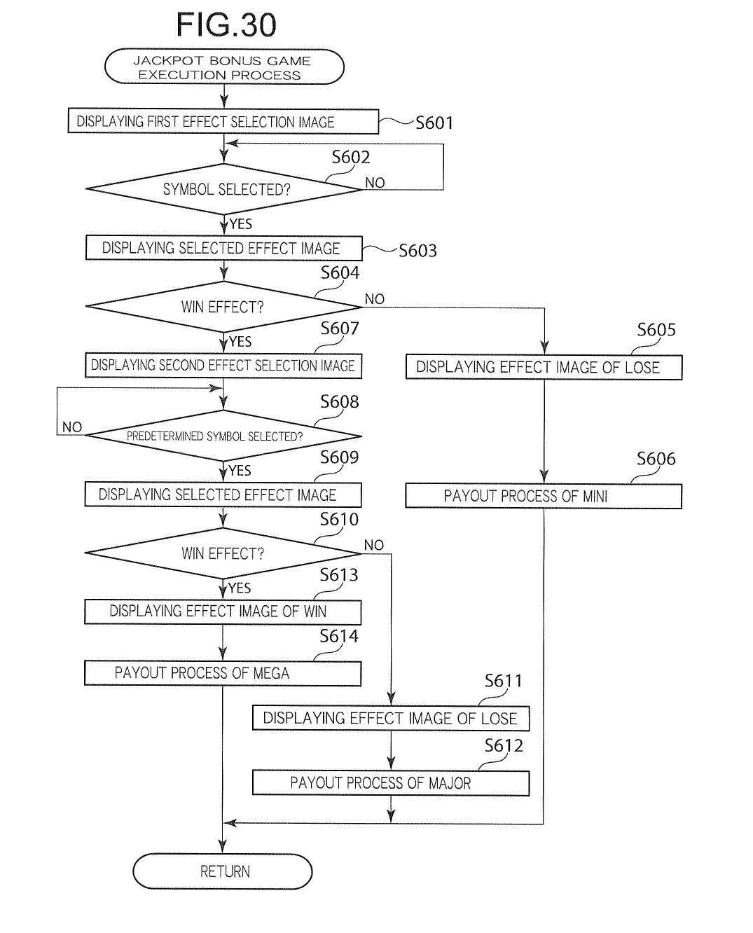

On the other hand, upon judging that the jackpot bonus trigger condition has been met (step S506: YES), the main CPU 41 executes a jackpot bonus game execution process described later with reference to FIG. 30 (step S507). In this jackpot bonus game, the main CPU 41 sequentially reads and executes the game programs or the like from the ROM 42 and performs the jackpot bonus game execution process. Upon terminating this process, the main CPU 41 controls the step to move to step S510.

Next, the main CPU 41 judges whether a prize has been established or not (step S508). Specifically, the main CPU 41 judges whether or not the number of symbols of respective types rearranged in the elements of the symbol matrix SM is a winning number allowed to award any of payouts. Here, the prize is established on condition that a predetermined number of symbols of the same type are rearranged in the elements of the symbol matrix SM.

Thereafter, upon judging that the prize has been established (step S508: YES), the main CPU 41 performs a payout process for paying out the coins in accordance with the number of coins set for the winning number (step S509). Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66.

On the other hand, upon judging that the prize has not been established (step S508: NO) or upon executing the processes at step S509 and step S510, the main CPU 41 sets the remaining free-game number B=B−1 (step S510). Specifically, the main CPU 41 sets B=B−1 at a value of the remaining free-game number B stored in the RAM 43.

The main CPU 41 then judges whether or not a value of the remaining free-game number B is equal to zero (step S511). Specifically, the main CPU 41 judges whether or not a value of the remaining free-game number B stored in the RAM 43 is equal to zero. Upon judging that the value of the remaining free-game number B is not zero (step S511: NO), the main CPU 41 controls the step to return to step S403.

On the other hand, upon judging that the value of B is equal to zero (step S511: YES), the main CPU 41 terminates the free game execution process.

FIG. 30 is a flowchart showing a subroutine of the jackpot bonus game execution process invoked and performed at step S210 of the subroutine shown in FIG. 26 and at step S507 of the subroutine shown in FIG. 29, according to the third embodiment. At first, the main CPU 41 displays a first effect selection image (step S601). Specifically, the main CPU 41 displays the jackpot bonus game display image 90b displaying the start of the jackpot bonus game on the upper image display panel 33, and a selection screen for determining the types of jackpot bonus games in the display region 92 (see FIG. 22B).

Next, the main CPU 41 judges whether or not the symbol is selected (step S602). Specifically, the main CPU 41 judges whether or not the symbol displayed on the selection screen for determining the types of jackpot bonus games is selected via the touch panel 69 (see FIG. 22B). Upon judging that the symbol is not selected (step S602: NO), the main CPU 41 controls the step to return to step S502.

On the other hand, upon judging that the symbol is selected (step S602: YES), the main CPU 41 displays the selected effect image (step S603). Specifically, the main CPU 41 sequentially reads the effect image corresponding to the symbol selected at step S502 from the ROM 42 and displays the effect image in the display region 92 (see FIG. 23A).

Next, the main CPU 41 judges whether or not a “Win” effect is read (step S604). Specifically, the main CPU 41 judges whether or not the effect image read at step S603 is the “Win” effect (see FIG. 23B). Upon judging that the “Win” effect is not read (step S604: NO), the main CPU 41 displays an effect image of “Lose” (step S605). Specifically, the main CPU 41 reads the effect image corresponding to the effect image of “Lose” from the ROM 42, and displays the effect image in the display region 92 (see FIG. 24A). Next, the main CPU 41 executes a payout process of “Mini” (step S606). Specifically, the main CPU 41 performs the coin-payout process corresponding to “Mini”. Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66. Upon execution of the process at step S606, the main CPU 41 terminates the jackpot bonus game execution process.

On the other hand, upon judging that the “Win” effect is read (step S604: YES), the main CPU 41 displays a second effect selection image (step S607). Specifically, the main CPU 41 displays in the display region 92 a selection screen for determining the types of jackpot games so that the symbol selected at step S602 is identifiable (see FIG. 24B).

Next, the main CPU 41 judges whether or not the predetermined symbol is selected (step S608). Specifically, the main CPU 41 judges whether or not the symbol other than that selected at step S602 is selected by way of the symbol touch panel 69. Upon judging that the predetermined symbol is not selected (step S608: NO), the main CPU 41 controls the step to return to step S608.

On the other hand, upon judging that the predetermined symbol is selected (step S608: YES), the main CPU 41 displays the selected effect image (step S609). Specifically, the main CPU 41 sequentially reads the effect image corresponding to the symbol selected at step S602 from the ROM 42 and displays the effect images in the display region 92.

Next, the main CPU 41 judges whether or not the “Win” effect is read (step S610). Specifically, the main CPU 41 judges whether or not the effect image read at step S609 is the “Win” effect. Upon judging that the “Win” effect is not read (step S610: NO), the main CPU 41 displays the effect image of “Lose” (step S611). Specifically, the main CPU 41 reads the effect image corresponding to the effect image of “Lose” from the ROM 42 and displays the effect image in the display region 92. Next, the main CPU 41 executes a payout process of “Major” (step S612). Specifically, the main CPU 41 performs the coin-payout process corresponding to Major. Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66. Upon execution of the process at step S612, the main CPU 41 terminates the jackpot bonus game execution process.

On the other hand, upon judging that the “Win” effect is read (step S610: YES), the main CPU 41 displays the effect image of “Win” (step S613). Specifically, the main CPU 41 reads the effect image corresponding to the effect image of “Win” from the ROM 42 and displays the effect image in the display region 92. Next, the main CPU 41 executes a payout process of “Maga” (step S614). Specifically, the main CPU 41 performs the coin-payout process corresponding to “Maga”. Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66. Upon execution of the process at step S614, the main CPU 41 terminates the jackpot bonus game execution process.

### 4. Fourth Embodiment

Next, a slot machine 100 according to a fourth embodiment will be described with reference to the drawings. The slot machine according to the fourth embodiment below is a so-called hybrid slot machine in which a plurality of rotatably-supported mechanical reels have a transparent liquid crystal panel on front surfaces to display images of various symbols drawn on the peripheral surfaces of the mechanism reels through the transparent liquid crystal panel through which the pictures are allowed to pass. The slot machine according to the fourth embodiment has an appearance, circuitry, and the like that are substantially the same as those of the slot machine 10 according to the third embodiment. Thus, a duplicated explanation is omitted here. Like constituent elements corresponding to those of the slot machine 10 are designated by like reference numerals and are explained.

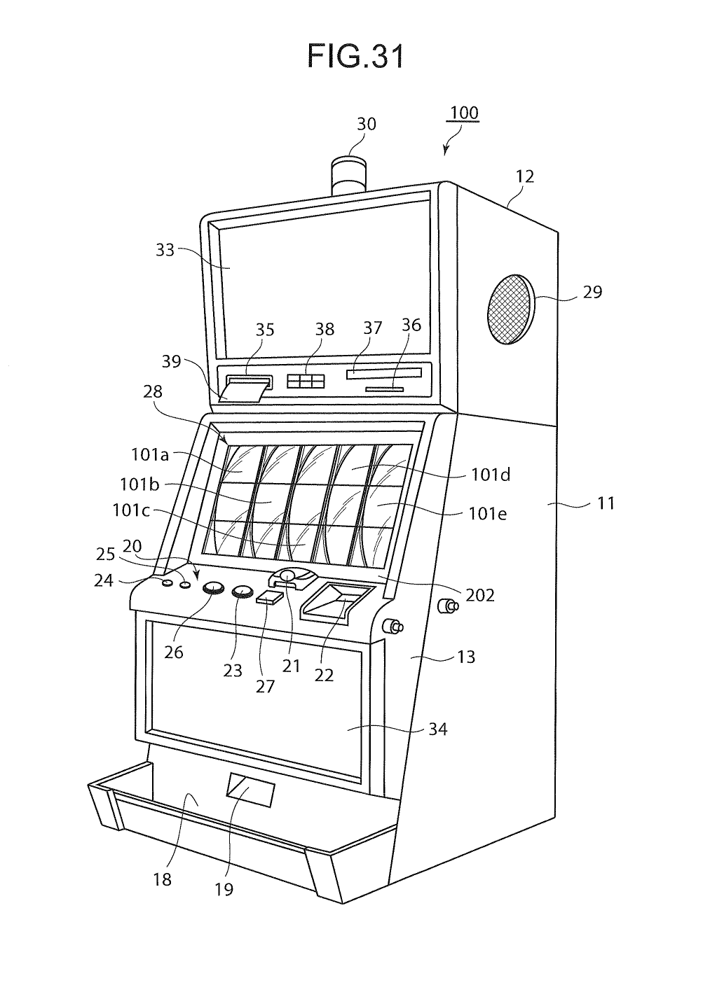

FIG. 31 is a view schematically showing an appearance of the slot machine according to the fourth embodiment of the present invention. As shown in FIG. 31, the slot machine 100 is rotatably provided with five reels 101a to 101e. A symbol column made up of the symbols “main character 121”, “sub character 122”, “office building 123”, “gold bullion 124”, “car 125”, “stock certificate 126”, “jet 127”, and “villa 128” is drawn on the respective one of the outer circumferential surfaces of the reels 101a to 101e.

A main liquid crystal panel 202 formed of a transparent liquid crystal panel, which is disposed at the main door, is provided in front of the respective reels 101a to 101e. The main liquid crystal panel 202 displays the symbol display region 28 with visually recognizable rear surface in such a manner as to surround symbols drawn on the reels 101a to 101e and displayed in a stopped state, respectively. The symbols drawn on the reels 101a to 101e are visualized by rendering the symbol display region 28 transparent.

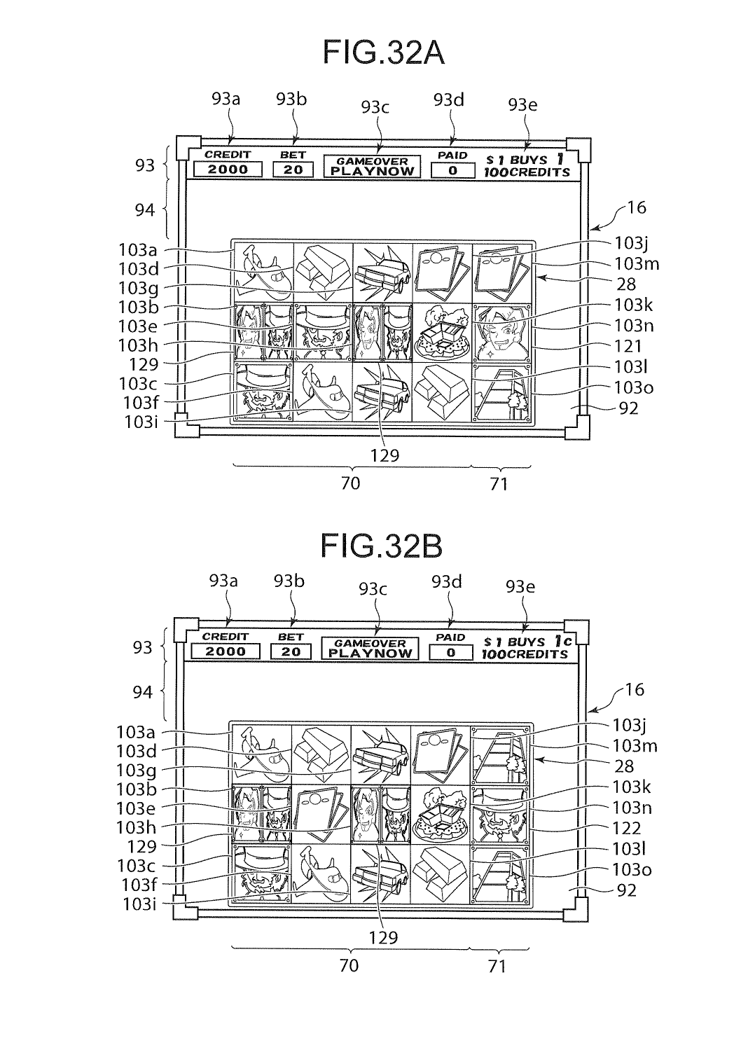

FIGS. 32A and 32B are views each showing an exemplary symbol matrix during the basic game. As shown in FIGS. 32A and 32B, the symbol display region 28 is displayed on the main liquid crystal panel 202 provided in the slot machine 100 of the present invention. A total of five reels 101a to 101e in five columns are rotatably provided rearwardly of the liquid crystal panel 202.

As shown in FIG. 32A, 15 display windows 103a to 103o with visually recognizable rear surface are formed within the symbol display region 28 of the lower image display panel 16. When the reels 101a to 101e stop, any of a total of fifteen symbols in three rows and five columns, “main character 121”, “sub character 122”, “office building 123”, “gold bullion 124”, “car 125”, “stock certificate 126”, “jet 127”, and “villa 128”, are displayed in a stopped state. With the use of the liquid crystal panel 202, a horizontal or vertical direction of two symbol image data is reduced so that the jackpot symbol can be added to the combined symbol 129 in response to the jackpot symbol rendering the predetermined progressive value. In this way, the symbols are rearranged in a superposed state on the reels 101a to 101d. In this case, after the reels 101a to 101d are displayed in a stopped state, the “combined symbols 129” is rearranged in a superposed state in the display windows 103b and 103h. Next, the reel 101e is displayed in a stopped state, and the “main character 121” is displayed in a stopped state in the display window 103n, and thus, the free game is executed.

As shown in FIG. 32B, 15 display windows 103a to 103o with visually recognizable rear surface are formed within the symbol display region 28 of the lower image display panel 16. When the reels 101a to 101e stop, any of a total of fifteen symbols in three rows and five columns, “main character 121”, “sub character 122”, “office building 123”, “gold bullion 124”, “car 125”, “stock certificate 126”, “jet 127”, and “villa 128”, are displayed in a stopped state. With the use of the liquid crystal panel 202, a horizontal or vertical direction of two symbol image data is reduced so that the jackpot symbol can be added to the combined symbol 129 in response to the jackpot symbol rendering the predetermined progressive value. In this way, the symbols are rearranged in a superposed state in the reels 101a to 101d. After the reels 101a to 101d have been displayed in a stopped state, the “combined symbols 129” are rearranged in a superposed state in the display windows 103b and 103h. Next, the reel 101e is displayed in a stopped state, and the “sub character 122” is displayed in a stopped state in the display window 103n, and thus, the jackpot bonus game is executed.

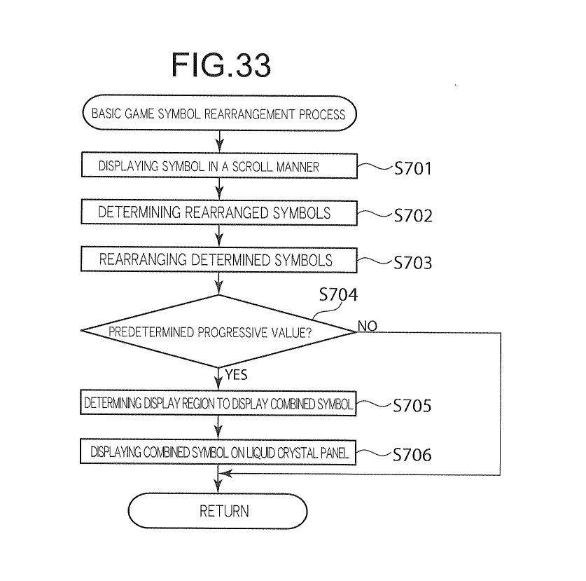

FIG. 33 is a flowchart showing a subroutine of a basic symbol rearrangement process, according to the fourth embodiment, invoked and executed at step S204 of the subroutine shown in FIG. 26. First, the main CPU 41 displays the symbols in a scrolling manner (step S701). Specifically, the main CPU 41 successively displays in a scrolling manner the symbols that are rearranged in the symbol display region 28 displayed in the lower image display panel.

Next, the main CPU 41 determines the symbols to be rearranged (step S702). Specifically, the main CPU 41 executes the program stored in the RAM 43 and determines the respective symbols to be arranged in the symbol display region 28 of the lower image display panel. These symbols are selected from among the symbols, “main character 121”, “sub character 122”, “office building 123”, “gold bullion 124”, “car 125”, “stock certificate 126”, “jet 127”, and “villa 128” drawn on the reels 101a to 101e. This determination is based on the random numeric values sampled by sampling the random numeric values in a numeric-value range which comes under a predetermined range of random numeric values.

Next, the main CPU 41 rearranges the determined symbols (step S703). Specifically, the main CPU 41 displays the reels 101a to 101e in a stopped state based on the symbols determined at step S702 to thereby rearrange the symbols in the display window 103.

Next, the main CPU 41 judges whether or not the jackpot becomes the predetermined progressive value (step S704). Specifically, the main CPU 41 judges whether or not the value regarding the credit of the progressive jackpot is a predetermined value. Upon judging that the jackpot is not the predetermined progressive value (step S704: NO), the main CPU 41 terminates the basic game symbol rearrangement process.

On the other hand, upon judging that the jackpot becomes predetermined progressive value (step S704: YES), the main CPU 41 determines the display region in which the combined symbol is displayed (step S705). Specifically, the main CPU 41 determines the display window 103, in which the combined symbol is displayed, from among the display windows 103a to 103o of the symbol display region 28.

Next, the main CPU 41 displays the combined symbol on the liquid crystal panel (step S706). Specifically, the main CPU 41 generates the combined symbol data so that the jackpot symbol is added to the combined symbol in which plural types of symbols are combined, and displays the combined symbol in the display window 103 determined at step S705 (see FIG. 30). The generated combined symbol data is stored in the RAM 43. Upon execution of this process, the main CPU 41 terminates the basic game symbol rearrangement process.

### 5. Fifth Embodiment

First, a slot machine 10 according to a fifth embodiment will be described in detail with reference to the drawings. The slot machine according to the fifth embodiment is a so-called video slot machine, which has an image display panel such as a liquid crystal display and executes a game by displaying images of various symbols on the image display panel.

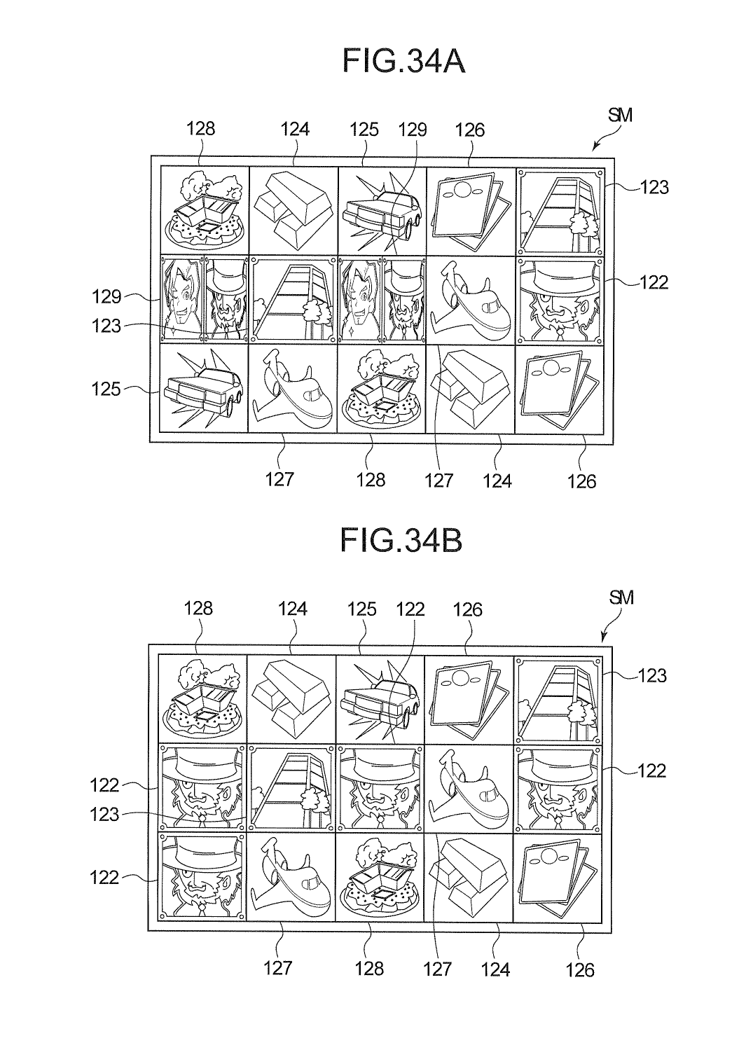

FIGS. 34A and 34B are views each showing an exemplary symbol matrix during a basic game according to the fifth embodiment. The slot machine 10 according to the present invention executes any one of three types of gaming modes including a basic game, a free game, and a progressive bonus game. The basic game is executed upon consuming a gaming value corresponding to the amount bet by a player. The free game is executed without consuming a gaming value. The progressive bonus game is executed when a jackpot value reaches a predetermined progressive value. The slot machine 10 is of a stand-alone type, which is not connected to a network, but the present invention is applicable to a networked slot machine.

As shown in FIGS. 34A and 34B, a symbol matrix SM is displayed on a lower image display panel 16 included in a slot machine 10 to be described later. A total of fifteen symbols in three rows and five columns are rearranged in the symbol matrix SM.

In the fifth embodiment of the present invention, any of symbols “main character” 121, “sub character” 122, “office building” 123, “gold bullion” 124, “car” 125, “stock certificate” 126, “jet” 127, and “villa” 128, is rearranged in the symbol matrix SM, and a payout is determined based on the number of respective symbols rearranged in the symbol matrix SM. Further, a jackpot is incorporated into the complex symbol 129 under condition of input of a side-BET.

As shown in FIG. 34A, when a jackpot reaches a predetermined progressive value during the basic game, symbols from among the symbols “main character” 121, “sub character” 122, “office building” 123, “gold bullion” 124, “car” 125, “stock certificate” 126, “jet” 127, and “villa” 128, and a complex symbol 129 are rearranged in a first display region 70 of the symbol matrix SM. The complex symbol 129 is a symbol into which the plurality of jackpot symbols is incorporated under condition of input of the side-BET. Further, symbols from among the symbols “main character” 121, “sub character” 122, “office building” 123, “gold bullion” 124, “car” 125, “stock certificate” 126, “jet” 127, and “villa” 128, are rearranged in the second display region 71 of the symbol matrix SM. The side-BET is input in this case, so that a combination of one symbol “sub character” 122 and two complex symbols 129 each composed of the symbols “main character” 121 and “sub character” 122, that are laterally scaled down, is rearranged. Therefore, a jackpot bonus game having a high payout ratio is to be selected and executed in accordance with a type of this combination.

As shown in FIG. 34B, in the case where the side-BET is not input during the basic game, any complex symbols 129 are not rearranged but the symbols “main character” 121, “sub character” 122, “office building” 123, “gold bullion” 124, “car” 125, “stock certificate” 126, “jet” 127, and “villa” 128 are rearranged in any of elements of the symbol matrix SM. In this case, a jackpot reaches a predetermined progressive value and a combination of three symbols “sub character” 122 is rearranged, so that the jackpot bonus game is selected and executed in accordance with a type of this combination.

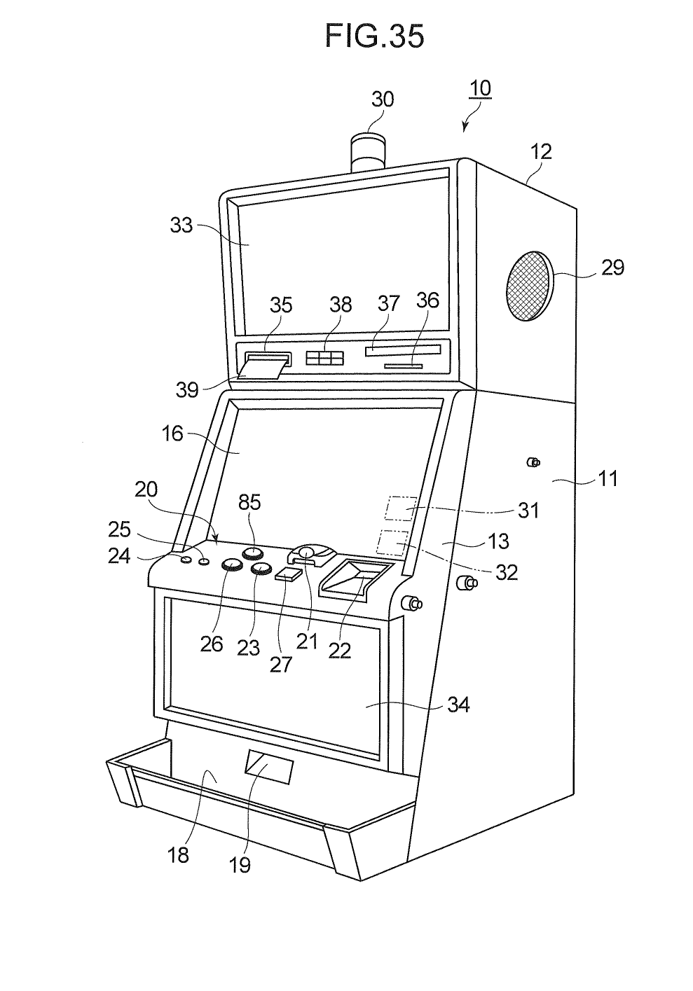

FIG. 35 is a view schematically depicting an appearance of the slot machine according to the fifth embodiment. The gaming media used in the slot machine 10 include coins, bills, or electronic value information equivalent thereto. In the present invention, however, the gaming media are not limitative thereto in particular, and can include medals, tokens, electric money, and tickets, for example. The above tickets are not limitative in particular, and can include barcode-attached tickets or the like, as described later, for example.

The slot machine 10 is provided with a cabinet 11, a top box 12 installed on an upper side of the cabinet 11, and a main door 13 provided on a front surface of the cabinet 11.

A lower image display panel 16 serving as a display device is provided in front of the main door 13. The lower image display panel 16 serving as a display device is provided in front of the main door 13. The lower image display panel 16 is provided with a liquid crystal panel, which displays fifteen elements of the symbol matrix 28 in three rows and five columns. In each symbol matrix SM, one symbol is arranged.

A credit amount display unit 31 of the lower image display panel 16 displays the number of coins credited by way of an image. A payout display unit 32 displays an image indicative of the number of coins or the like to be paid out in the case where the predetermined number or more of respective symbols are rearranged in the symbol matrix SM.

Provided on a lower side of the lower image display panel 16 are a control panel 20 having a plurality of buttons 23 to 27 through which command regarding the process of the game will be input by a player, a coin receiving slot 21 for receiving coins into the cabinet 11, and a bill validator 22.

On the control panel 20, a start button 23, a change button 24, a cashout button 25, a 1-BET button 26, and a max-BET button 27 are provided. The start button 23 is intended for entering a command for starting the game. The change button 24 is intended for use in asking an attendant of the gaming facility for change. The cashout button 25 is intended for entering a command for paying the credited coins to a coin tray 18 through a coin payout exit 19.

The 1-BET button 26 is intended for entering a command for betting one coin among the credited coins on the game. The max-BET button 27 is intended for entering a command for betting the maximum number (fifty coins in this embodiment) of coins that can be bet per game among the credited coins on the game.

The bill validator 22 validates whether or not a bill is legitimate and accepts a legitimate bill into the cabinet 11. The bill validator 22 may be configured so that a barcode-attached ticket 39 described later is readable thereby. Provided on a lower front surface of the main door 13, that is, at a lower part of the control panel 20, is a berry glass 34 on which characters of the slot machine 10 and the like are depicted.

On a front surface of the top box 12, an upper image display panel 33 is provided. The upper image display panel 33 has a liquid crystal panel, which displays images for introducing the game contents or explaining game rules, for example.

Also, on the top box 12, a speaker 29 and a lamp 30 are provided. On a lower side of the upper image display panel 33, a ticket printer 35, a card reader 36, a data display unit 37, and a key pad 38 are provided. The ticket printer 35 prints on the ticket, a barcode having encoded thereon data such as the credit amount, the date and time, and the identification number of the slot machine 10, and outputs the printed ticket as the barcode-attached ticket 39. The player can play the game on another slot machine with the barcode attached ticket 39 by causing this slot machine to read the barcode attached ticket 39. Alternatively, the player can exchange the barcode-attached ticket 39 with the bills or the like at a predetermined place (at a cashier inside a casino, for example) of the gaming facility.

The card reader 36 reads data from and writes data into a smart card. The smart card is to be owned by the player, which stores data for identifying the player or data regarding the log of games executed by the player, for example. The smart card may store data corresponding to coins, bills, or credit. As an alternative of a smart card, a magnetic stripe card may be employed. The data display 37 is made up of a fluorescent display and the like, and displays the data read by the card reader or the data input by the player through the key pad 38, for example. The key pad 38 inputs data and commands regarding the ticket issuance or the like.

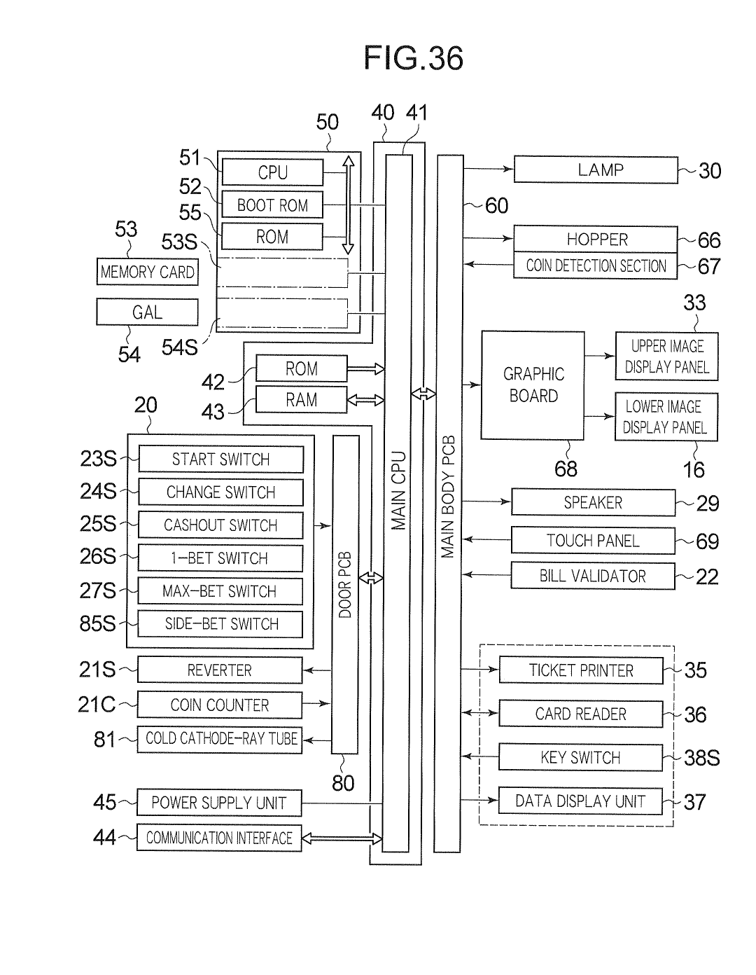

FIG. 36 is a block diagram depicting the internal construction of the slot machine shown in FIG. 35. A gaming board 50 includes: a CPU (Central Processing Unit) 51, a ROM (Read Only Memory) 55 and a boot ROM 52 interconnected by an internal bus; a card slot 53S corresponding to a memory card 53; and an IC socket 54S corresponding to a GAL (Generic Array Logic) 54.

A memory card 53 is composed of a non-volatile memory, such as CompactFlash (registered trademark), and stores a game program. The game programs include a symbol selection program. The symbol selection program is intended for determining symbols to be rearranged on a symbol matrix SM. The symbol selection program includes symbol weighing data corresponding to each of a plurality of kinds of payout ratios (for example, 80%, 84%, and 88%). The symbol weighting data is indicative of the correspondence relationship between the respective symbols and one or more random numeric values which come under a predetermined numerical range (0 to 255). The payout ratio is determined according to the payout-ratio setting data output from the GAL 54. The symbols to be rearranged in the symbol matrix SM are determined depending upon the symbol weighing data corresponding to this payout ratio. Further, the game programs include table data indicating the correspondence relationship between each of the symbols and a payout.

Also, the card slot 53S is configured to allow the memory card 53 to be inserted thereinto or ejected therefrom, and is connected to a motherboard 40 through IDE bus. Accordingly, the memory card 53 can be ejected from the card slot 53S, other game programs and other game system programs can then be written into the memory card 53, and further, the memory card 53 can be inserted into the card slot 53S, thereby allowing the player to change the types and contents of games executed in the slot machine 10. The game programs include those related to the progress of a game. Furthermore, the game program includes image data or sound data to be output during the game. The image data includes, for example, image data indicative of the symbol matrix.

The GAL 54 is a type of a PLD having a fixed OR array structure. The GAL 54 includes plural input ports and plural output ports. In the case where predetermined data is input to the input port, the GAL 54 outputs data corresponding to the aforementioned data from the output port. The data output from this output port is equivalent to the aforementioned payout-ratio setting data. Further, the IC socket 54S is configured to allow the GAL 54 to be attached thereto and detached therefrom, and is connected to the motherboard 40 by a PCI bus. Accordingly, the GAL can be replaced with the replacement GAL 54 to change the payout-ratio setting data.

The CPU 51, the ROM 55, and the boot ROM 52 interconnected by the internal bus are connected to the motherboard 40 by the PCI bus. The PCI bus serves to transmit signals between the motherboard 40 and the gaming board 50 and supply power from the motherboard 40 to the gaming board 50. The motherboard 40 is constructed with a commercially available general-purpose motherboard (a printed circuit board on which the essential parts of a personal computer are mounted).

The motherboard 40 is constructed using a general-purpose motherboard commercially available (a printed circuit board on which essential parts of a personal computer are mounted) and includes: a main CPU (Central Processing Unit) 41, a ROM (Read Only Memory) 42; a RAM (Random Access Memory) 43; and a communication interface 44. The main CPU 41 functions as a processor for controlling a display device and memory according to the embodiment of the present invention.

The ROM 42 is made up of a memory device such as a flash memory and stores thereon a program such as BIOS (Basic Input/Output System) executed by the main CPU 41, and permanent data. When the BIOS is executed by the main CPU 41, processing of initializing predetermined peripheral devices is carried out and processing of capturing game programs and game system programs stored in the memory card 53 through the gaming board 50 is started. In the present invention, the contents of the ROM 42 may be rewritable or not.

The RAM 43 stores data and a program used when the main CPU 41 is activated. The RAM 43 can also store game programs. The RAM 43 further stores data concerning the credit amount, the number of coin-in or coin-out for one game, and the like.

Both a main body PCB (Printed Circuit Board) 60 and a door PCB 80, which will be described later, are connected to the motherboard 40 by USB. A power supply unit 45 is also connected to the motherboard 40.

Connected to the main body PCB 60 and the door PCB 80 are: equipment and devices which generate input signals to be input to the main CPU 41; and equipment and devices of which operations are controlled by a control signal output from the main CPU 41. The main CPU 41 executes a game program stored in the RAM 43 based on an input signal having been input to the main CPU 41 and executes a predetermined computational process, thereby storing results thereof in the RAM 43 or transmitting a control signal to each of equipment and devices as a control process therefor.

Connected to the main body PCB 60 are a lamp 30, a hopper 66, a coin detecting section 67, a graphic board 68, a speaker 29, a touch panel 69, a bill validator 22, a ticket printer 35, a card reader 36, a key switch 38S, and a data display 37. The lamp 30 illuminates in a predetermined pattern, based on a control signal output from a main CPU 41.

The hopper 66 is installed in the cabinet 11 and pays out a predetermined number of coins from the coin payout exit 19 to the coin tray 18 based on a control signal output from the main CPU 41. The coin detecting section 67 is installed inside the coin payout exit 19 and outputs an input signal to the main CPU 41 upon detecting that a predetermined number of coins have been paid out from the coin payout exit 19.

The graphic board 68 controls, based on a control signal output from the main CPU 41, images to be displayed on the upper image display panel 33 and the lower image display panel 16. The credit amount stored in the RAM 43 is displayed on a credit amount display section 31 (see FIG. 35) of the lower image display panel 16. The number of coins to be paid out is displayed at a payout amount display section 31 (see FIG. 35) of the lower image display panel 16. The graphic board 68 is equipped with a DVP (Video Display Processor) which generates image data based on a control signal output from the main CPU 41 and a video RAM which temporarily stores image data generated by the VDP, and the like. The image data used in generating image data with VDP is contained in the game program read from the memory card 53 and stored in the RAM 43.

The bill validator 22 validates whether or not a bill is legitimate and accepts a legitimate bill into the cabinet 11. Upon accepting a legitimate bill, the bill validator 22 outputs an input signal to the main CPU 41 based on the amount of the bill. The main CPU 41 stores in the RAM 43 the credit amount corresponding to the amount of bills transmitted by the input signal.

Based on a control signal output from the main CPU 41, the ticket printer 35 prints on a ticket a barcode having encoded thereon data such as the credit amount, data and time, and the identification number of the slot machine 10 stored in the RAM 43. Further, this printer outputs the printed ticket as a barcode-attached ticket 39. The card reader 36 transmits to the main CPU 41 the data read from the smart card and writes the read data onto the smart card, based on a control signal from the main CPU 41. The key pad switch 38S is provided on the key pad 38, and outputs a predetermined input signal to the main CPU 41 when the player operates the key pad 38. The data display 37, based on a control signal output from the main CPU 41, displays the data read by the card reader 36 and the data input by the player through the key pad 38.

The control panel 20, a reverter 21S, a coin counter 21C, and a cold cathode tube 81 are connected to the door PCB 80. The control panel 20 is provided with: a start switch 23S corresponding to the start button 23; a change switch 24S corresponding to the change button 24; a cashout switch 25S corresponding to a cashout button 25; a 1-BET switch 26S corresponding to a 1-BET button 26; and a max-BET switch 27S corresponding to the max BET button 27. When the player operates the buttons 23 to 27, the corresponding switches 23S to 27S output input-signals to the main CPU 41, respectively.

The coin counter 21C is provided inside the coin receiving slot 21, and validates whether or not a legitimate coin is inserted into the coin receiving slot 21. Those other than the legitimate coins are discharged from the coin payout exit 19. The coin counter 21C outputs an input signal to the main CPU 41 when a legitimate coin is detected.

The reverter 21S operates based on a control signal output from the main CPU 41 and distributes coins recognized as being legitimate by the coin counter 21C into a cash box (not shown in the drawings) or the hopper 66 which is arranged in the slot machine 10. In other words, when the hopper 66 is filled with coins, legitimate coins are distributed by the reverter 21S into the cash box. On the other hand, when the hopper 66 is not filled with coins, legitimate coins are distributed into the hopper 66. A cold cathode tube 81 functions as a backlight installed on rear face side of each of the lower image display panel 16 and the upper image display panel 33, and is lit up based on a control signal output from the main CPU 41.

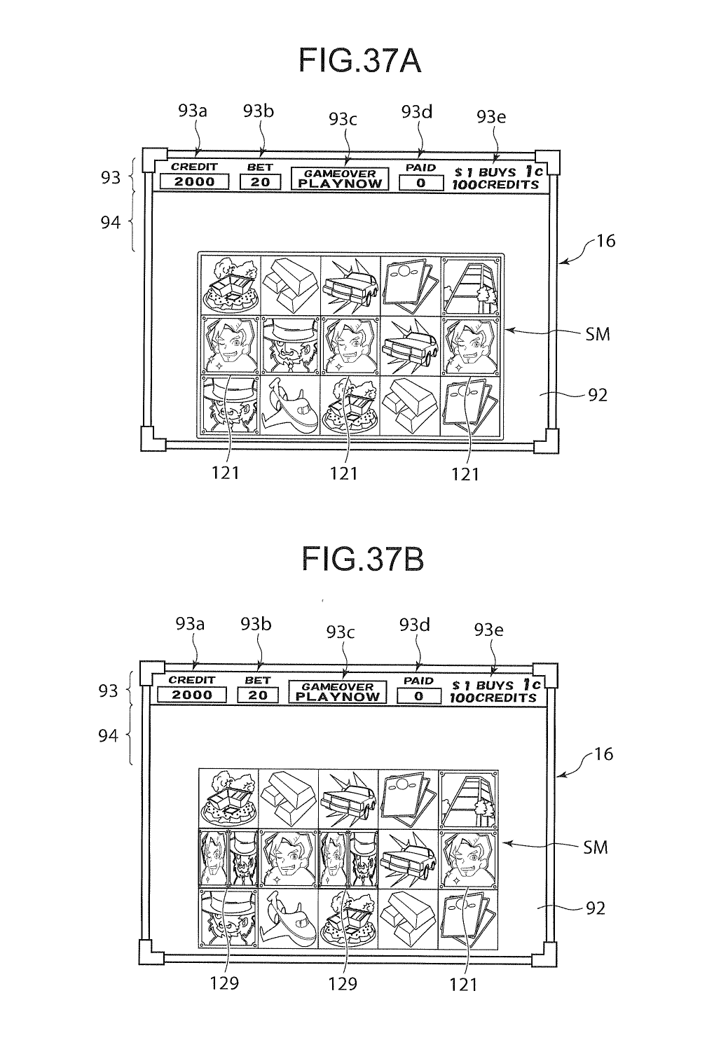

As shown in FIG. 37A, the lower image display panel 16 is made up of a display region 92, an information display section 93, the effect image display section 94, and the like. The display area section 92 is for displaying a symbol matrix SM. In addition, the information display section 93 is arranged above the display area section 92. This display section is made up of a credit amount display section 93a, a BET amount display section 93b, a character information display portion 93c, a PAID amount display section 93d, and a charge display section 93e.

The number of coins currently credited is displayed at the credit amount display section 93a while the number of coins bet on one game is displayed at the BET amount display section 93b. The character information indicative of a current status of the game is displayed at the character information display section 93c. The characters of “PLAYNOW” are displayed during the play of the game, whereas the characters of “GAMEOVER” are displayed during the intervals between the plays of the game. The number of coins that has been successfully obtained in one game is displayed at the PAID amount display section 93d, whereas a conversion value of the credit amount based on a predetermined charge is displayed at the charge display section 93e.

At the effect image display section 94, effect images in accordance with a type of the present slot game are displayed. In other words, the effect image display section 94 displays different effect images between the basic and free games.

Symbols from among the symbols, “main character” 121, “sub character” 122, “office building” 123, “gold bullion” 124, “car” 125, “stock certificate” 126, “jet” 127, and “villa” 128, and the complex symbol 129 are rearranged in the symbol matrix SM displayed on the lower image display panel 16. A payout is determined based on the number of these symbols rearranged in the symbol matrix SM.

When a jackpot reaches a predetermined progressive value during the basic game, symbols from among the symbols “main character” 121, “sub character” 122, “office building” 123, “gold bullion” 124, “car” 125, “stock certificate” 126, “jet” 127, and “villa” 128 are rearranged in the symbol matrix SM. In this case, a combination of three symbols “main character” 121 is rearranged, so that the free game is selected and executed in accordance with a type of this combination.

As shown in FIG. 37B, when a jackpot reaches a predetermined progressive value during the basic game, symbols from among the symbols “main character” 121, “sub character” 122, “office building” 123, “gold bullion” 124, “car” 125, “stock certificate” 126, “jet” 127, and “villa” 128, and the complex symbol 129 are rearranged in the first display region 70 of the symbol matrix SM. The complex symbol 129 is a symbol, into which the plurality of jackpot symbols is incorporated under condition of input of the side-BET. Further, the symbols “main character” 121, “sub character” 122, “office building” 123, “gold bullion” 124, “car” 125, “stock certificate” 126, “jet” 127, and “villa” 128, are rearranged in the second display region 71 of the symbol matrix SM. The side-BET is input in this case, so that a combination of one symbol “main character” 121 and two complex symbols 129 each composed of the symbols “main character” 121 and “sub character” 122, that are laterally scaled down, is rearranged. Therefore, the more number of free games are to be selected and executed in accordance with a type of this combination, compared with a case where the side-BET is not input.

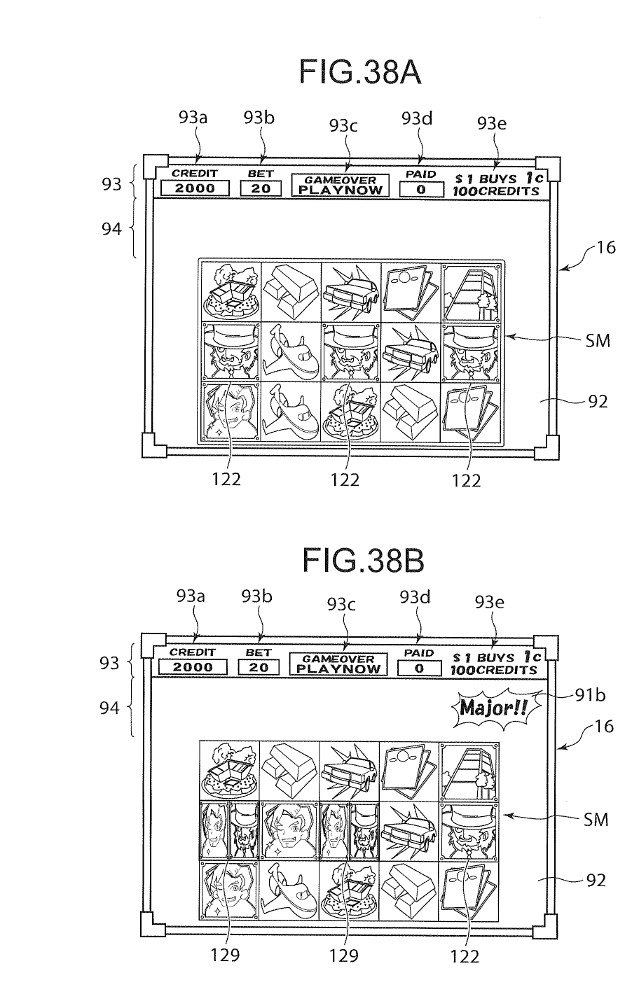

FIGS. 38A and 38B are views each showing an exemplary image displayed during the basic game in the slot machine shown in FIG. 35. As shown in FIG. 38A, when a jackpot reaches a predetermined progressive value during the basic game, symbols from among the symbols “main character” 121, “sub character” 122, “office building” 123, “gold bullion” 124, “car” 125, “stock certificate” 126, “jet” 127, and “villa” 128 are rearranged in the symbol matrix SM. In this case, a combination of three symbols “sub character” 122 is rearranged, so that the jackpot bonus game is selected and executed in accordance with a type of this combination

As shown in FIG. 38B, when a jackpot reaches a predetermined progressive value during the basic game, symbols from among the symbols “main character” 121, “sub character” 122, “office building” 123, “gold bullion” 124, “car” 125, “stock certificate” 126, “jet” 127, and “villa” 128, and a complex symbol 129 are rearranged in the first display region 70 of the symbol matrix SM. The complex symbol 129 is a symbol, into which the plurality of jackpot symbols is incorporated under condition of input of the side-BET. Further, symbols from among the symbols “main character” 121, “sub character” 122, “office building” 123, “gold bullion” 124, “car” 125, “stock certificate” 126, “jet” 127, and “villa” 128, are rearranged in the second display region 71 of the symbol matrix SM. The side-BET is input in this case, so that a combination of one symbol “main character” 121 and two complex symbols 129 each composed of the symbols “main character” 121 and “sub character” 122, that are laterally scaled down, is rearranged. Therefore, the jackpot bonus game having a higher payout ratio is to be selected and executed in accordance with a type of this combination, compared with the case where the side-BET is not input.

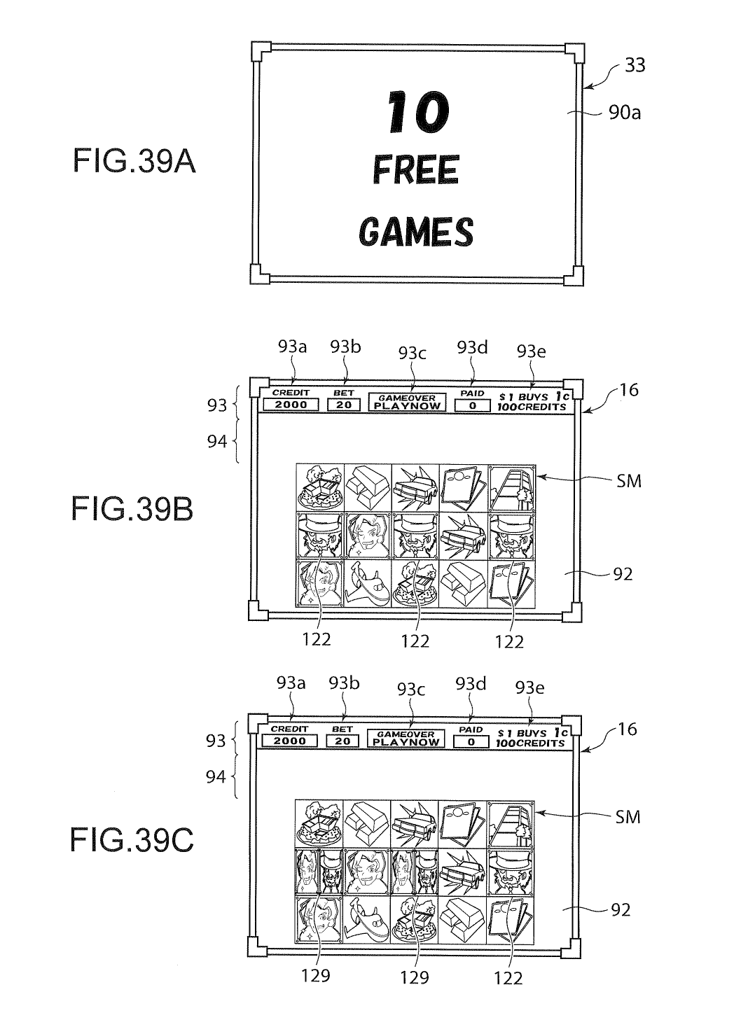

FIGS. 39A, 39B, and 39C are views each showing an exemplary image displayed during the free game in the slot machine 10 shown in FIG. 35. As shown in FIG. 39A, when the symbols rearranged in the symbol matrix SM in FIGS. 37A and 37B form a combination for executing the free game, the free game is started. Upon start of the free game, the upper image display panel 33 displays a free-game-number display image 90a indicative of the number of times in executing the free game. In this case, the free-game-number display image 90a of “10 FREE GAME” is displayed indicating that the number of times in executing the free game has been set to ten.

As shown in FIG. 39B, when a jackpot reaches a predetermined progressive value during the free game, symbols from among the symbols “main character” 121, “sub character” 122, “office building” 123, “gold bullion” 124, “car” 125, “stock certificate” 126, “jet” 127, and “villa” 128, are rearranged in the symbol matrix SM. In this case, a combination of three symbols “sub character” 122 is rearranged, so that the jackpot bonus game is selected and executed.

As shown in FIG. 39, when a jackpot reaches a predetermined progressive value during the bonus game, symbols from among the symbols “main character” 121, “sub character” 122, “office building” 123, “gold bullion” 124, “car” 125, “stock certificate” 126, “jet” 127, “villa” 128, and the complex symbol 129 are rearranged in the first display region 70 of the symbol matrix SM. The complex symbol 129 is a symbol, into which the plurality of jackpot symbols is incorporated under condition of input of the side-BET. Further, symbols from among the symbols “main character” 121, “sub character” 122, “office building” 123, “gold bullion” 124, “car” 125, “stock certificate” 126, “jet” 127, and “villa” 128, are rearranged in the second display region 71 of the symbol matrix SM. In this case, a combination of one symbol “main character” 121 and two complex symbols 129 each composed of the symbols “main character” 121 and “sub character” 122, that are laterally scaled down, is rearranged. Therefore, the jackpot bonus game having a higher payout ratio is to be selectively executed in accordance with a type of this combination, compared with a case where the side-BET is not input.

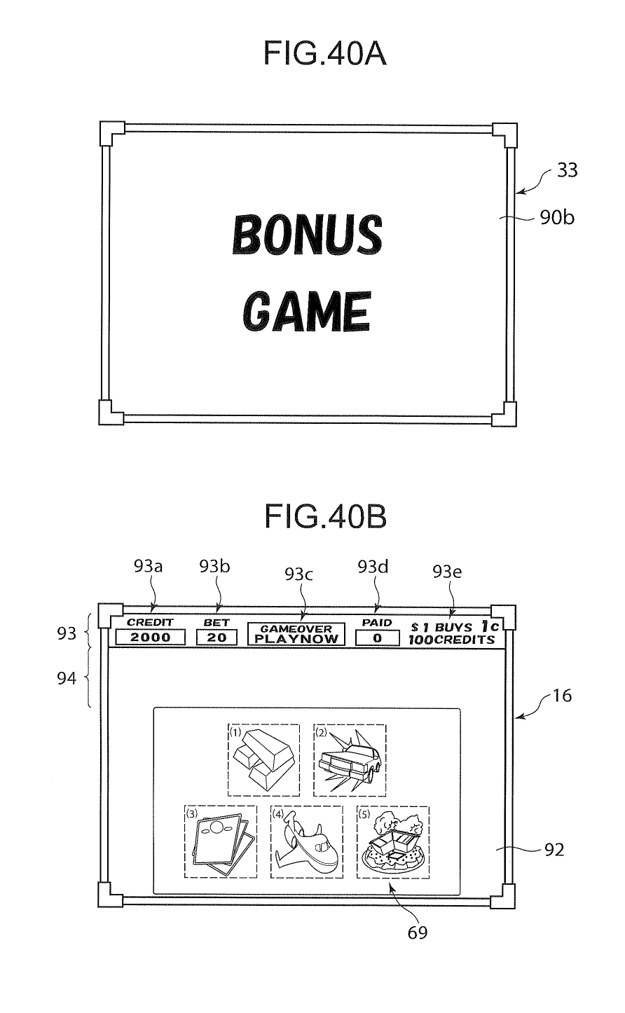

FIGS. 40A to 42B are views each showing an exemplary image displayed during the jackpot bonus game in the slot machine 10 shown in FIG. 35. As shown in FIG. 40A, when the symbols rearranged in the symbol matrix SM in FIGS. 38A to 39C form a combination for executing the jackpot bonus game, the jackpot bonus game is started. When start of the jackpot bonus game is determined, the upper image display panel 33 displays a jackpot-bonus-game display image 90b indicative of start of the jackpot bonus game. In this case, the jackpot-bonus-game display image 90b of “BONUS GAME” is displayed indicating that the jackpot bonus game is to be started.

As shown in FIG. 40B, upon starting the jackpot bonus game, the display region 92 displays a selection screen for determining types of jackpot bonus games. In this case, the symbols (1) to (5) including “gold bullion” 124, “car” 125, “stock certificate” 126, “jet” 127, and “villa” 128 are displayed so that a type of the jackpot bonus game can be selected by selecting one from among these symbols though a touch panel 69.

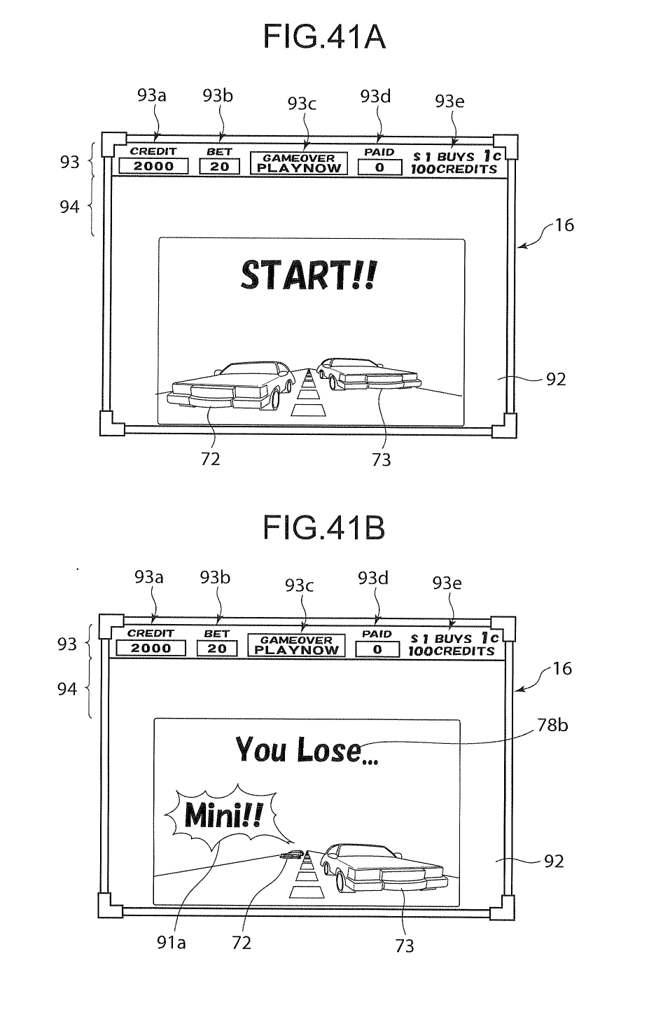

FIGS. 41A and 41B are views each showing an exemplary image displayed during the jackpot bonus game in the slot machine 10 shown in FIG. 35; As shown in FIG. 41A, the jackpot bonus game, which corresponds to the symbol selected in FIG. 40B, is displayed. Because the symbol (2) is selected in FIG. 40B, the jackpot bonus game of a car race is started. A car-race start screen composed of the main character effect image 72 and the sub character effect image 73 is then displayed.

As shown in FIG. 41B, displayed next is a win-or-lose screen of the jackpot bonus game that corresponds to the symbol selected in FIG. 40B. When the symbol (2) is selected in FIG. 40B and the sub character effect image 73 wins in the jackpot bonus game of a car race, a win-or-lose information display 78b of “You Lose” is displayed. A payout display image 91a of “Mini” is displayed which is indicative of a payout type of the jackpot. The payout corresponding to “Mini” is then awarded.

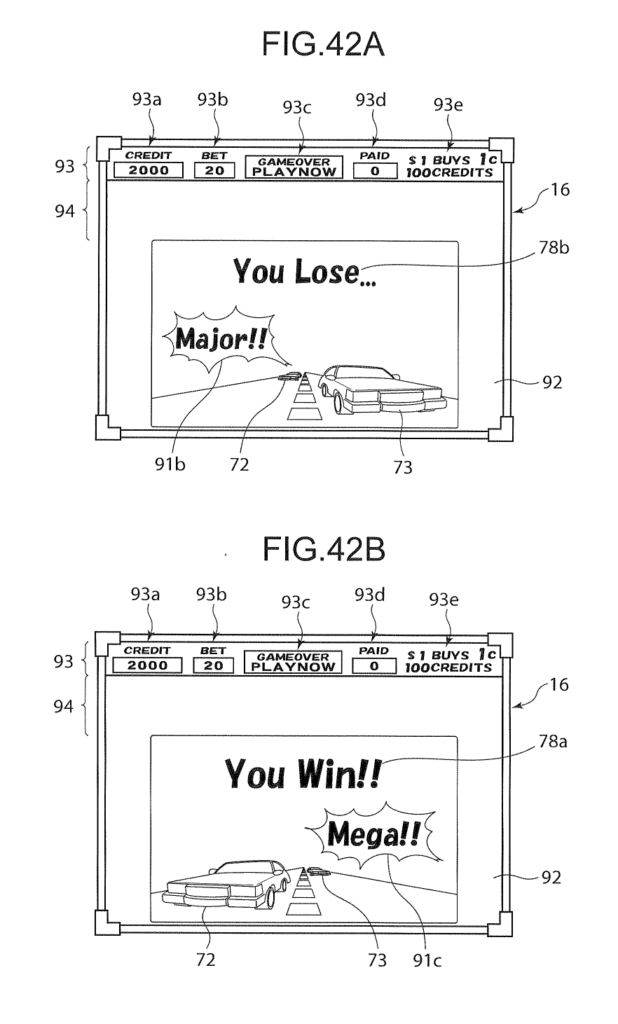

FIGS. 42A and 42B are views each showing an exemplary image displayed during the jackpot bonus game in the slot machine 10 shown in FIG. 35. As shown in FIG. 42A, in the case where the symbol (2) is selected in FIG. 41B and a main character effect image 72 wins in the jackpot bonus game of the car race, the next jackpot bonus game is started. In this case, the jackpot bonus game of the car race is started. In the case where the sub character effect image 73 wins, a win-or-lose information display 78b of “You Lose” is displayed. A payout display image 91 of “Major” is displayed which is indicative of a payout type of the jackpot. The payout corresponding to “Major” is awarded.

As shown in FIG. 42B, in the case where the symbol (2) is selected in FIG. 41B and a main character effect image 72 wins in the jackpot bonus game of the car race, the next jackpot bonus game is started. In this case, the jackpot bonus game of the car race is started. In the case where the main character effect image 72 wins, a win-or-lose information display 78a of “You Win” is displayed. A payout display image 91 of “Mega” is displayed which is indicative of a payout type of the jackpot. The payout corresponding to “Mega” is awarded.

Next, a process executed in the slot machine 10 according to the fifth embodiment, will be described in detail with reference to the drawings. The main CPU 41 reads out and executes a game program, thereby conducting the game.

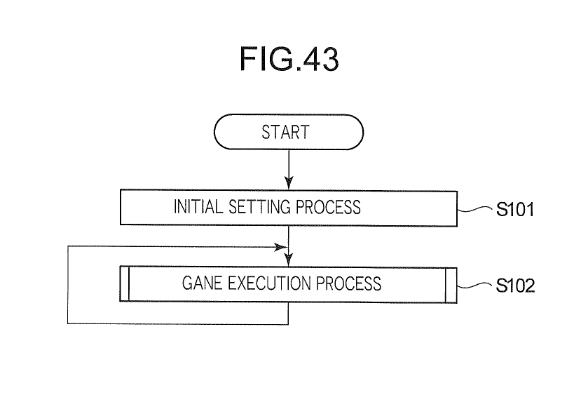

FIG. 43 is a flowchart showing a subroutine of main processing. In the main process, first, when a power switch is turned on (that is, when power is supplied), a motherboard 40 and a gaming board 50 are activated respectively, so that the CPU 51 executes an initial setting process (step S101). In this initial setting process, the main CPU 41 executes the BIOS stored in the ROM 42, decompresses, in the RAM 43, compressed data included in the BIOS, executes the BIOS decompressed in the RAM 43, and executes diagnosis and initialization of each of the peripheral devices. Further, the main CPU 41 writes game programs or the like from the ROM 42 into the RAM 43, and acquires payout-ratio setting data and country-identification information. The main CPU 41 also executes an authentication process for each program during execution of the initial setting process.

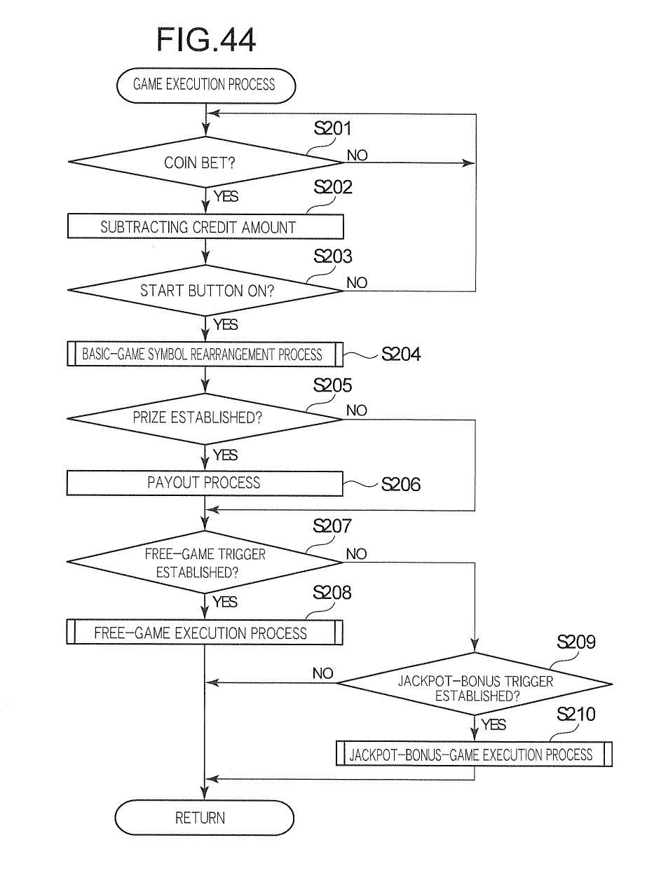

Next, the main CPU 41 executes a game execution process described later with reference to FIG. 44 (step S102). In the game execution process, the main CPU 41 sequentially reads and executes game programs or the like from the ROM 42. By performing the game execution process, the slot machine 10 executes the game according to the fifth embodiment. The game execution process is repeatedly performed while power is supplied to the slot machine 10.

FIG. 44 is a flowchart showing a subroutine of the game execution process invoked and performed at step S102 of the subroutine shown in FIG. 43. First, the main CPU 41 judges whether or a coin has been bet (step S201). Specifically, the main CPU 41 judges whether or not an input signal has been received, the signal being output from the 1-BET switch 26S when the 1-BET button 26 is pressed, or alternatively, being output from the MAX-BET switch 27S when the MAX-BET button 27 is pressed. The main CPU 41 controls the process to return to step S201 upon judging that no coin has been bet (step S201: NO).

On the other hand, the main CPU 41 subtracts the number of bet coins from the credit amount stored in the RAM 43 (step S202) upon judging that a coin has been bet (step S201: YES). Where the number of bet coins is larger than the credit amount stored in the RAM 43, the main CPU 41 controls the current the process to return to step S201 without performing the process for subtracting the number of bet coins from the credit number stored in the RAM 43. Where the number of bet coins exceeds the upper limit (fifty coins in this embodiment) of coins that can be bet in one game, the main CPU 41 controls the process to shift to step 203 without performing the process for subtracting the number of bet coins from the credit number stored in the RAM 43.

At step S203, the main CPU 41 judges whether or not the start button 23 has been set to ON (step S203). Specifically, the main CPU 41 judges whether or not an input signal output from the start switch 23S at the time of pushing of the start button 23 has been received. The main CPU 41 controls the process to return to step 201 upon judging that the start button 23 has not been set to ON (step S203: NO). Where the start button 23 has not been set to ON (for example, where an instruction has been input to terminate the game without setting the start button 23 to ON), the main CPU 41 cancels acceptance of a subtraction result at step S202.

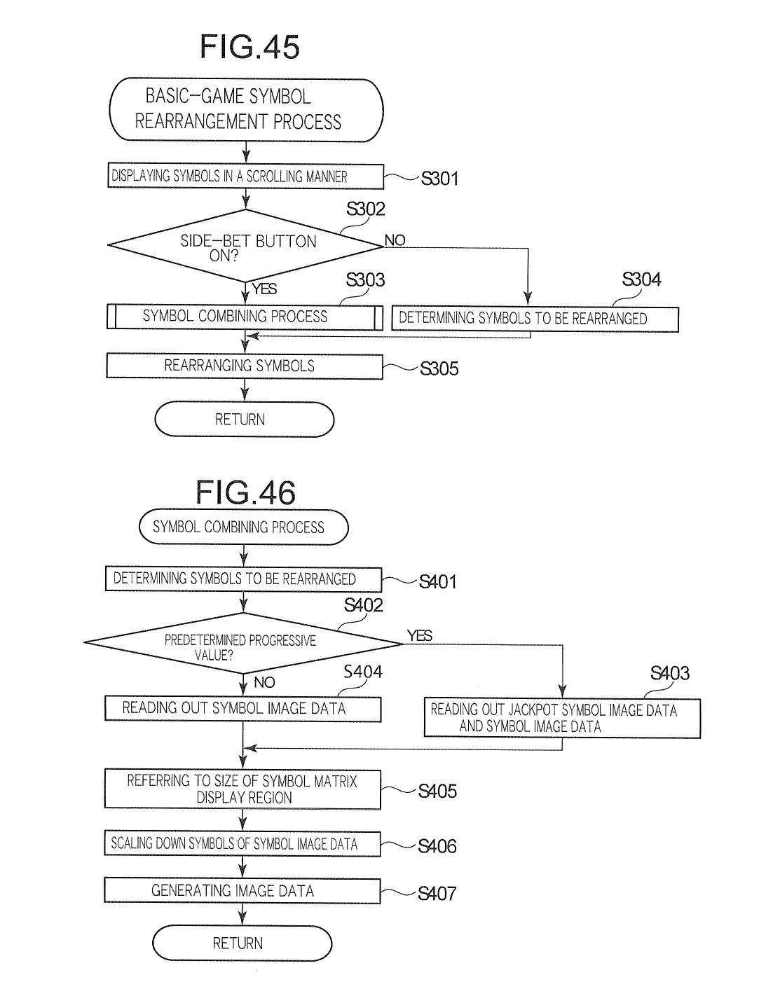

On the other hand, when the main CPU 41 judges that the start button 23 has been set to ON (step S203: YES), the main CPU 41 carries out symbol rearrangement process which will be described later with reference to FIG. 45 (step S204). Specifically, the CPU 41 executes the program stored in the RAM 43 and determines the symbols to be rearranged in the symbol matrix SM displayed on the lower image display panel 16. The symbols are determined from among the symbols, “main character” 121, “sub character” 122, “office building” 123, “gold bullion” 124, “car” 125, “stock certificate” 126, “jet” 127, and “villa” 128, and the complex symbol 129. This determination is based on the symbol weighting data and random numeric values sampled by sampling the random numeric values in a numerical range which comes under a predetermined range of random numeric values. The CPU 41 then rearranges the symbols in the symbol matrix SM.

Next, the main CPU 41 judges whether a prize has been established or not (step S205). Specifically, the main CPU 41 judges whether or not the number of symbols of respective types rearranged in the symbol matrix SM is a winning number allowed to award any of payouts. Herein, the prize is established on condition that a predetermined number of symbols of the same type are rearranged in the symbol matrix SM.

Upon judging that the prize is established (step S205: YES), the main CPU 41 then executes a coin-payout process in accordance with the amount of bet and the number of coins set for the winning number (step S206). Where the coins are deposited, the main CPU 41 executes a process for adding the number of paid-out coins to the credit amount stored in the RAM 43. On the other hand, upon execution of the coin-payout process, the main CPU 41 pays out the predetermined number of coins by transmitting a control signal to the hopper 66.

On the other hand, the main CPU 41 judges whether a free game trigger has been established or not (step S207) when judging that the prize is not established (step S205: NO) or executing the process at step S206. Specifically, the main CPU 41 executes the program stored in the RAM 43 to sample the random numeric values in a numerical range which comes under a predetermined range of random numeric values, thereby judging whether or not the free game trigger has been established based on the sampled random numeric values. Upon judging that the free game trigger is established (step S207: YES), the main CPU 41 executes a free game execution process described later with reference to FIG. 46 (step S208). In this free game execution process, the main CPU 41 sequentially reads and executes the game programs or the like from the ROM 42 and executes the free game execution process.

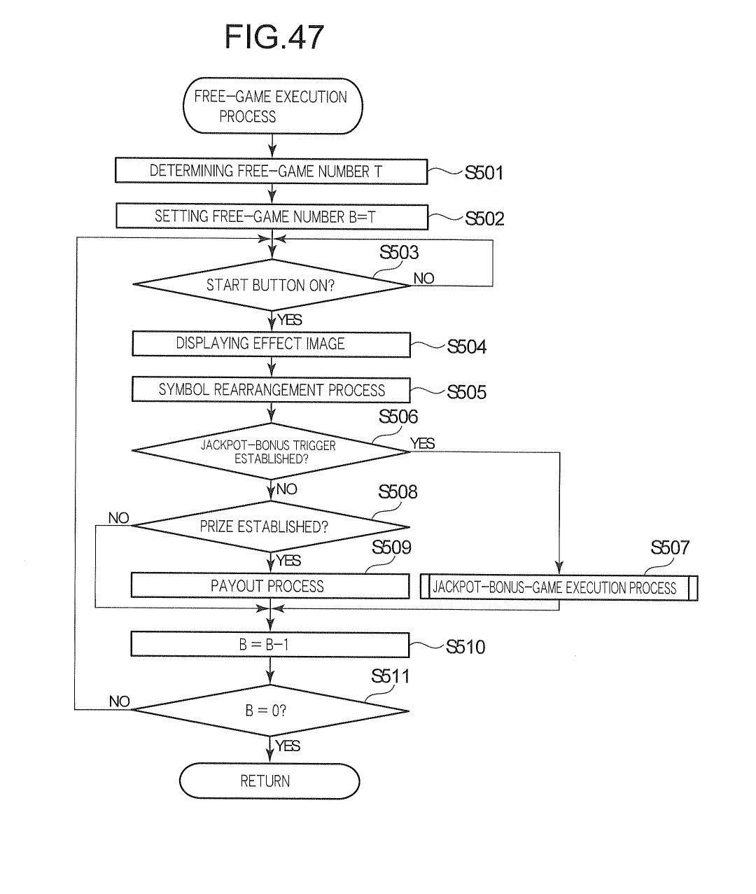

On the other hand, upon judging that the free game trigger has not been established (step S207: NO), the main CPU 41 judges whether or not a jackpot bonus game trigger has been established (step S209). Specifically, the main CPU 41 executes the program stored in the RAM 43 to sample the random numeric values in a numerical range which comes under a predetermined range of random numeric values, thereby judging whether or not the jackpot bonus game trigger has been established based on the sampled random numeric values. Upon judging that the jackpot bonus game trigger has been established (step S209: YES), the main CPU 41 executes a jackpot bonus game execution process described later with reference to FIG. 47 (step S210). In this jackpot bonus game, the main CPU 41 sequentially reads and executes the game programs or the like from the ROM 42 to execute the jackpot bonus game execution process.

The CPU 41 terminates the game execution process when judging that the jackpot bonus game trigger has not been established (step S209: NO) or when executing the process at step S208.

FIG. 45 is a flowchart showing a subroutine of the basic-game symbol rearrangement process invoked and executed in step S204 of the subroutine shown in FIG. 44. Next, the main CPU 41 displays the symbols in a scrolling manner (step S301). Specifically, the main CPU 41 successively displays in a scrolling manner the symbols that are rearranged in the symbol matrix SM displayed on the lower image display panel 16.

Next, the main CPU 41 judges whether or not a side-BET button 85 has been set to ON (step S302). Specifically, the main CPU 41 judges whether or not an input signal has been received, the signal being output from a side-BET switch 85S at the time of pushing the side-BET button 85. The main CPU 41 executes a symbol combining process (step S303) described later with reference to FIG. 46 upon judging that the side-BET button 85 has been set to ON (step S302: YES). Specifically, the main CPU 41 reads image data of at least two symbols including symbols that are combined under condition of input of the side-BET. The main CPU 41 then laterally or longitudinally scales down the symbols of the read-out image data so as to be displayed together in a region for displaying a single symbol, thereby rearranging therein the complex symbol composed of these scaled-down symbols.

On the other hand, upon judging that the side-BET button 85 is not set to ON (step S302: NO), the main CPU 41 determines symbols to be rearranged (step S304). Specifically, the main CPU 41 selects the predetermined storage area set in the RAM 43, the area for storing data of the predetermined symbol. Upon terminating this process, the main CPU 41 controls the process to shift to step S305.

Next, the main CPU 41 rearranges the symbols when terminating the process at step S303 or S304 (step S305). Specifically, the main CPU 41 executes the program stored in the RAM 43 and determines the respective symbols determined at step S303 or S304 to be arranged in the symbol matrix SM displayed on the lower image display panel. The symbols are selected from among the symbols “main character” 121, “sub character” 122, “office building” 123, “gold bullion” 124, “car” 125, “stock certificate” 126, “jet” 127, and “villa” 128, and the complex symbol 129 in the case where the complex symbol, that is scaled down at step S303, is determined. This determination is based on the symbol weighing data and random numeric values sampled by sampling the random numeric values in a numeric-value range which comes under a predetermined range of random numeric values. The main CPU 41 terminates the basic game symbol rearrangement process when executing this process.

FIG. 46 is a flowchart showing a subroutine of the symbol scaling down process invoked and executed at step S303 of the subroutine shown in FIG. 45. First, the main CPU 41 determines the symbols to be rearranged (step S401). Specifically, the main CPU 41 selects the predetermined storage area set in the RAM 43, the area for storing data of a predetermined symbol.

The main CPU 41 then judges whether or not a jackpot is a predetermined progressive value (step S402). Specifically, the main CPU 41 judges whether or not a value of credit for the progressive jackpot is equal to a predetermined value. Upon judging that a jackpot is a predetermined progressive value (step S402: YES), the main CPU 41 reads out image data concerning a jackpot symbol and image data concerning a symbol (step S403). Specifically, the main CPU 41 reads from the RAM 43, image data concerning two symbols, i.e., a jackpot symbol and a symbol to be assigned with the jackpot symbol. The main CPU 41 controls the process to shift to step S405 when terminating this process.

On the other hand, upon judging that a jackpot is not a predetermined progressive value (step S402: NO), the main CPU 41 reads out the symbol image data (step S404). Specifically, the main CPU 41 reads out of image data concerning symbols stored in the RAM 43, the image data concerning two symbols to be combined with each other.

Next, the main CPU 41 refers to a size of a symbol matrix display region (step S405). Specifically, the main CPU 41 refers to a size of a display region of the symbol matrix SM, in which the complex symbol is rearranged.

Next, the main CPU 41 scales down a symbol of the image data (step S406). Specifically, the main CPU 41 laterally or longitudinally scales down two symbol images read out at step S403 or S404 in a manner to match the size referred to at step S405 so that these two symbol images are displayed together in a region for displaying a single symbol.

Next, the main CPU 41 generates the image data (step S406). Specifically, the main CPU 41 generates the image data so that the two symbol images that are scaled down at step S405 are combined in a predetermined relationship so as to be displayed together in a display region for displaying a single symbol (step S407). The main CPU 41 terminates the symbol scaling process when executing this process.

FIG. 47 is a flowchart showing a subroutine of a free-game execution process invoked and executed at step S208 of the subroutine shown in FIG. 44. First, the main CPU 41 determines the free-game number T (step S501). Specifically, the main CPU 41 determines the free-game number T in accordance with a program stored in the RAM 43.

Next, the main CPU 41 performs a process for setting the free-game number B=T (step S502). Specifically, the main CPU 41 sets a remaining free-game number B=T in the storage area provided in the RAM 43, the area for storing the data indicative of the remaining free-game number B as the remaining number of times in executing the free game. A value of T is equal to the free-game number T determined at step S401.

Next, the main CPU 41 judges whether or not the start button 23 has been set to ON (step S503). Specifically, the main CPU 41 judges whether or not an input signal has been received, the signal being output from the start switch 23S at the time of pushing of the start button 23. The main CPU 41 controls the process to return to step S403 upon judging that the start button 23 has not been set to ON (step S503: NO).

On the other hand, upon judging that the start button 23 has been set to ON (step S503: YES), the main CPU 41 performs a process for displaying the effect image (step S504). Specifically, the main CPU 41 displays the free-game number display image 90a corresponding to the number of times in executing the free game on the upper image display panel 33 (see FIG. 40).

Next, the main CPU 41 performs a free-game symbol rearrangement process (step S505). Specifically, the main CPU 41 executes the program stored in the RAM 43 and determines the symbols to be rearranged in the symbol matrix SM displayed on the lower image display panel. These symbols are selected from among the symbols “main character” 121, “sub character” 122, “office building” 123, “gold bullion” 124, “car” 125, “stock certificate” 126, “jet” 127, and “villa” 128, and the complex symbol 129. This determination is based on the symbol weighing data and random numeric values sampled by sampling the random numeric values in a numeric-value range which comes under a predetermined range of random numeric values. The main CPU 41 then rearranges the symbols to be rearranged in the symbol matrix SM.

Next, the main CPU 41 judges whether or not a jackpot bonus trigger has been established (step S506). Specifically, the main CPU 41 executes the program stored in the RAM 43 to sample the random numeric values in a numerical range which comes under a predetermined range of random numeric values, thereby judging whether or not the jackpot bonus game trigger has been established based on the sampled random numeric values. Upon judging that the jackpot bonus game trigger has not been established (step S506: NO), the main CPU 41 controls the process to shift to step S508.

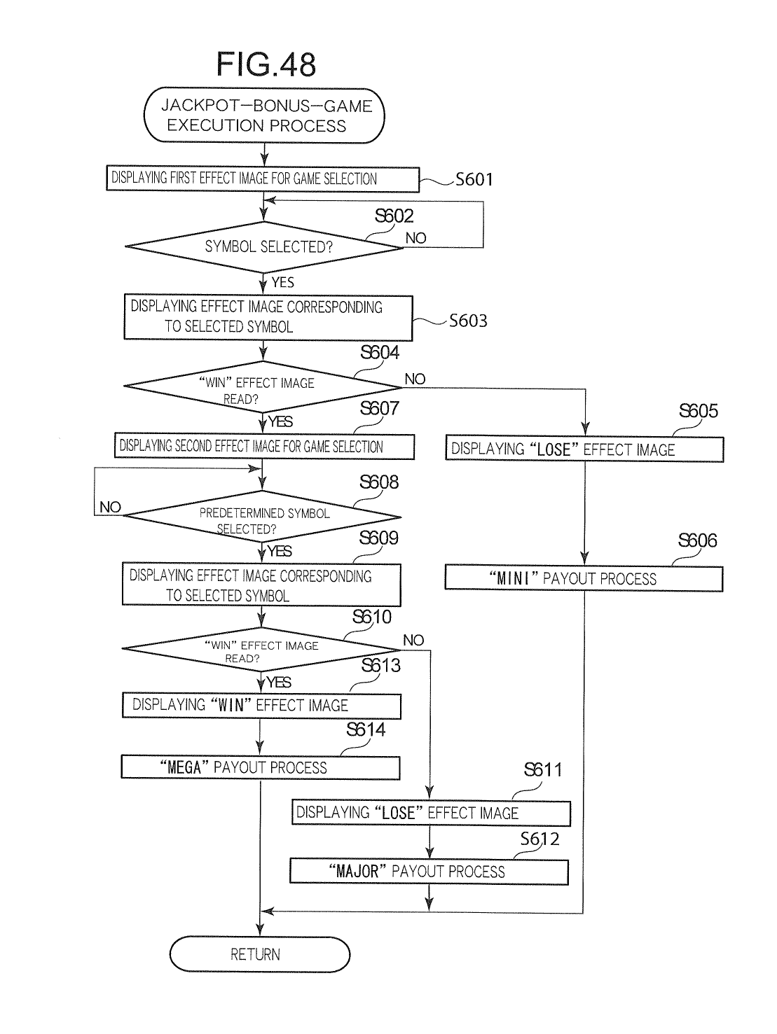

On the other hand, upon judging that the jackpot bonus trigger has been established (step S506: YES), the main CPU 41 executes a jackpot bonus game execution process described later with reference to FIG. 48 (step S507). In this jackpot bonus game, the main CPU 41 sequentially reads and executes the game programs or the like from the ROM 42 to execute the jackpot bonus game execution process.

Next, the main CPU 41 judges whether or not a prize has been established (step S508). Specifically, the main CPU 41 judges whether or not the number of symbols of respective types rearranged in the symbol matrix SM is a winning number allowed to award any of payouts. Herein, the prize is established on condition that a predetermined number of symbols of the same type are rearranged in the symbol matrix SM.

Thereafter, upon judging that the prize has been established (step S508: YES), the main CPU 41 performs a payout process for paying out the coins in accordance with the number of coins set for the winning number (step S509). Where the coins are deposited, the main CPU 41 performs a process for adding the number of paid-out coins to the credit amount stored in the RAM 43. On the other hand, upon execution of the coin-payout process, the main CPU 41 pays out the predetermined number of coins by transmitting a control signal to the hopper 66.

On the other hand, upon judging that the prize has not been established (step S508: NO) or upon executing the processes at step S509, the main CPU 41 sets the remaining free-game number B=B−1 (step S510). Specifically, the main CPU 41 sets B=B−1 at a value of the free-game number B stored in the RAM 43.

The main CPU 41 then judges whether or not a value of the remaining free-game number B is equal to zero (step S511). Specifically, the main CPU 41 judges whether or not a value of the remaining game number B stored in the RAM 43 is equal to zero. Upon judging that a value of the remaining free-game number B is not zero (step S511: NO), the main CPU 41 controls the step to return to step S403.

On the other hand, upon judging that a value of B is equal to zero (step S511: YES), the main CPU 41 terminates the free-game execution process.

FIG. 48 is a flowchart showing a subroutine of the jackpot bonus game execution process invoked and performed at step S210 of the subroutine shown in FIG. 44 and at step S507 of the subroutine shown in FIG. 47. First, the main CPU 41 displays a first effect image (step S601). Specifically, the main CPU 41 displays a jackpot bonus game display image 90b indicative of start of the jackpot bonus game on the upper image display panel 33 and the selection screen through which a type of the jackpot is determined (see FIG. 40) in the display region 92.

Next, the main CPU 41 judges whether or not the symbol is selected (step S602). Specifically, the main CPU 41 judges whether a symbol displayed on the selection screen for determining a type of jackpot bonus game is selected or not by means of the touch panel 69. Upon judging that the symbol is not selected (step S602: NO), the main CPU 41 returns the process to step S602.

On the other hand, upon judging that the symbol is selected (step S602: YES), the main CPU 41 displays the selected effect image (step S603). Specifically, the main CPU 41 sequentially reads from the ROM 42 the effect image corresponding to the symbol selected at step S602, and displays the effect image in the display region 92 (see FIG. 41A).

Next, the main CPU 41 judges whether or not the read effect image is the “Win” effect image (step S603). Specifically, the main CPU 41 judges whether or not the effect image read at step S603 is the “Win” effect. Upon judging that the “Win” effect is not read (step S604: NO), the main CPU 41 displays an effect image of “Lose” (step S605). Specifically, the CPU 41 reads the effect image corresponding to the effect image of “Lose” from the ROM 42, and displays the effect image in the display region 92 (see FIG. 41B). Next, the main CPU 41 executes a payout process of “Mini” (step S606). Specifically, the main CPU 41 executes a coin-payout process corresponding to a “Mini” payout. Where the coins are deposited, the main CPU 41 executes a process for adding the number of paid-out coins to the credit amount stored in the RAM 43. On the other hand, upon execution of the coin-payout process, the main CPU 41 pays out the predetermined number of coins by transmitting a control signal to the hopper 66. The main CPU 41 terminates the jackpot bonus execution process when executing the process at step S606.

On the other hand, upon judging that the “Win” effect is read (step S604: YES), the main CPU 41 displays a second effect selection image (step S607). Specifically, the main CPU 41 displays in the display region 92 a selection screen for determining a type of the jackpot bonus game, in a manner to make the symbol selected at step S602 identifiable.

Next, the main CPU 41 judges whether or not the predetermined symbol has been selected (step S608). Specifically, the main CPU 41 judges whether or not any one of symbols other than the symbol selected at step S602 has been selected through the touch panel 69. Upon judging that the symbol has not been selected (step S608: NO), the main CPU 41 returns the process to step S608.

On the other hand, upon judging that the predetermined symbol has been selected (step S608: YES), the main CPU 41 displays an effect image corresponding to the selected symbol (step S609). Specifically, the main CPU 41 sequentially reads out of the ROM 42 the effect image corresponding to the symbol selected at step S602, and displays the effect image in the display region 92.

Next, the main CPU 41 judges whether or not the “Win” effect has been read out (step S610). Specifically, the main CPU 41 judges whether or not the effect image read at step S609 corresponds to the “Win” effect. Upon judging that the read-out image does not correspond to the “Win” effect (step S610: NO), the main CPU 41 displays the effect image of “Lose” (step S611). Specifically, the main CPU 41 reads out of the ROM 42 the effect image corresponding to the effect image of “Lose”, and displays the effect image in the display region 92 (see FIG. 42A). Next, the main CPU 41 executes a coin-payout process of “Major” (step S612). Specifically, the main CPU 41 executes a coin-payout process corresponding to a “Major” payout. Where the coins are deposited, the main CPU 41 executes a process for adding the number of paid-out coins to the credit amount stored in the RAM 43. On the other hand, upon execution of the coin-payout process, the main CPU 41 pays out the predetermined number of coins by transmitting a control signal to the hopper 66. The main CPU 41 terminates the jackpot bonus execution process when executing the process at step S612.

On the other hand, upon judging that the read-out image corresponds to the “Win” effect (step S610: YES), the main CPU 41 displays the effect image of “Win”. Specifically, the main CPU 41 reads out of the ROM 42 the effect image corresponding to the effect image of “Win”, and displays the effect image in the display region 92 (see FIG. 42B). Next, the main CPU 41 executes a payout process of “Mega” (step S614). Specifically, the main CPU 41 executes a payout process corresponding to a “Mega” payout. Where the coins are deposited, the main CPU 41 executes a process for adding the number of paid-out coins to the credit amount stored in the RAM 43. On the other hand, upon execution of the coin-payout process, the main CPU 41 pays out the predetermined number of coins by transmitting a control signal to the hopper 66. The main CPU 41 terminates the jackpot bonus game execution process when executing the process at step S614.

### 6. Sixth Embodiment

Next, a slot machine 100 according to a sixth embodiment will be described in detail with reference to the drawings. Here, the slot machine according to the sixth embodiment described below is a so-called hybrid type slot machine, which has a transparent liquid crystal panel allocated in front of a plurality of mechanical reels supported in a rotatable manner, and executes a game by displaying images of various types of symbols drawn on an outer peripheral surface of the mechanical reels through the transparent liquid crystal panel. The slot machine according to the sixth embodiment has an appearance, circuitry, and the like that are substantially the same as those of the slot machine 10 according to the fifth embodiment. Thus, a duplicated explanation is omitted here. In addition, the constituent elements corresponding to those of the slot machine 10 are designated by the same reference numerals and are explained.

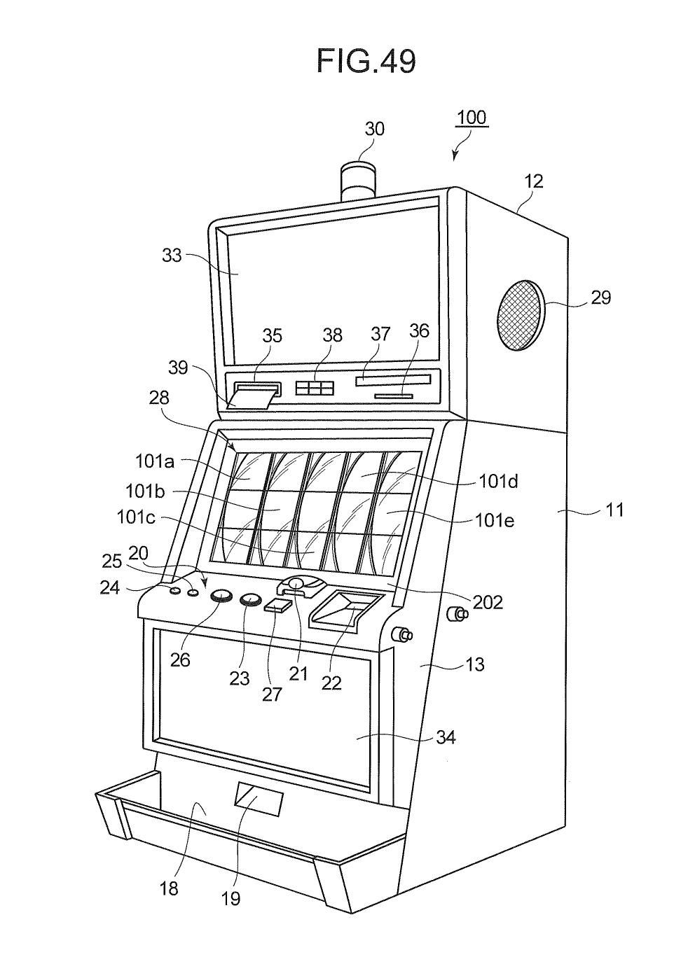

FIG. 49 is a view for schematically showing an appearance of the slot machine according to the sixth embodiment of the present invention. As shown in FIG. 49, the slot machine 100 is rotatably provided with five reels 101a to 101e. A symbol column made up of the symbols “main character” 121, “sub character” 122, “office building” 123, “gold bullion” 124, “car” 125, “stock certificate” 126, “jet” 127, and “villa” 128 is drawn on the respective one of the outer circumferential surfaces of the reels 101a to 101e.

A main liquid crystal panel 202 formed of a transparent liquid crystal panel, which is disposed at the main door, is provided in front of the respective reels 101a to 101e. The main liquid crystal panel 202 displays the symbol display region 28 with a visually recognizable rear surface so as to surround symbols displayed on the reels 101a to 101e in a stopped state, respectively. The symbols drawn on the reels 101a to 101e are visualized by rendering the symbol display region transparent.

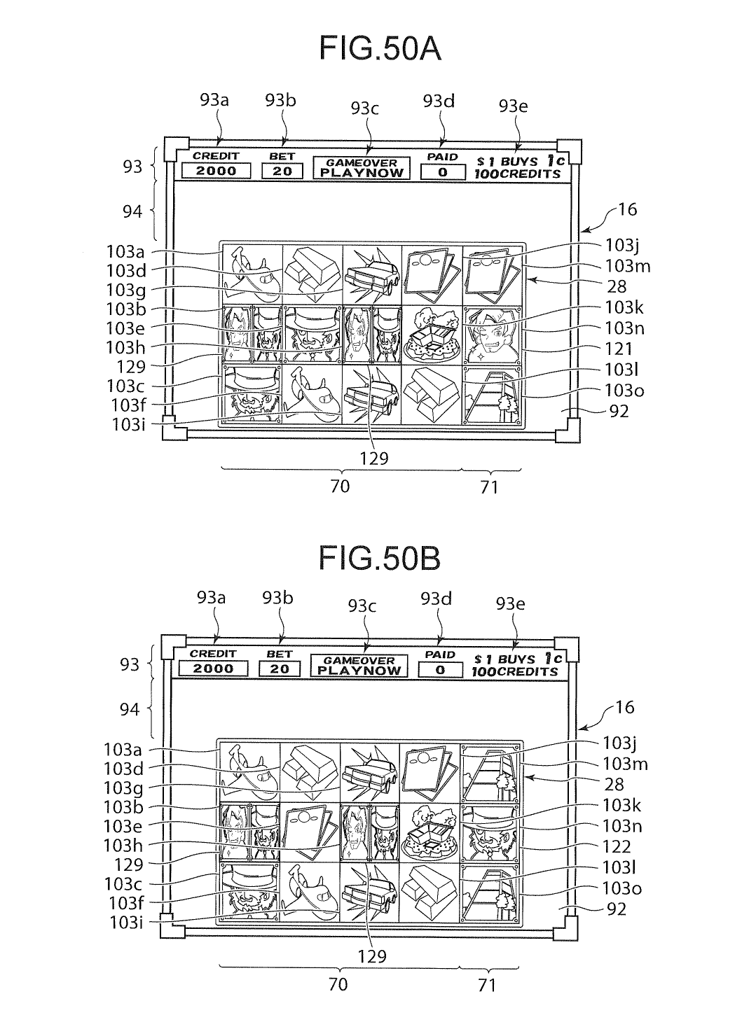

FIGS. 50A and 50B are views each showing an exemplary symbol matrix during the basic game. As shown in FIGS. 50A and 50B, the symbol display region 28 is displayed on the main liquid crystal panel 202 included in the slot machine 100 of the present invention. Further, the total of five reels 101a to 101e in five columns are rotatably provided behind the liquid crystal panel 202.

As shown in FIG. 50A, fifteen display windows 103a to 103o, rear surfaces of which are visually recognizable, are formed within the symbol display region 28 of the lower image display panel 16. When the reels 101a to 101e are stopped, symbols from among the total of fifteen symbols in three rows and five columns, “main character” 121, “sub character” 122, “office building” 123, “gold bullion” 124, “car” 125, “stock certificate” 126, “jet” 127, and “villa” 128, are displayed in a stopped state. Further, in the case where a jackpot is a predetermined progressive value, the complex symbol 129 is rearranged in a superimposed manner on the reels 101a to 101e by means of the liquid crystal panel 202. In this case, by means of the liquid crystal panel 202, the two complex symbols 129 and the symbol “main character” 121 are rearranged in a superimposed manner on the display windows 103b, 103h, 103n, respectively, so that the free game is to be executed.

As shown in FIG. 50B, the fifteen display windows 103a to 103o, rear surfaces of which are visually recognizable, are formed within the symbol display region 28 of the lower image display panel 16. When the reels 101a to 101e are stopped, symbols from among the total of fifteen symbols in three rows and five columns, “main character” 121, “sub character” 122, “office building” 123, “gold bullion” 124, “car” 125, “stock certificate” 126, “jet” 127, and “villa” 128, are displayed in a stopped state. Further, in the case where a jackpot is a predetermined progressive value, the complex symbol 129 is rearranged in a superimposed manner on the reels 101a to 101e by means of the liquid crystal panel 202. In this case, by means of the liquid crystal panel 202, the two complex symbols 129 and the symbol “sub character” 122 are rearranged in a superimposed manner on the display windows 103b, 103h, 103n, respectively, so that the jackpot bonus game is to be executed.

While the embodiment according to the present invention has been described, the description presents only some of the specific examples and is not intended to limit the present invention in any way and specific constructions of each means and the like can be properly changed in terms of design. Moreover, the effects described in the embodiment of the present invention are only the most preferable effects generated from the present invention and the effects to be caused by the present invention is not limitative thereto.

1.-18. (canceled)

19. A slot machine, comprising:
a display device for displaying a symbol matrix display region having a first display region and a second display region; and
a controller for controlling the display device, the controller being programmed to:
(a) execute a basic game;
(b) rearrange a complex symbol composed of plural types of single symbols in the first display region of the symbol matrix display region and the plural types of single symbols in the second display region during the basic game; and
(c) selectively execute a first bonus game or a second bonus game in accordance with a type of a combination of the complex symbol displayed in the first display region and the single symbol displayed in the second display region, in the case where the combination is a predetermined one.

20. The slot machine according to claim 19, wherein:
the first bonus game or the second bonus game is set to a free game or a jackpot bonus game.

21. The slot machine according to claim 20, further comprising:
a memory for cumulatively storing a progressive value, wherein:
the controller exercises control, over the itemized (b), to assign the complex symbol with a jackpot symbol accordingly when a jackpot reaches a predetermined progressive value on referring to the progressive value stored in the memory, in the case where the bonus game is set to the jackpot bonus game.

22. A slot machine, comprising:
a display device for displaying a symbol matrix display region having a first display region and a second display region;
a memory for storing plural types of symbol image data; and
a controller for controlling the display device and the memory, the controller being programmed to:
(a) execute a basic game;
(b) read at least two symbol image data to be combined from among the symbol image data stored in the memory during the basic game,
reduce a horizontal or vertical direction of the read symbol image data so that said at least two symbol images are displayed in a region for displaying a single symbol, and then,
generate combined symbol image data for displaying a combined symbol to be displayed in the first display region by combined said at least two reduced symbol image data;
(c) rearrange the combined symbol corresponding to the combined symbol image data in the first display region within the symbol display region and,
rearrange symbols corresponding to the plural types of symbol image data in the second display region within the symbol display region, during the basic game; and
(d) selectively execute a first bonus game or a second bonus game according to types of the combination, in a case where a combination of the combined symbol displayed in the first display region and single symbols displayed in the second display region matches a predetermined combination.

23. The slot machine according to claim 22, wherein:
the first bonus game or the second bonus game is a free game or a jackpot.

24. The slot machine according to claim 22, further comprising a memory for cumulatively storing a progressive value, wherein
the controller, in the itemized (b), reads the symbol image data from the memory with referring to the progressive value of the memory, in a case where the bonus game is the jackpot, so that a jackpot symbol is added to the combined symbol in response to the jackpot becoming a predetermined progressive value.

25. A slot machine, comprising:
a display device for displaying a symbol matrix display region having a first display region and a second display region;
an input device for accepting input of a normal-BET and a side-BET different from the normal-BET;
a memory for storing image data concerning plural types of symbols; and
a controller for controlling the display device and the input device, the controller being programmed to:
(a) execute a basic game;
(b) read from the image data concerning the symbols stored in the memory, image data concerning at least two symbols including symbols that are possibly combined under condition of the input of the side-BET;
laterally or longitudinally scale down the at least two symbols of the read-out image data to display these two symbols in a region for displaying a single symbol; and
generate image data concerning a complex symbol to display the complex symbol in the first display region, based on the image data concerning the scaled-down symbols; and
(c) rearrange the complex symbol composed of the symbols combined in accordance with the image data concerning the complex symbol, in the first display region in the symbol matrix display region and a symbol in accordance with the image data concerning the plural types of symbols in the second display region during the basic game; and
(d) selectively execute one bonus game from among a plurality of bonus games, in accordance with a type of a combination of the complex symbol displayed in the first display region and the single symbol displayed in the second display region, in the case where the combination is a predetermined one.

26. The slot machine according to claim 25, wherein:
the bonus game is set to a jackpot bonus game; and
the image data concerning the symbols that are possibly combined under condition of the input of the side-BET includes image data concerning a plurality of jackpot symbols.

27. The slot machine according to claim 26, further comprising:
a memory for cumulatively storing a progressive value, wherein:
the controller, in the itemized (b), reads the image data concerning the symbols out of the memory to incorporate one jackpot symbol from among the plurality of jackpot symbols into the complex symbol accordingly, when a jackpot reaches a predetermined progressive value on referring to the progressive value stored in the memory.
